(19) United States
(12) Patent Application Publication
(10) Pub. No.: US 2016/0067866 A1
(43) Pub. Date: Mar. 10, 2016

(54) AUTOMATED COOKING MACHINE USING A CARTESIAN BOT

(71) Applicant: Casabots Inc., San Jose, CA (US)

(72) Inventors: Deepak Chandra Sekar, San Jose, CA (US); Phil Swab, Santa Rosa, CA (US); Rupsha Chaudhuri, San Jose, CA (US); Amit Bose, San Jose, CA (US); Brian Richardson, Los Gatos, CA (US)

(73) Assignee: CASABOTS INC., San Jose, CA (US)

(21) Appl. No.: 14/847,959

(22) Filed: Sep. 8, 2015

Related U.S. Application Data
(60) Provisional application No. 62/047,785, filed on Sep. 9, 2014.
(60) Provisional application No. 62/056,368, filed on Sep. 26, 2014.
(60) Provisional application No. 62/094,595, filed on Dec. 19, 2014.
(60) Provisional application No. 62/150,303, filed on Apr. 21, 2015.
(60) Provisional application No. 62/185,524, filed on Jun. 26, 2015.
(60) Provisional application No. 62/201,105, filed on Aug. 4, 2015.

(51) Int. Cl. B25J 11/00; B25J 9/02; A47J 44/00

(52) U.S. Cl. CPC B25J 11/0045; A47J 44/00; B25J 9/023; Y10S 901/16

(57) ABSTRACT

An automated cooking machine is described wherein various functions, such as dispensing, stirring, chopping, baking and cleaning are conducted by intelligent use of a Cartesian robot system.

### CROSS-REFERENCE TO RELATED APPLICATIONS

This application claims the benefit of U.S. Provisional Patent Application No. 62/047,785, filed Sep. 9, 2014, U.S. Provisional Patent Application No. 62/056,368, filed Sep. 26, 2014, U.S. Provisional Patent Application No. 62/094,595, filed Dec. 19, 2014, U.S. Provisional Patent Application No. 62/150,303, filed Apr. 21, 2015, U.S. Provisional Patent Application No. 62/185,524, filed Jun. 26, 2015, and U.S. Provisional Patent Application No. 62/201,105, filed Aug. 4, 2015. The contents of the foregoing applications are incorporated herein by reference in their entirety.

### BACKGROUND OF THE INVENTION

1. Field of the Invention

This application relates to the general field of electronically-aided apparatuses, systems, methods and techniques to conduct the cooking process in a home or a business.

2. Discussion of Background Art

Over the years, a number of innovations have come in to help with the cooking process. Food processors are now available to chop vegetables and meat. Induction cooktops allow a faster cooking process. Microwave ovens allow efficient reheating. However, despite these innovations, many of us spend an hour a day, or sometimes even more, cooking food for ourselves and our families. Cooking also requires a significant learning curve before one can do it in a tasty manner. Ways to reduce the “human time” needed for cooking as well as the learning curve associated with cooking could be quite useful. As well, direct and indirect economic benefits may accrue for a business by transferring some of the human time costs to a machine, robot, and such.

U.S. Patent Application Publication No. 2013/0112683 from Hegedis, Davenport and Hoare apparently describes a cooking apparatus where a heating element works with a user interface and temperature sensors and provides prompts to the user during cooking. However, this requires user input to provide all the ingredients needed for cooking and requires the user to stand near the cooktop for large periods of time to respond to the prompts provided by the cooking apparatus. There is no mixing function available automatically, so the user needs to stand near the cooktop for large periods of time as well.

U.S. Patent Application Publication No. 2011/0108546 from Cho and Chen apparently describes an intelligent heating mechanism which adaptively provides power to an induction cooktop based on temperature sensor data as well as a user-defined temperature profile. However, this requires the user to provide all the ingredients needed for cooking manually and requires the user to stand near the cooktop to mix the food items periodically.

Foodini, a prototype and soon-to-be-released product from Natural Machines, apparently 3D prints food items by heating food pastes and dispensing them on to a stage. However, this requires food to be in paste form before being dispensed, which could be cumbersome and costly.

Everycook, a prototype made in Europe, apparently promises to cut and mix food items and cook them with a recipe. However, the user still needs to be present near the Everycook cooking apparatus and dump additional food items every so often.

Sereneti Kitchen, a prototype in the US, apparently wants to automate the cooking process but does not conduct any chopping of the ingredients and utilizes pre-chopped food instead. Neither does it put measured quantities of ingredients into the cooking vessel.

It is clear based on the background that invention of a cooking apparatus and method that allow food preparation with minimal human intervention during the cooking process will be quite beneficial.

### SUMMARY

Cooking is often considered a complex process and one which requires the complex functionality that human hands provide. For example, Moley Robotics, a company based in Europe, tries to mimic human hands as closely as possible. Their prototype apparently requires 24 motors and more than 100 sensors. It is an object of this invention to automate the cooking process with intelligent use of simple robot arms thereby having a significantly reduced number of motors and sensors (vis-à-vis an approach which mimics human hands).

In this invention, Cartesian robot arms, also called Cartesian bots, are used. Based on intelligent use of a Cartesian bot as well as additional hardware and software, we show that one can perform various functions such as ingredient dispensing, stovetop cooking, baking, chopping and stirring.

### BRIEF DESCRIPTION OF THE DRAWINGS

Various embodiments of the invention will be understood and appreciated more fully from the following detailed description, taken in conjunction with the drawings in which:

FIG. 1 is an example illustration of an automated cooking machine using an induction cooking apparatus, a mixer, an automated ingredient delivery system and a user interface in an embodiment of the present invention;

FIG. 2 is an example illustration of an ingredient delivery system in an embodiment of the present invention;

FIG. 3 is an example illustration of the automated ingredient delivery system dispensing ingredients into the cooking vessel in an embodiment of the present invention;

FIG. 4 is an example illustration of a valve system for the automated ingredient delivery system in an embodiment of the present invention;

FIG. 5 is an example illustration of a configuration for the valve system in an embodiment of the present invention;

FIG. 6 is an example illustration of a configuration for the valve system in an embodiment of the present invention;

FIG. 7 is an example illustration of a configuration for the valve system in an embodiment of the present invention;

FIG. 8 is an example illustration of another design for the cooking machine in an embodiment of the present invention;

FIG. 9 is an example illustration of the cooking machine utilizing feedback from various sensors in an embodiment of the present invention;

FIG. 10 is an example illustration of how the cooking machine can provide information about food that is going to be cooked in an embodiment of the present invention;

FIG. 11 is an example illustration of a food processor in an embodiment of the present invention;

FIG. 12 is an example illustration of a blade used in the food processor of FIG. 11 in an embodiment of the present invention;

FIG. 13 is an example illustration of a top view of the food processor of FIG. 11 in an embodiment of the present invention;

FIG. 14 is an example illustration of a cooking machine in an embodiment of the present invention;

FIG. 15 is an example illustration of an example cooking processor using the machine in FIG. 14 in an embodiment of the present invention;

FIG. 16 is an example illustration of an example cooking processor using the machine in FIG. 14 in an embodiment of the present invention;

FIG. 17 is an example illustration of an example cooking processor using the machine in FIG. 14 in an embodiment of the present invention;

FIG. 18 is an example illustration of an example cooking processor using the machine in FIG. 14 in an embodiment of the present invention;

FIG. 19 is an example illustration of a cooking machine with multiple burners in an embodiment of the present invention;

FIG. 20 is an example illustration of an apparatus for ingredient dispensing in an embodiment of the present invention;

FIG. 21 is an example illustration of an initial step of the ingredient dispensing process in an embodiment of the present invention;

FIG. 22 is an example illustration of a step of the ingredient dispensing process that may follow FIG. 21 in an embodiment of the present invention;

FIG. 23 is an example illustration of a step of the ingredient dispensing process that may follow FIG. 22 in an embodiment of the present invention;

FIG. 24 is an example illustration of a step of the ingredient dispensing process that may follow FIG. 23 in an embodiment of the present invention;

FIG. 25 is an example illustration of how Cartesian bot motion may be used to push ingredients to be dispensed in an embodiment of the present invention;

FIG. 26A is an example illustration of a configuration for a two-position, spring-loaded, mechanically actuated, sliding valve system for a cooking machine in an embodiment of the present invention;

FIG. 26B is an exploded view of a configuration for a two-position, spring-loaded, mechanically actuated, sliding valve system for a cooking machine in an embodiment of the present invention;

FIG. 27 is an example illustration of a configuration for a sliding valve system for a cooking machine in an idle state in an embodiment of the present invention;

FIG. 28 is an example illustration of a configuration for a sliding valve system for a cooking machine in the load state in an embodiment of the present invention;

FIG. 29 is an example illustration of a configuration for a sliding valve system for a cooking machine in the dispense state in an embodiment of the present invention;

FIG. 30 is an example illustration of a configuration for a rotary assembly of a sliding valve system with remote manual actuator for a cooking machine in the idle state in an embodiment of the present invention;

FIG. 31 is an example illustration of a configuration for a rotary assembly of a sliding valve system with remote manual actuator for a cooking machine in the load state in an embodiment of the present invention;

FIG. 32 is an example illustration of a configuration for a rotary assembly of a sliding valve system with remote manual actuator for a cooking machine in the dispense state in an embodiment of the present invention;

FIG. 33 is an example illustration of an example of taste sensors and their associated feedback mechanism for the cooking machine in an embodiment of the present invention;

FIG. 34 is an example illustration of an example of gas sensors and the associated feedback mechanism for the cooking machine in an embodiment of the present invention;

FIG. 35 is an example illustration of an example of light (visible and infrared) sensors and the associated feedback mechanism for the cooking machine in an embodiment of the present invention;

FIG. 36 is an example illustration of a configuration of a dual-slider, spice valve system with sliders in the load position in an embodiment of the present invention;

FIG. 37 is an example illustration of a configuration of a dual-slider, spice valve system with sliders in the dispense position, at a step in the dispensing process that may follow FIG. 36 in an embodiment of the present invention;

FIG. 38 is an example illustration of a configuration of spring-loaded, dual slider, spice valve system with sliders in the load position in an embodiment of the present invention;

FIG. 39 is an example illustration of a configuration of a spring-loaded, dual slider, spice valve system with sliders in the dispense position, at a step in the dispensing process that may follow FIG. 38 in an embodiment of the present invention;

FIG. 40 is an example illustration of a configuration of a single slider, spice valve system with slider in the load position in an embodiment of the present invention;

FIG. 41 is an example illustration of a configuration of a single slider, spice valve system with slider in the dispense position, at a step in the dispensing process that may follow FIG. 40 in an embodiment of the present invention;

FIG. 42 is an example illustration of a configuration of a dual via, single slider, spice valve system, with slider in the load position in an embodiment of the present invention;

FIG. 43 is an example illustration of a configuration of a dual delivery via, single slider, spice valve system with slider in the load position in an embodiment of the present invention;

FIG. 44 is an example illustration of a configuration of a dual delivery via, single slider, spice valve system with slider in the dispense position, at a step in the dispensing process that may follow FIG. 43 in an embodiment of the present invention;

FIG. 45 is an example illustration of a configuration of a dual delivery via, single slider, spice valve system with slider in the load position, at a step in the dispensing process that may follow FIG. 44 in an embodiment of the present invention;

FIG. 46 is an example illustration of a configuration of a dual delivery via, single slider, spice valve system with slider in the dispense position, at a step in the dispensing process that may follow FIG. 45 in an embodiment of the present invention;

FIG. 47 is an example illustration of a configuration of a dual delivery via, single slider, spring loaded spice valve system with slider in the dispense position in an embodiment of the present invention;

FIG. 48 is an example illustration of a configuration of a dual delivery via, single slider, spring loaded spice valve system with slider in the load position, at a step in the dispensing process that may follow FIG. 47 in an embodiment of the present invention;

FIG. 49 is an example illustration of a configuration of a dual delivery via, single slider, spring loaded spice valve system with slider in the dispense position, at a step in the dispensing process that may follow FIG. 48 in an embodiment of the present invention;

FIG. 50 is an example illustration of a configuration of a motor driven screw auger spice valve system in an embodiment of the present invention;

FIG. 51 is an example illustration of a configuration of a motor driven screw auger spice valve system with a funnel shaped reservoir in an embodiment of the present invention;

FIG. 52 is an example illustration of a configuration of a motor driven screw auger spice valve system with a funnel shaped reservoir in an embodiment of the present invention;

FIG. 53 is an example illustration of a configuration of a rotary assembly of eight motor driven screw auger spice valves with funnel shaped reservoirs, on a rotating index plate, with auger #3 aligned with the auger drive motor in an embodiment of the present invention;

FIG. 54 is an example illustration of a configuration of an ingredient delivery system with a horizontal actuator assembly to transfer horizontal force downward to a vertical pusher which pushes food into a food processor and automated cooker in an embodiment of the present invention;

FIG. 55 is an example illustration of a top-down view of a configuration to park cassettes of spices and food ingredients out of the way of the food processing and cooking areas of an automated cooking appliance in an embodiment of the present invention;

FIG. 56 is an example illustration of the configuration of an ingredient dispenser which can keep food items chilled for periods of time in an embodiment of the present invention;

FIG. 57 is an example illustration of an ingredient dispenser whose dispensing mechanism may make use of a robot arm in an embodiment of the present invention;

FIG. 58 is an example illustration of another configuration for parts of the ingredient dispenser in an embodiment of the present invention;

FIG. 59 is an example illustration of a configuration for the ingredient dispenser in an embodiment of the present invention;

FIG. 60 is an example illustration of a side view of a configuration for an automated cookpot having perimeter slicing and cutting modules, and a chopping and stirring module in the bottom of the pot in an embodiment of the present invention;

FIG. 61 is an example illustration of a top-down view of a configuration for an automated cookpot having perimeter slicing and cutting modules, and a chopping and stirring module in the bottom of the pot in an embodiment of the present invention;

FIG. 62 is an example illustration of a top-down view of a configuration for an automated cookpot with perimeter slicing and cutting modules, a chopping and stirring module in the bottom of the pot, and a food drawer with food modules and a spice cassette in an embodiment of the present invention;

FIG. 63 is an example illustration of a configuration of a dual-purpose cutting/stirring blade in an embodiment of the present invention;

FIG. 64 is an example illustration of a cross-sectional view of the dual-purpose cutting/stirring blade shown in FIG. 63 in an embodiment of the present invention;

FIG. 65 is an example illustration of a configuration of a dual-purpose cutting/stirring blade in an embodiment of the present invention;

FIG. 66 is an example illustration of a cross-sectional view of a dual-purpose cutting/stirring blade shown in FIG. 63, simulating rotation of the blade in a direction that results in cutting in an embodiment of the present invention;

FIG. 67 is an example illustration of a cross-sectional view of a dual-purpose cutting/stirring blade shown in FIG. 65, simulating rotation of the blade in a direction that results in stirring in an embodiment of the present invention;

FIG. 68 is an example illustration of a pre-assembly configuration of a dual-purpose cutting/stirring blade in an embodiment of the present invention;

FIG. 69 is an example illustration of a post-assembly configuration of the dual-purpose cutting/stirring blade shown in FIG. 68 in an embodiment of the present invention;

FIG. 70 is an example illustration of a side view of a configuration for an automated cookpot having side-mounted perimeter slicing and cutting modules, and a top-down chopping and stirring module coming from above the cooking pot to the bottom of the pot where the shaft engages a shaft stabilizer in an embodiment of the present invention;

FIG. 71 is an example illustration of a side view of a configuration for an automated cookpot having side-mounted perimeter slicing and cutting modules, and an articulated stirring arm module coming from above the cooking pot to the bottom of the pot in an embodiment of the present invention;

FIG. 72 is an example illustration of the front view of a Cartesian bot system used for stirring in an embodiment of the present invention;

FIG. 73 is an example illustration of the side view of a Cartesian bot system used for stirring in an embodiment of the present invention;

FIGS. 74A-74C are example illustrations of an automated system that handles baked food in an embodiment of the present invention;

FIG. 75 is an example illustration of a system that may be used for cooking various food items that may benefit from two sided heating in an embodiment of the present invention;

FIGS. 76A-76D are example illustrations of various steps for providing two sided heating in an embodiment of the present invention;

FIGS. 77A-77E are example illustrations of a system and procedure for automated cleaning of a cooking machine in an embodiment of the present invention;

FIGS. 78A-78F are example illustrations of a system and procedure for making baked food with an automated cooking machine in an embodiment of the present invention;

FIG. 79 is an example illustration of a liquid delivery system in an embodiment of the present invention;

FIG. 80 is an example illustration of a liquid delivery system in an embodiment of the present invention;

FIG. 81 is an example illustration of a spice delivery system in an embodiment of the present invention;

FIG. 82 shows a configuration of a dual via, L-shaped single slider, spice valve system, with slider in the load position in an embodiment of the present invention;

FIG. 83 shows a configuration of a dual via, L-shaped single slider, spice valve system, with slider in the Dispense position in an embodiment of the present invention;

FIG. 84 shows a configuration of a dual via, L-shaped single slider, spice valve system, with slider in the load position in an embodiment of the present invention;

FIG. 85 shows a configuration of a dual via, L-shaped single slider, spice valve system, with slider in the Dispense position in an embodiment of the present invention;

FIG. 86 shows a configuration of a dual via, F-shaped single slider, spice valve system, with slider in the load position in an embodiment of the present invention;

FIG. 87 shows a configuration of a dual via, F-shaped single slider, spice valve system, with slider in the load position in an embodiment of the present invention;

FIG. 88 shows a configuration of a dual via, F-shaped single slider, spice valve system, with slider in the Dispense position, at a step in the dispensing process that may follow FIG. 87 in an embodiment of the present invention;

FIG. 89 shows a configuration of a dual via, F-shaped single slider, spice valve system, with slider in the load position, at a step in the dispensing process that may follow FIG. 88 in an embodiment of the present invention;

FIG. 90 shows a configuration of a dual via, F-shaped single slider, spice valve system, with slider in the Dispense position, at a step in the dispensing process that may follow FIG. 89 in an embodiment of the present invention;

FIG. 91 shows a configuration of a Cartesian bot and a motor-mounted actuator. An assembly of two food modules is shown attached to the Cartesian bot and the motor-mounted actuator is shown to have opened one of the food module slider valves in an embodiment of the present invention;

FIG. 92 illustrates a method for using the cooking robot in an embodiment of the present invention;

FIG. 93 illustrates a method for using the cooking robot in an embodiment of the present invention;

FIG. 94 illustrates a method for using the cooking robot to perform baking functions in an embodiment of the present invention;

FIG. 95 illustrates a method for using a cooking robot having both a bottom and a top heater in an embodiment of the present invention;

FIG. 96 illustrates a method for using a cooking robot in an embodiment of the present invention;

FIG. 97 illustrates a method for using a cooking robot in an embodiment of the present invention;

FIG. 98 depicts an example computer processing system that may be used in implementing an illustrative embodiment of the present invention.

### DETAILED DESCRIPTION

Embodiments of the present invention are now described with reference to at least the above figures. Persons of ordinary skill in the art will appreciate that the description and figures illustrate rather than limit the invention and that in general the figures are not drawn to scale for clarity of presentation. Such skilled persons will also realize that many more embodiments are possible by applying the inventive principles contained herein and that such embodiments fall within the scope of the invention which is not to be limited except by any appended claims.

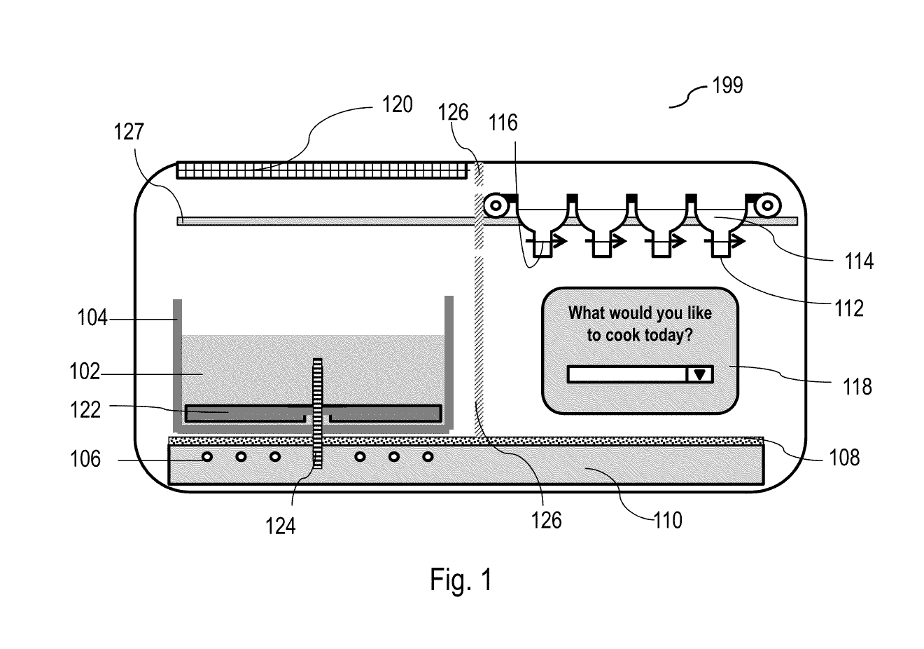

As illustrated in FIG. 1, an example automated cooking machine/apparatus 199 may be constructed and may include an induction cooking apparatus, a mixer, an automated ingredient delivery system and a user interface, and describes at least an embodiment of this invention. Automated cooking machine/apparatus 199, depending on design, manufacturing and feature considerations, may include food material 102, vessel 104, induction coil 106, cover plate 108, portion of the electronics 110, containers 112, ingredients 114, valve systems 116, user interface 118, ventilation 120, blades 122, stir/mix apparatus 124, chamber wall 126, and rails 127. Food material 102 may be cooked in a vessel 104 using an induction cooking apparatus, which may include induction coil 106, a cover plate 108 and a portion of the electronics 110. To allow for good transfer of heat using induction cooking, vessel 104 may include a metal or metallic composition, such as, for example, stainless steel. One drawback with conventional cooking apparatus is that a user needs to be present near the cooktop to stir the food and prevent burning. To avoid this, automated cooking machine/apparatus 199 may use a mixer which may consist of blades 122 and stir/mix apparatus 124 which may help the blades 122 to rotate and mix the food. The stir/mix apparatus 124 may include a rod, a motor to rotate the rod, fasteners for joining the rod to the bottom assembly and other items (not shown). One skilled in the art will appreciate that the stir/mix apparatus 124 may stretch below the vessel as shown in FIG. 1; alternatively, stir/mix apparatus 124 may stretch above the vessel onto a fixture (not shown). Stir/mix apparatus 124 may rotate at various speeds to potentially mimic human movements. Ingredients 114 needed for the food being cooked may be present in containers 112. Containers 112 may be mounted to the Cartesian bot system which may include rails 127. Containers 112 may be movable, can move atop vessel 104 and may utilize one or more valve systems 116 to drop ingredients 114 into vessel 104 according to the recipe being used for cooking. It may be appreciated by one skilled in the art that the valve system 116 is depicted with a symbol (arrow) for simplicity in FIG. 1. Several ways exist to physically implement the valve system, and examples of that will be shown later in this patent application. The recipe used for cooking may be entered into user interface 118, for example, a touchscreen display or into some other type of user interface. Ventilation 120 may be used to take away a portion or substantially all of the gaseous effluents from the cooking process. Ventilation 120 may include several components, for example, such as a filter, a fan and other items. A chamber wall 126 may be used to separate the region of the apparatus used for cooking the food, and which is exposed to gaseous effluents and heat, from other parts of the apparatus. It can be observed that two chambers are present in the cooking apparatus in FIG. 1 due to the chamber wall. Automated cooking machine/apparatus 199 may be described as a two chamber system wherein the resting location of the ingredient delivery system may be in another chamber compared to the chamber where the food is cooking. The electronics in portion of the electronics 110 may include some part or all of the electronics needed for induction cooking, it may include the power supply to the whole apparatus, it may include controllers or other integrated circuits for the user interface 118, electronics for motors to move the ingredient containers such as containers 112, controllers for the valve systems 116, integrated circuits for connecting to the internet, controllers for the mixer as well as electronics for several other functions of automated cooking machine/apparatus 199. FIG. 1 may include an induction cooking apparatus, a food mixer, a user interface, ventilation and an automated ingredient delivery system. It will be appreciated by those skilled in the art that the invention is not limited to what has been particularly shown and described hereinabove and that several variations of the concepts in FIG. 1 may be possible. For example, one may use a conventional cooking hot plate instead of the induction cooking apparatus. Furthermore, the user interface may be constructed in several ways. Many other modifications within the scope of the illustrated embodiments of the invention described herein will suggest themselves to such skilled persons after reading this specification. Thus the invention is to be limited only by the appended claims

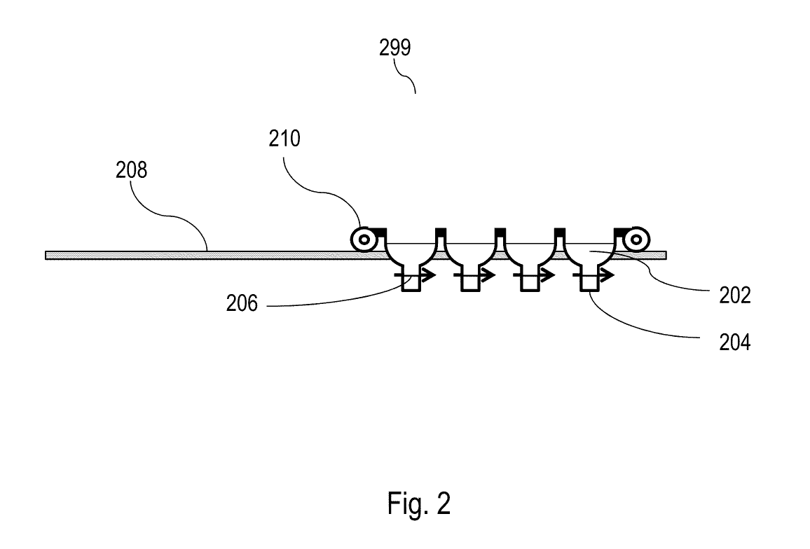

As illustrated in FIG. 2, an automated ingredient delivery system 299 (e.g., a dispensing sub-system) may be constructed and may include ingredients 202 in containers 204, may include valve systems 206 which control the ingredient delivery, as well as mechanisms for moving the stage, such as wheels 210 and rails 208, and describes at least an embodiment of this invention. Automated ingredient delivery system 299 may also be referred to as a movable ingredient stage. It will be appreciated by those skilled in the art that several mechanisms for moving the stage are possible.

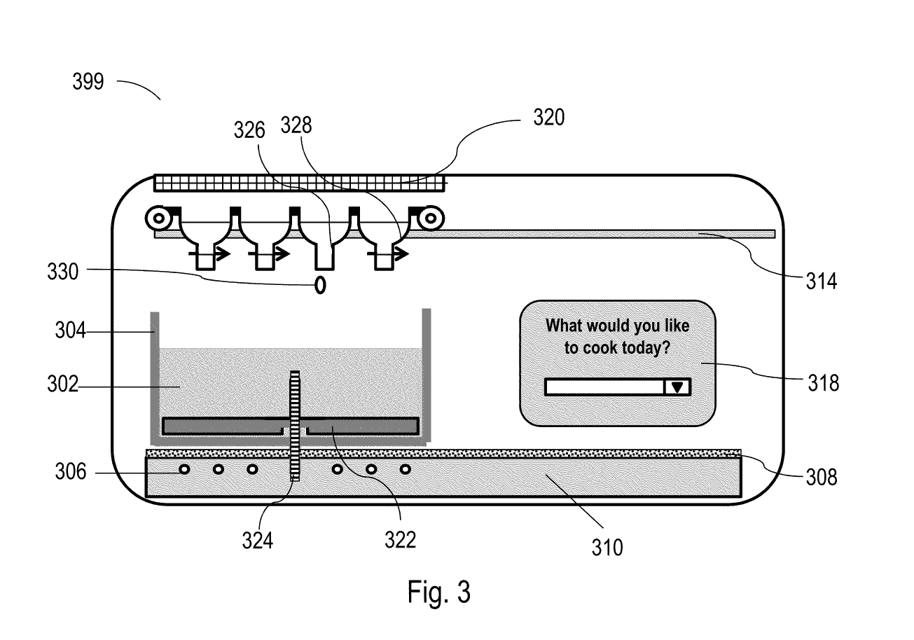

As illustrated in FIG. 3, an example of how the movable ingredient stage may be brought atop the vessel 304 to deliver ingredients 330 to the food being cooked 302 is described. For the illustration in this figure, dispensed food container 326 has its valve system open while other containers, such as food container 328, have their valve systems closed. Example automated cooking machine/apparatus 399 may include the elements of the movable ingredient stage described above, and may also include mixer blades 322, stir/mix apparatus 324, portion of the electronics 310, induction coil 306, user interface 318, movable stage 314, ventilation 320, and cover plate 308. The chamber wall is not shown in this figure for simplicity.

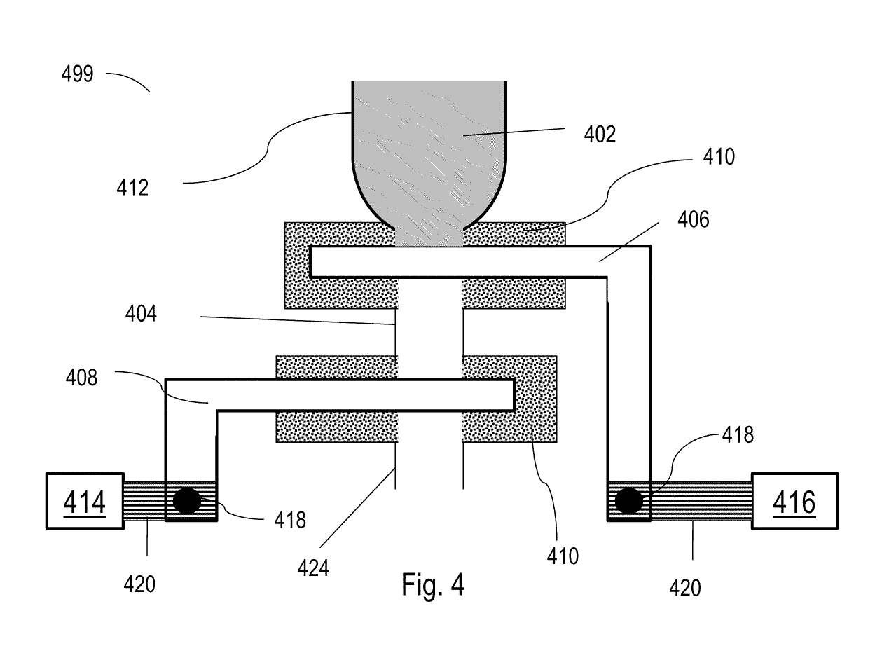

Several challenges exist for providing a good automated ingredient delivery system. The valve system, if controlled electronically, could allow an integrated circuit to control the ingredient delivery systems. Conventional electronically controlled valve systems (e.g. solenoid valves) may be used. However, since the ingredient containers may need to be washed in a dishwasher periodically, the electronically controlled valve system may need to be made waterproof for at least the electronic wires, or some other solution needs to be found. Also, conventional valves may not provide a controlled/measured amount of ingredients to the vessel being cooked. FIG. 4-FIG. 7 describes an embodiment of this invention, which describe the design and working of a valve system in an automated ingredient delivery system that may provide a controlled amount of ingredients to the vessel being cooked and which may be washed in a dishwasher without the electronic wires getting spoiled by exposure to water, and may provide for an easier sterilization procedure and more complete sterilization achievement level.

As illustrated in FIG. 4, an example valve system 499 may be constructed that may be utilized for dispensing measured quantities of a multiplicity of ingredients. Valve system 499 may include two valves, first valve 406 and second valve 408, ingredient 402, chamber 404, valve seat/body 410, initial chamber 412, first linear actuator 414, second linear actuator 416, fastener 418, connector 420, and chute 424. For example, first valve 406 and second valve 408 can be of a gate valve type (e.g., slide gate valves). Both first valve 406 and second valve 408 are illustrated in a “closed” position in FIG. 4. In this position, ingredient 402 may largely be disposed in initial chamber 412 since first valve 406 blocks ingredient 402 from proceeding into chamber 404. The chamber 404 may be relatively or substantially clear of ingredients. Chamber 404 may be disposed between initial chamber 412 and chute 424. Valve seat/body 410 may include a metal, a polymer or a combination of both. Valve seat/body 410 may be formed with different materials if mated with either first valve 406 or second valve 408, or similar materials, depending on design and engineering choices. First linear actuator 414 and second linear actuator 416, when they move, may move its associated connector 420 and in turn move the corresponding valve between “open” and “closed” positions, or in-between open and closed positions. Fasteners 418 may be used to separate the linear actuators from the ingredient containers such as initial chamber 412 and chamber 404. When the ingredient containers need to be washed, the fastener, which may be a screw-less fastener, may be removed to allow the ingredient containers to be washed without risk of wires getting wet. Note that, in this case, the washed parts of FIG. 4 may not include electrical/electronic components such as, for example, first linear actuator 414 and second linear actuator 416. Movement of ingredient 402 from initial chamber 412 to chamber 404 and eventually to chute 424 and elsewhere in the overall system, may utilize force either alone or in combination(s), for example, gravity, pushing via a plunger, pneumatic and/or vacuum, depending on design and engineering choices and considerations. Additionally, at least the interior walls of initial chamber 412, chamber 404, and chute 424 may utilize materials to provide at least a slippery/low friction interior surface, and/or one of high surface tension, and/or high physical phobic tendency, and/or may have small holes shaped to effect a pneumatic push, all of which may assist movement of ingredient 402 for dispensing purposes and cleaning purposes. The extent of initial chamber 412, chamber 404, and chute 424 may extend into its associated valve seat/body 410 so that the material and structure of valve seat/body 410 may not touch ingredient 402. Initial chamber 412 may include a controllable attachment such as a grinder, to provide ‘fresh ground’ ingredient 402 into other area of initial chamber 412.

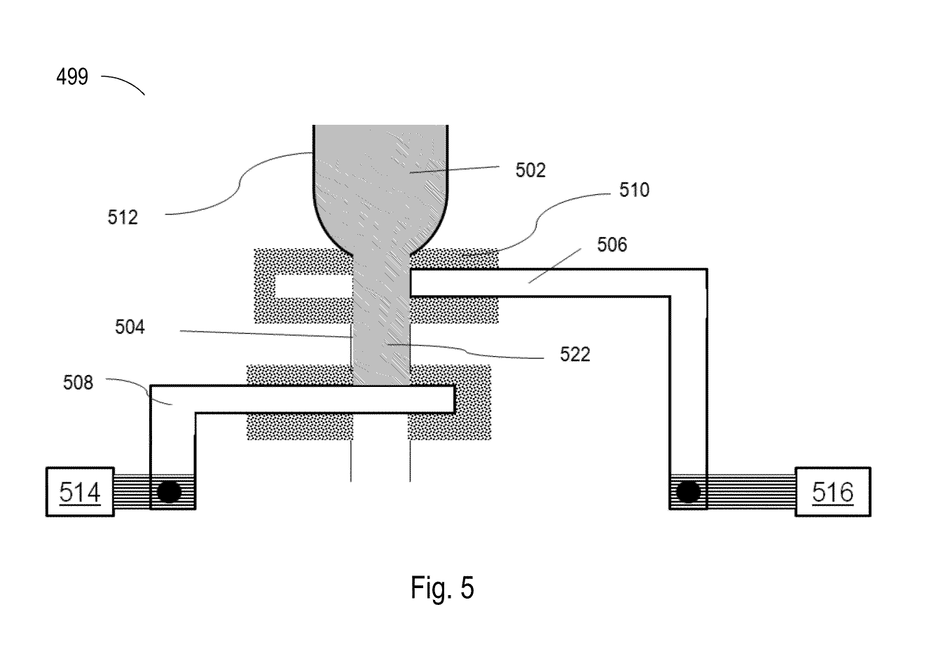

As illustrated in FIG. 5, the valve system 499 of FIG. 4 may be controlled/manipulated to where first valve 506 is in “open” position and second valve 508 is in “closed” position, and illustrates a step in providing the ingredients in a controlled manner to the cooking area of the overall system. In this case, ingredient 502 moves from the initial chamber 512 to the chamber 504, thus a first portion 522 of ingredient 502 is now disposed within chamber 504. Analogously numbered and/or illustrated objects in FIG. 5 may have similar meanings and functions as described in FIG. 4, for example, valve seat/body 510 is analogous to valve seat/body 410 of FIG. 4, and so on. Note that the size of chamber 504 may be determined by the application. For example, if the valve system in FIG. 5 is used to deliver salt, the size of the chamber 504 may be a quarter of a teaspoon. If a particular food item needs 5 teaspoons, the valve system would have to work about 20 times to provide the 5 teaspoons.

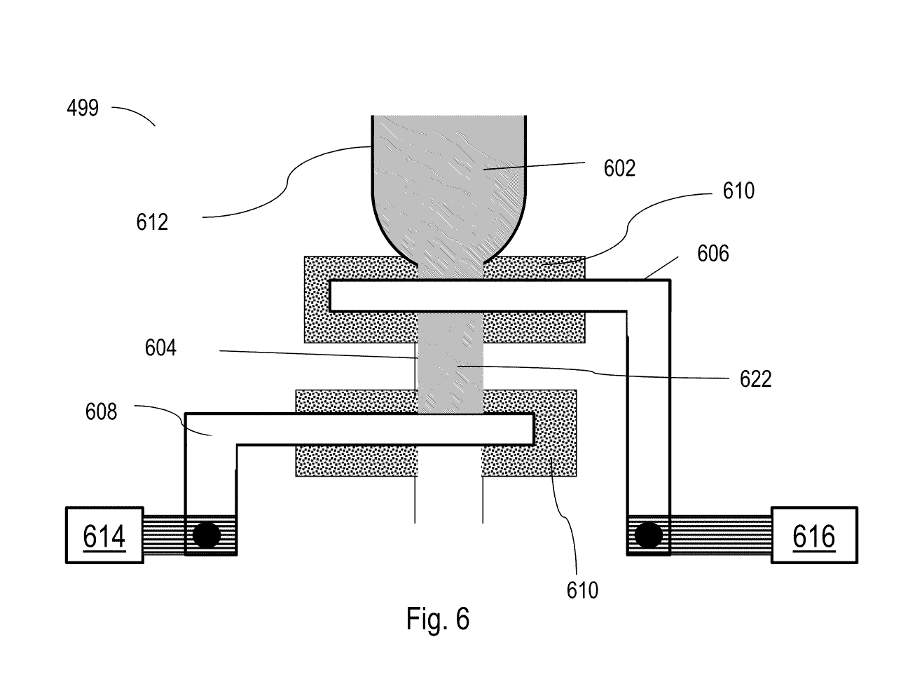

As illustrated in FIG. 6, the valve system 499 of FIG. 4 may be further controlled/manipulated to provide the next step of providing the ingredients, where both first valve 606 and second valve 608 are in the “closed” position. A controlled amount of ingredient first portion 622 is present in the chamber 604. The amount of first portion 622 may be controlled by at least approximately the volume of chamber 604 or the time first valve 606 was open previously, or the shape and size of first valve 606, the opening size/shape of 612 into 610, or combinations thereof. The linear actuators (first linear actuator 614 and second linear actuator 616 in this figure) could be a solenoid actuator, a mechanism that includes a motor (e.g., a built-in motor) or some other equivalent mechanism, for example, a piezoelectronic type actuator. Analogously numbered and/or illustrated objects in FIG. 6 may have similar meanings and functions as described in FIG. 4 or FIG. 5, for example, valve seat/body 610 is analogous to valve seat/body 410 of FIG. 4, valve seat/body 510 of FIG. 5, and so on.

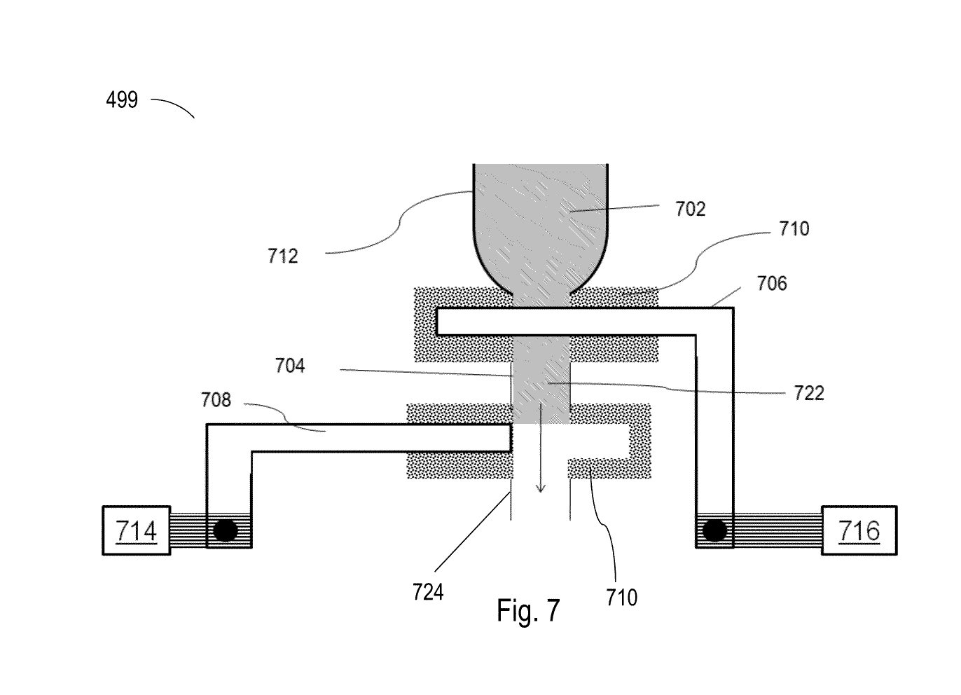

As illustrated in FIG. 7, the valve system 499 of FIG. 4 may be further controlled/manipulated to provide the next step of providing the ingredients, where first valve 708 is in the “open” position while second valve 706 is in the “closed” position. The ingredient first portion 722 may then be transferred into the food vessel thru chute 724. Analogously numbered and/or illustrated objects in FIG. 7 may have similar meanings and functions as described in FIG. 4, FIG. 5 or FIG. 6, for example, valve seat/body 710 is analogous to valve seat/body 410 of FIG. 4, valve seat/body 510 of FIG. 5, valve seat/body 610 of FIG. 6, and so on.

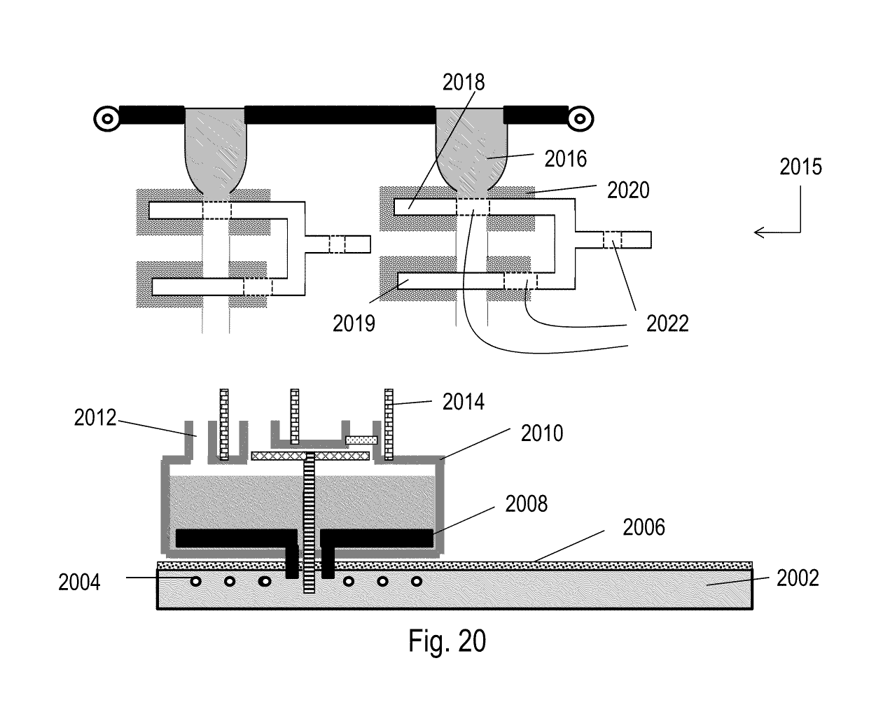

FIG. 4-7 therefore illustrate an example valve system which has two chambers and two valves to provide a controlled amount of ingredients to at least a cooking vessel. Actuators may be separated from the valve mechanism using fasteners so that wires in actuators do not have risk of getting wet during washing of the ingredient containers. It will be appreciated by one skilled in the art that several variations of FIG. 4-FIG. 7 are possible. The valve types need not be gate valves, the valves and valve seats and valve bodies themselves may have different configurations to reduce leakage and the mechanism for connecting the linear actuator to the valve may be different. FIG. 20 herein illustrates an example of an alternative embodiment of a valve system in an automated ingredient delivery system.

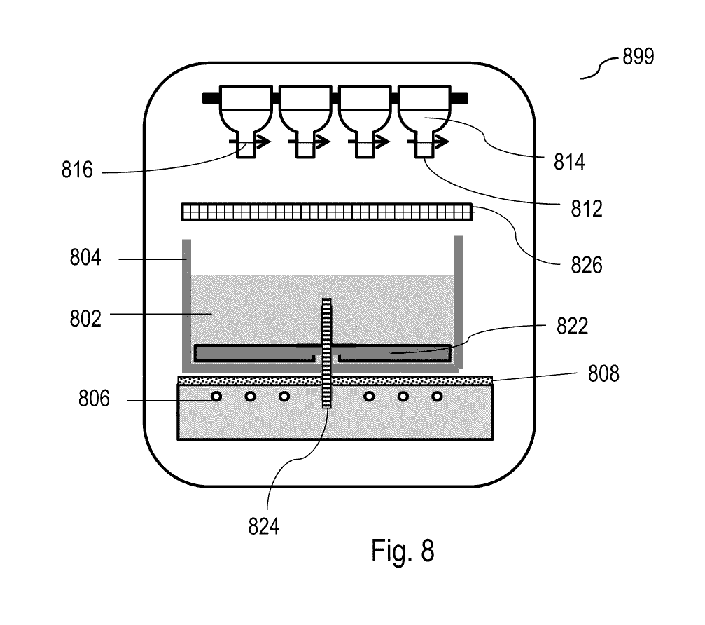

FIG. 1 described a two chamber system wherein the resting location of the ingredient delivery system was in another chamber compared to the vessel where the food was cooking. As illustrated in FIG. 8, an example automated cooking machine/apparatus 899 which uses a single chamber ingredient delivery system may be constructed and may include an induction cooking apparatus, a mixer, an automated ingredient delivery system (which may be mounted on/to a Cartesian bot system) and a user interface, and describes at least an embodiment of this invention. Example automated cooking machine/apparatus 899 may include cooking vessel 804, food being cooked 802, induction heating coil 806, a cover plate 808, mixer blades 822, stir/mix apparatus 824, an ingredient 814, a valve system 816 for providing ingredients, ingredient container 812, and ventilation 826. Ventilation 826 may be provided along the sides of the unit, bottom of the unit or on the top of the unit, and may be divided in multiple manifolds which may be independently controlled. Gaps (not shown) may be designed into ventilation 826 such that ingredient 814 may fall from an ingredient container 812 into cooking vessel 804. Portions of ventilation 826 may be designed to movable.

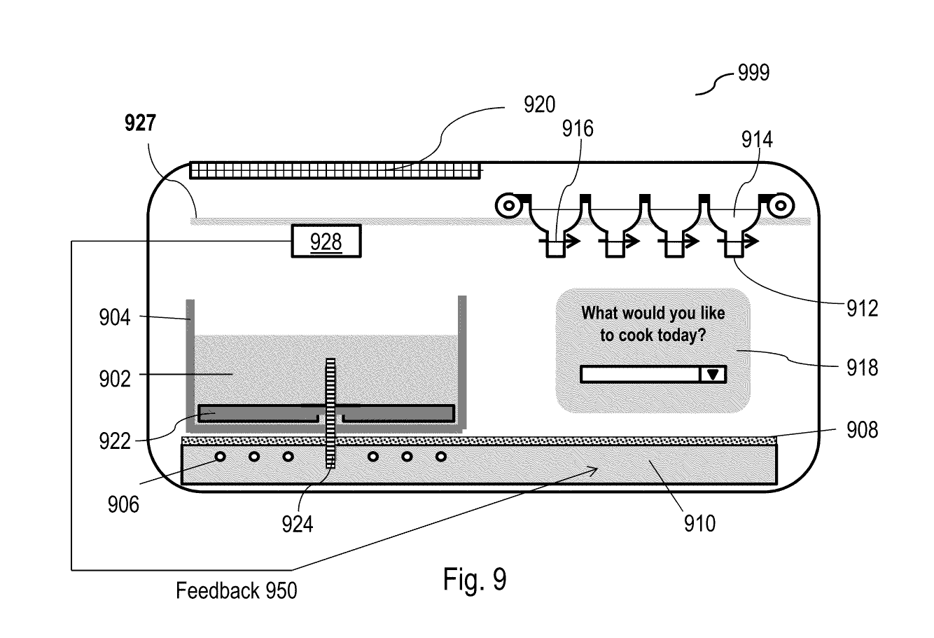

Sensors for tracking food quality, such as calories, water content, firmness, bacteria, burning, temperature and various other items/characteristics are available. As illustrated in FIG. 9, an example automated cooking machine/apparatus 999 where sensor 928 may be used to sense quality of the food and provide feedback 950 to the controller electronics present in portion of the electronics 910 to modulate the cooking process, and may include an induction cooking apparatus, a mixer, an automated ingredient delivery system and a user interface, and describes at least an embodiment of this invention. Automated cooking machine/apparatus 999 with sensor 928, depending on design, manufacturing and feature considerations, may include food material 902, vessel 904, induction coil 906, cover plate 908, portion of the electronics 910, containers 912, ingredients 914, valve systems 916, user interface 918, ventilation 920, blades 922, stir/mix apparatus 924, chamber wall (not shown) and rail 927. Modulation of the cooking process may include, for example, changing the temperature of the cooking process, changing the recipe (e.g. changing the amount of oil added to the food if the calorie count is high already or reducing the amount of water added for cooking the food if the moisture content is high, changing a seasoning dispense/cook temperature gradient to achieve a color/browning effect desired), etc. The recipe can be tailored to optimize the food quality using the controller circuits. The controller may be a proportional controller, a PD controller, a PID controller or some other type. The blades 922 may be optimized for the cooking application. For example, the blades may go close to the bottom or even to the bottom of the cooking vessel to prevent food accumulating near the bottom of the vessel and getting burnt. The blades 922 may also be optimized for cutting food items. One may use different blades or rotation speeds for cutting various materials. Communication between sensor 928 and portion of the electronics 910 to effect feedback 950 may utilize conductive wires or may be wireless. It will be clear to one skilled in the art that alternative embodiments, where sensors are present for safety reasons, may be used, for example, motion sensors and/or IR sensors (cook temp and/or presence of human hand), and so on.

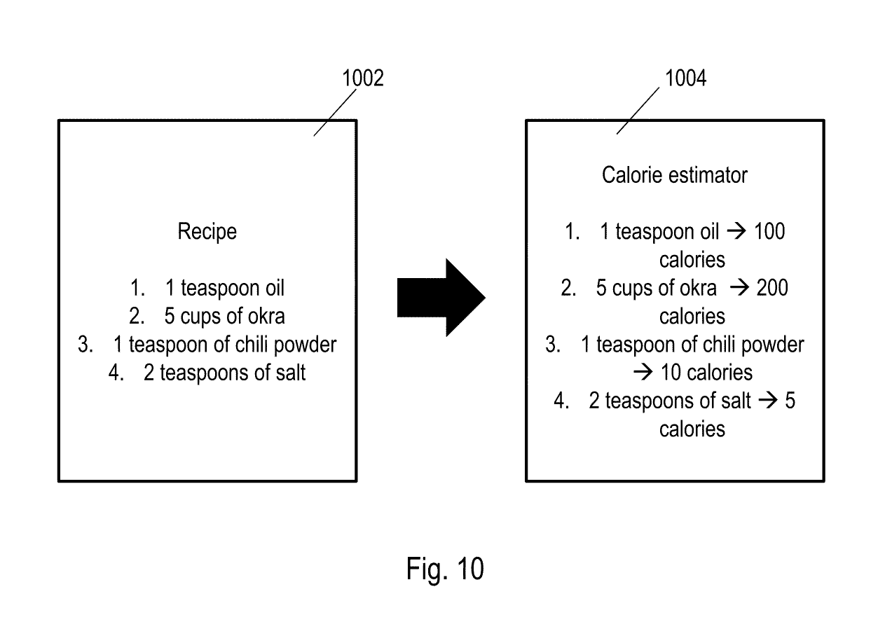

As illustrated in FIG. 10, a user of an automated cooking machine/apparatus presented herein may obtain information 1004 about the prepared food based on at least the ingredients used in the recipe 1002, and describes at least an embodiment of this invention. For example, this could include calorie count, amount of different vitamins in the food, effect of the temperature cycle chosen on the vitamin amount remaining and various other information, such as water content, allergic check with user specified substances, and so on. After the food is cooked, the user can provide feedback to personalize and/or improve the cooking process of the food item for the next round of cooking. The user may also be able to select the type of cooking (e.g. low calorie, low fat, etc.) before the cooking process starts based on the predictive information given by the user interface for various recipes. Recipes which allow the user's preference may be preferentially selected.

According to an embodiment of this invention, the recipe may be downloaded from a network and the cooking apparatus could be designed to be secure and not reveal some or all the details of the recipe to the user. For example, the temperature profiles used during the cooking process may not be revealed. This could allow “recipe rentals” that give high-quality food and potentially help protect the intellectual property of the recipe-holder.

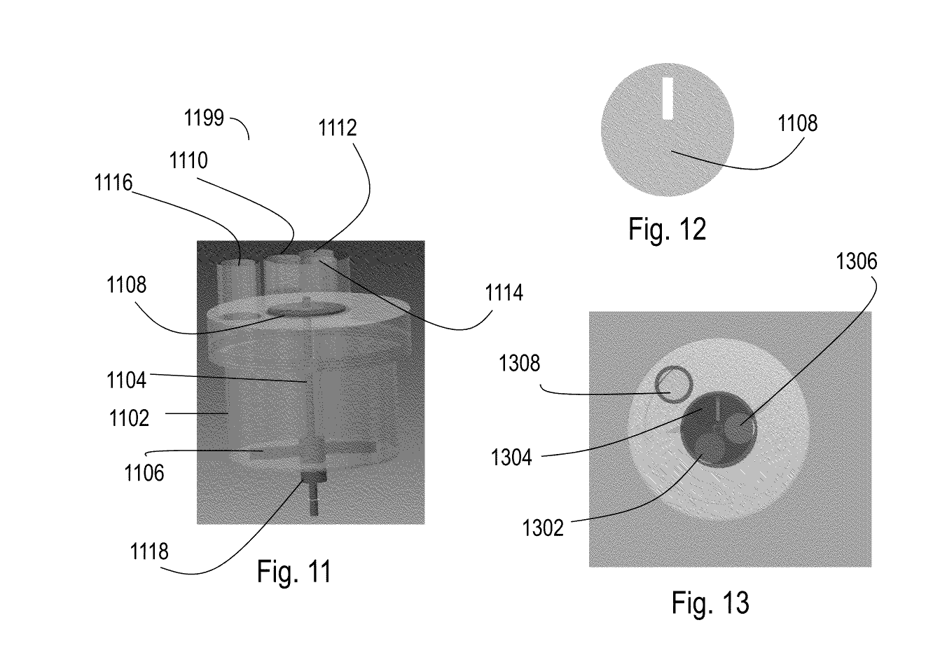

Conventional food processors use several cutting/chopping blades, and can cause a user inconvenience due to frequent and cumbersome changing of blades. For example, while preparing a food item where some ingredients need to be grinded into fine pieces, while other ingredients need to be diced, the user may need to change the blades manually in between. This also makes designing an automated cooking machine difficult. FIGS. 11-13 describe an embodiment of this invention, which describes a machine that may be used for cutting, grinding, dicing or other alternative food processing applications.

As illustrated in FIG. 11, food processor 1199 may be constructed (e.g., a chopping system or sub-system). Food processor 1199 may include vessel 1102, first shaft 1104, first blade 1106 and second blade 1108, first opening 1110, second opening 1112, third opening 1114, fourth opening 1116, second shaft 1118. First blade 1106 and second blade 1108 may include multiple types of blades. For example, FIGS. 11-13 show first blade 1106 as an S blade, which could be used for grinding and fine chopping, and show second blade 1108 as a slicing blade. While these types of blades are used as an example in this explanation, one skilled in the art will realize that multiple types of blades and cutting operations are possible. FIG. 12 illustrates a top view of second blade 1108 as a slicing blade option. First shaft 1104 and second shaft 1118 may include shafts which may be connected to one or more motors to rotate and thereby cause the food processing operation to be performed. First shaft 1104 and second shaft 1118 may be rotationally spun and may also include a vertical motion component (vertical direction being along the shaft, substantially perpendicular to the rotational motion—if any). Depending on design considerations, first shaft 1104 and second shaft 1118 may be adapted to run at different speeds and motions; for example, first shaft 1104 may run clockwise at 100 rpm and second shaft 1118 may be running at 50 rpm counter-clockwise). First blade 1106 may be connected/coupled to second shaft 1118 and run at substantially the same speeds and motions as second shaft 1118. Second blade 1108 may be connected/coupled to first shaft 1104 and run at substantially the same speeds and motions as first shaft 1104. Food ingredients that may need to be processed may be dropped through first opening 1110, second opening 1112, third opening 1114, and/or fourth opening 1116, depending on the type of food processing operation that may need to be performed. FIG. 13 illustrates a top view of the openings of example food processor 1199 of FIG. 11. Some of these openings may have attachments (e.g. dicing grids of different dimensions) placed in them. For example, first opening 1302 and second opening 1304 may have two sizes of dicing grids, while third opening 1306 and fourth opening 1308 may not have dicing grids, allowing the food to fall directly to first blade 1106 (thereby missing second blade 1108 but not first blade 1106) or optionally thru the blade portion of the processor entirely (not shown); hence missing both first blade 1106 and second blade 1108. For the example illustrated in FIG. 11-13, if a food ingredient needs to be diced into fine pieces, it may be dropped down first opening 1302 or if a food ingredient needs to be finely ground, it may be dropped down fourth opening 1116 and the S blade of first blade 1106 may be rotated. The food ingredient may be pushed down fourth opening 1116, for example, with a plunger (not shown), a mechanical device which applies downward pressure. Other methods may be used to move the food to and thru an opening, and to and thru a blade; for example, gravity, pneumatic and/or vacuum, depending on design and engineering choices and considerations. First blade 1106 and second blade 1108 may be removable. One skilled in the art will recognize that various mechanisms may be used to connect blades first blade 1106 and second blade 1108 to shafts first shaft 1104 and second shaft 1118 and to the motors (not shown). One or more of the blades first blade 1106 and second blade 1108 may optionally be rotated in a reverse direction if needed or swapped with other blades. While FIG. 11 used two blades and four openings as an example, various other numbers of blades and openings may be used.

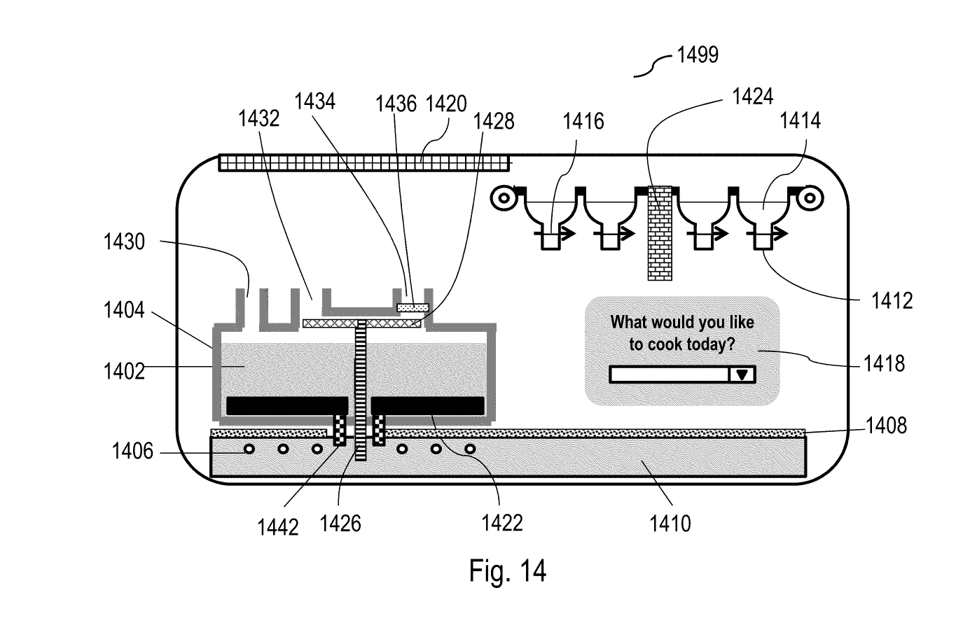

As illustrated in FIG. 14, an example automated cooking machine/apparatus 1499 may be constructed and may include an induction cooking apparatus, a mixer, an automated ingredient delivery system and a user interface, and describes at least an embodiment of this invention. Automated cooking machine/apparatus 1499 may include a Cartesian bot system for delivering ingredients to the cooking vessel 1404. Automated cooking machine/apparatus 1499, depending on design, manufacturing and feature considerations, may include food material 1402, vessel 1404, induction coil 1406, cooktop cover 1408, portion of the electronics 1410, containers 1412, ingredients 1414, valve systems 1416, user interface 1418, ventilation 1420, first blade 1422, plunger 1424, first shaft 1426, second blade 1428, rail (not shown), first opening 1430, second opening 1432, third opening 1434, dicing grid 1436, and second shaft 1442. Analogously numbered and/or illustrated objects in FIG. 14 may have similar meanings and functions as described in FIG. 1, for example, induction coil 1406 is analogous to induction coil 106 of FIG. 1, and so on.

Ingredients 1414 to be used for cooking may be placed in containers 1412 which may include valve systems 1416 which control the amount of ingredients 1414 to be dispensed into the cooking vessel 1404. The assembly which includes food ingredients and valves may be mounted atop a Cartesian bot system, which may include motors and position control mechanisms which move the food ingredient containers to various locations in the automated cooking machine/apparatus 1499, include above the cooking vessel 1404. Cartesian bot systems are familiar to those skilled in the art, since they are widely used in 3D printers, Computer Numerical Control Machinery, biomedical instruments and various other applications. They can move to points in the X, Y and/or Z co-ordinate systems. Cooktop cover 1408 may be made of glass or ceramic or other materials or combinations of them. Induction coil 1406 may include the coil used for induction cooking. Cooktop cover 1408 may be constructed, for example, with a metal which may lead to induction heating occurring on the metal. Portion of the electronics 1410 may include various electronic components for controlling the cooking, user interface 1418, the Cartesian bot and various other electronic functions needed for the automated cooking machine in FIG. 14. Many of the elements of FIG. 1 may be similarly labeled in FIG. 14 and those shapes would have a similar function in FIG. 14 as in FIG. 1.

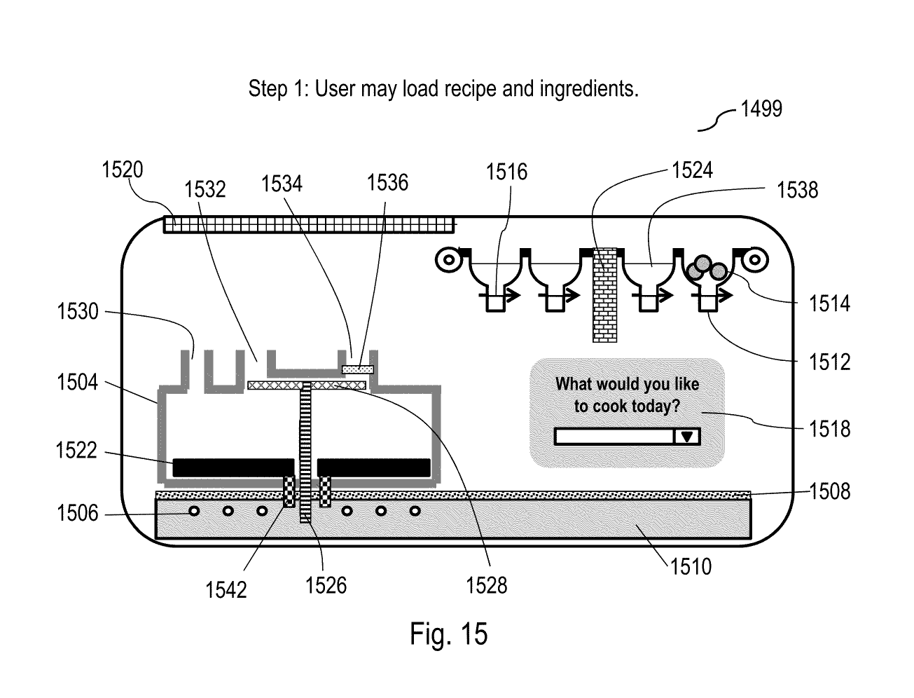

Various elements of the food processing machine shown in FIG. 13 are also illustrated in FIG. 14. First opening 1430, second opening 1432, and third opening 1434 are examples of openings through which ingredients may be dispensed. Dicing grid 1436 may have similar functions and characteristics as the dicing grids of FIGS. 11-13 herein. Second blade 1428 and first blade 1422 may be blades used for food processing or mixing the food. First shaft 1426 may be a shaft coupling second blade 1428 to a motor (not shown). The blades second blade 1428 and/or first blade 1422 may be connected to two shafts (first shaft 1426 and second shaft 1442) that may be driven by multiple motors or a single motor alone with a gearbox (not shown). The blade first blade 1422 may be designed to allow both stirring and cutting. For example, the shaft connected to first blade 1422 may be set up so that it may rotate in two directions. When rotated in one direction, the first blade 1422 may have sharp blades meant for cutting food items get into contact with the food, while when rotated in the opposite direction, the first blade 1422 may have “stirrer-type edges” that may not substantially cut the food and may be useful for at least stirring it. For the stirrer functions and motions, the speed of rotation may be slower than for the cutter function. It will be clear to one skilled in the art that more than two blades may potentially be used. The plunger 1424 in the automated ingredient delivery system of automated cooking machine/apparatus 1499 may be used to apply downward pressure on the ingredients dispensed down an opening in the cooking vessel. It will be clear to one skilled in the art that various alternative embodiments for the food processing and mixing functions are feasible and may be combined with the automated ingredient delivery system. It will also be clear to one skilled in the art that the Cartesian bot may be customized to move in 1 dimension (e.g. X, Y or Z), 2 dimensions (e.g. XY, YZ or XZ), 3 dimensions (e.g. XYZ) or more dimensions based on the configuration of the automated cooking machine. The recipe used for cooking may be entered in or shown on the user interface 1418. Based on the recipe, a sequence of operations may be performed on the automated cooking machine. An example sequence of operations for the automated cooking machine/apparatus 1499 in FIG. 14 will now be described in FIG. 15-FIG. 18.

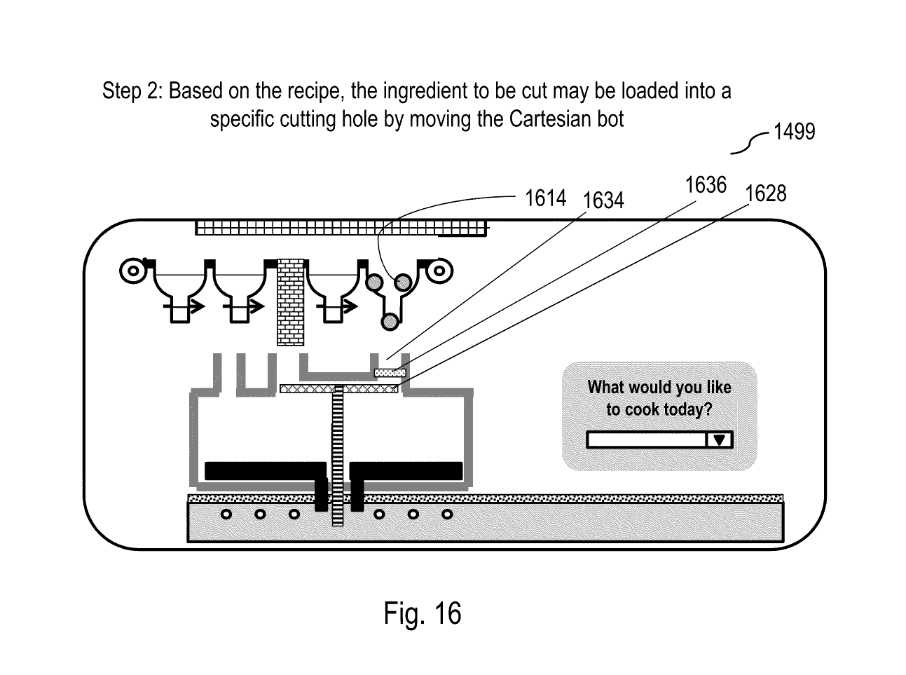

FIG. 15-FIG. 18 illustrate an example sequence of operations on the automated cooking machine/apparatus 1499 shown in FIG. 14. In these figures, for ease of illustration, several items may be labeled in FIG. 15 and those shapes would have a similar function in FIG. 16-FIG. 18.

Ingredients to be cooked (e.g. first ingredient 1538, second ingredient 1514) may be loaded into the automated ingredient delivery system at the start of the cooking process as shown in FIG. 15. This may be done by the machine's user. The recipe for cooking may be loaded onto the automated cooking machine at this point as well. Containers 1512 for the ingredients may have valves 1516 to control the flow of material. A mass (e.g., weight) measurement sensor (not shown) may be located on the automated ingredient delivery system, and flow controllers may be optionally used. These systems may optionally be used to help the user put in only a specific quantity of ingredients into the automated ingredient delivery system initially. The system may optionally include systems shown, for example, earlier in this patent application, such as, for example, the system in FIG. 4-7. Represented in this figure, the example automated cooking machine/apparatus 1499 may include plunger 1524, ventilation 1520, user interface 1518 which may include a display and associated electronics, induction cooking apparatus 1506, cooktop cover 1508 may be a plate made of glass or ceramic or other material, portion of electronics 1510 may be electronics for controlling various tasks in the automated cooking machine, cooking vessel 1504, first blade 1522 and second 1528 may be blades used for cutting or mixing the food in future steps, first shaft 1526 and second shaft 1542 may be shafts which may be coupled to motors (not shown), first opening 1530, second opening 1532 and third opening 1534 may be openings in the cooking vessel 1504, and dicing grid 1536.

FIG. 16 illustrates an example next step in the example cooking process. Based on the recipe, a controlled amount of ingredient 1614 may be put into one of the openings by moving the Cartesian bot which holds the ingredient containers and other parts of the automated ingredient delivery system. In this example, the recipe indicates ingredient 1614 needs to be diced, thus ingredient 1614 may be dispensed into the opening 1634. As illustrated in FIG. 16, automated cooking machine/apparatus 1499 may include dicing grid 1636 and blade 1628.

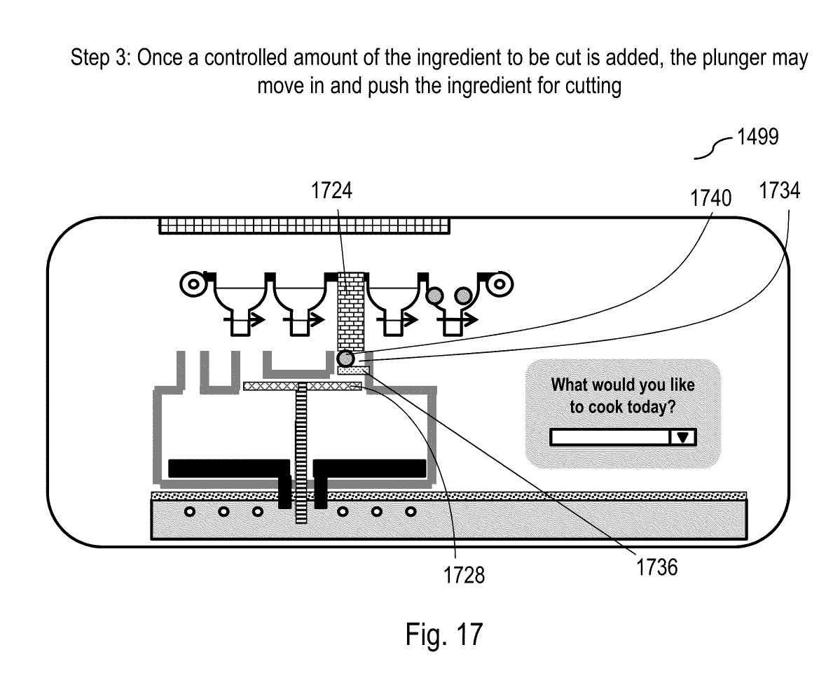

FIG. 17 illustrates an example next step in the example cooking process in which the plunger 1724 may be moved by the Cartesian bot to push the ingredient to be diced 1740 down the opening 1734. The dicing grid 1736 and blade 1728 can then dice the material, ingredient to be diced 1740. Other ingredients to be put into the cooking vessel may also be dispensed using methods that will become apparent to one skilled in the art based on at least FIG. 16 and FIG. 17.

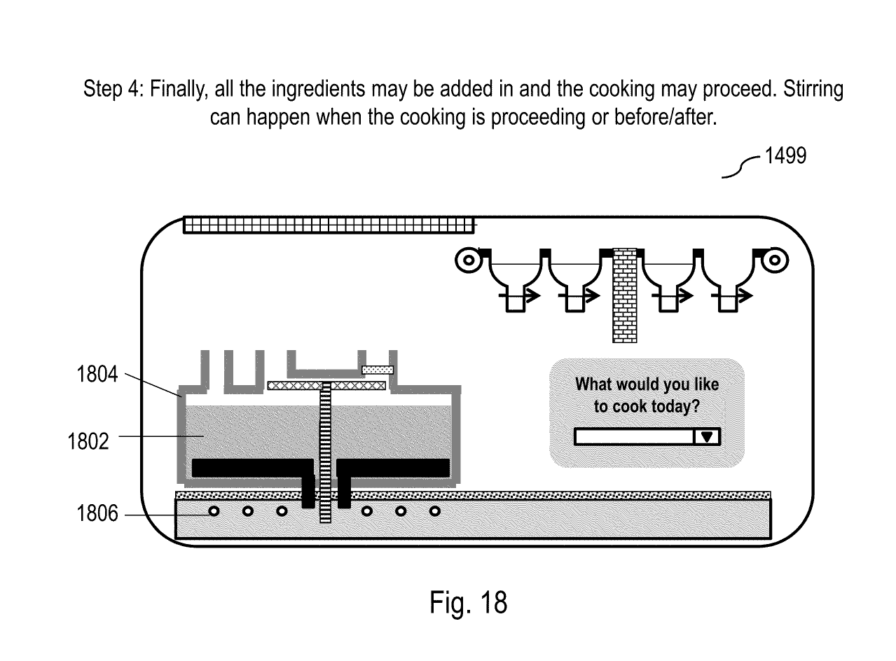

FIG. 18 illustrates the next step in the example cooking process where all the ingredients may be added into the cooking vessel 1804 and food 1802 may be prepared and cooked using the induction cooking burner 1806. Mixing/stirring can be done during cooking using the blades present in the automated cooking machine, as well as before or after cooking.

The steps in FIGS. 15-18 may be run automatically by following a recipe stored electronically. The recipe may be stored, for example, in the cloud, in local memory, on a user's phone or other personal device. Various alternative recipes could result in a different sequence of operations. It will be clear to one skilled in the art that FIG. 15-FIG. 18 represents just one example of how the automated cooking machine/apparatus 1499 of FIG. 14 may be used. For example, the cooking and ingredient delivery can be split and can proceed at various points in the cooking process (which would be different from what is depicted in FIG. 15-FIG. 18). Several other variations and embodiments may be possible, which would be apparent to one skilled in the art based on the teaching herein.

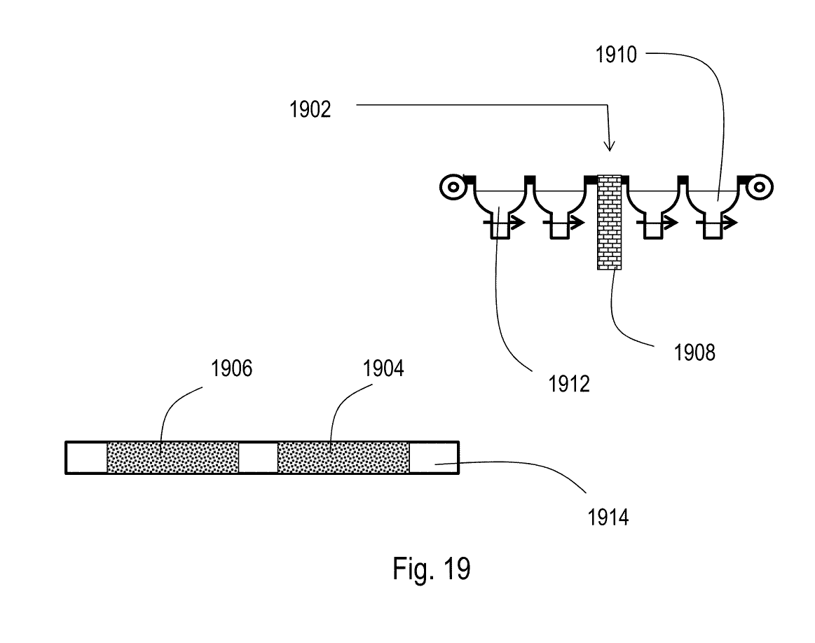

While FIGS. 1-18 showed a single burner automated cooking machine/apparatus, an embodiment of the invention may have multiple heating devices. For example, automated cooking machine/apparatus 1499 of FIG. 14, may have more than one heating device, for example multiple burners, multiple induction heaters, IR heaters, and so on. The automated ingredient delivery system may be shared between heating device in such cases. One or more of the heating devices may be utilized for pre-heating, searing, cool down, quench, and other functions within a recipe or multiplicity of recipes. As illustrated in FIG. 19, an example automated cooking machine/apparatus 1499 may be constructed and may include more than one heating device and describes at least an embodiment of this invention. Automated cooking machine/apparatus 1499 may include cooktop 1914, which may include a first heating device 1904 and a second heating device 1906. The automated ingredient delivery system 1902 may include a Cartesian bot which may be positioned atop any burner in the cooktop, deliver recipe necessary ingredients such as first ingredient 1910 and second ingredient 1912 and stir the food. It may optionally include a plunger 1908. Temperatures and performance of first heating device 1904 and second heating device 1906 may be controlled using a recipe which may either be directly loaded on the cooktop or loaded onto the Cartesian bot/Automated ingredient delivery system. Communication between the Cartesian bot/automated ingredient delivery system and the Cooktop may proceed wirelessly and/or with wires.

As illustrated in FIG. 20, an example automated cooking machine/apparatus may be constructed and operated wherein the ingredient dispensing process may be conducted without requiring solenoid actuators on the ingredient dispensing system, and describes at least an embodiment of this invention. The sections of the automated cooking machine/apparatus, for example, automated cooking machine/apparatus 1499 of FIG. 14, that help explain the ingredient dispensing process are shown in FIG. 20, while some other parts of the automated cooking machine 1499 are not shown for simplicity. The example portions of automated cooking machine/apparatus 1499 illustrated in FIG. 20 may include heating coils 2004 for induction cooking, cooktop cover 2006 may be a plate made of glass, plastic, metal, ceramic or some other material, portion of the electronics 2002 and/or other parts of the induction cooktop, cooking vessel 2010, a blade 2008 of the food processor, opening 2012 through which ingredients may be dispensed, and protrusion 2014 which may be used advantageously during the ingredient dispense operation, and at least one Cartesian bot with ingredient dispenser 2015, which may include first gate valve 2018 and second gate valve 2019, material to be dispensed 2016, openings in the gate valve 2022 system through which material may be dispensed, and gate valve seats 2020. It will be clear to one skilled in the art that several variations of the gate valve system shown in FIG. 20 are possible. It will also be clear to one skilled in the art that various types of cooking vessel 2010 may be used. This may include open vessels, closed ones, pressure-cooking friendly vessels, woks and entirely different vessels.

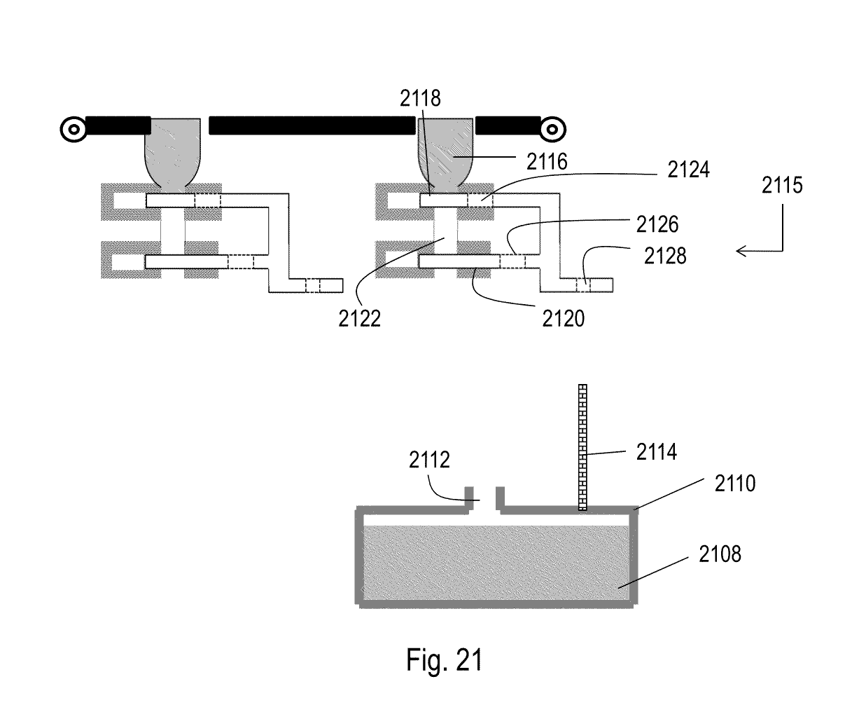

Example methods of operation of the apparatus in FIG. 20 will now be described in FIG. 21-FIG. 24.

FIG. 21-FIG. 24 illustrate at least one embodiment of this invention which describe a process for dispensing ingredients of an example automated cooking machine/apparatus. The sections of the automated cooking machine/apparatus, for example, automated cooking machine/apparatus 1499 of FIG. 14, that help explain the ingredient dispensing process are shown in FIGS. 21-24, while some other parts of the automated cooking machine are not shown for simplicity. The portions of the apparatus which are essential for describing the working of the ingredient dispense function are shown in these figures.

The example portions of automated cooking machine/apparatus 1499 illustrated in FIG. 21 may include food item being cooked 2108, cooking vessel 2110, opening 2112 through which ingredients may be dispensed, and protrusion 2114 which may be used advantageously in the cooking process, and at least one Cartesian bot with ingredient dispenser 2115, which may include ingredient 2116, first gate valve 2118 and second gate valve 2120, chamber 2122, first opening 2124, second opening 2126 and third opening 2128. In the step shown in FIG. 21, both first gate valve 2118 and second gate valve 2120 are in a closed position and only a negligible amount of material may be present in chamber 2122.

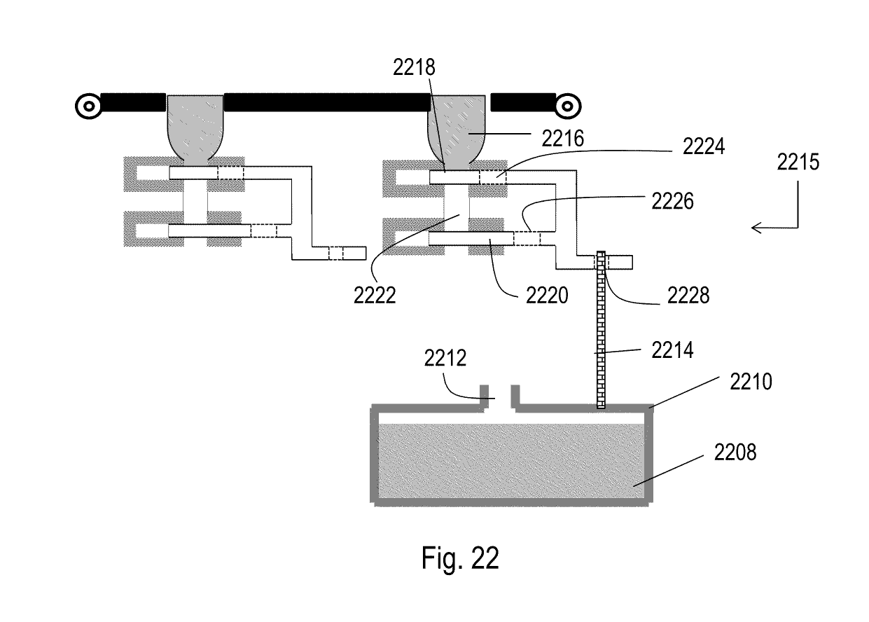

FIG. 22 illustrates a next step in the ingredient dispensing function. The example portions of automated cooking machine/apparatus 1499 illustrated in FIG. 22 may include food item being cooked 2208, cooking vessel 2210, opening 2212 through which ingredients may be dispensed, and protrusion 2214 which may be used advantageously in the cooking process, and at least one Cartesian bot with ingredient dispenser 2215, which may include ingredient 2216, first gate valve 2218 and second gate valve 2220, chamber 2222, first opening 2224, second opening 2226 and third opening 2228. In the step shown in FIG. 22, the Cartesian bot's position has been moved so that the protrusion 2214 may fit into the opening 2228. In the step shown in FIG. 22, both first gate valve 2218 and second gate valve 2220 are in a closed position and thus only a negligible amount of material may be present in chamber 2222.

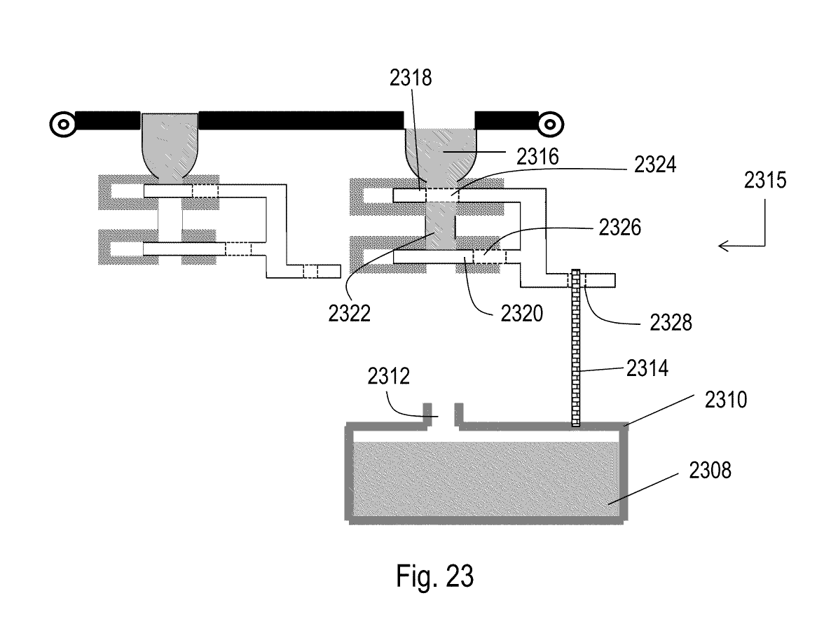

FIG. 23 illustrates a next step in the ingredient dispensing function. The example portions of automated cooking machine/apparatus 1499 illustrated in FIG. 23 may include food item being cooked 2308, cooking vessel 2310, opening 2312 through which ingredients may be dispensed, and protrusion 2314 which may be used advantageously in the cooking process, and at least one Cartesian bot with ingredient dispenser 2315, which may include ingredient 2316, first gate valve 2318 and second gate valve 2320, chamber 2322, first opening 2324, second opening 2326 and third opening 2328. FIG. 23 indicates a stage in the ingredient dispensing function wherein the Cartesian bot with ingredient dispenser 2315 has been moved such that first gate valve 2318 may be in an open position and second gate valve 2320 may be in a closed position, thus chamber 2322 may be filled with a portion of ingredient 2316.

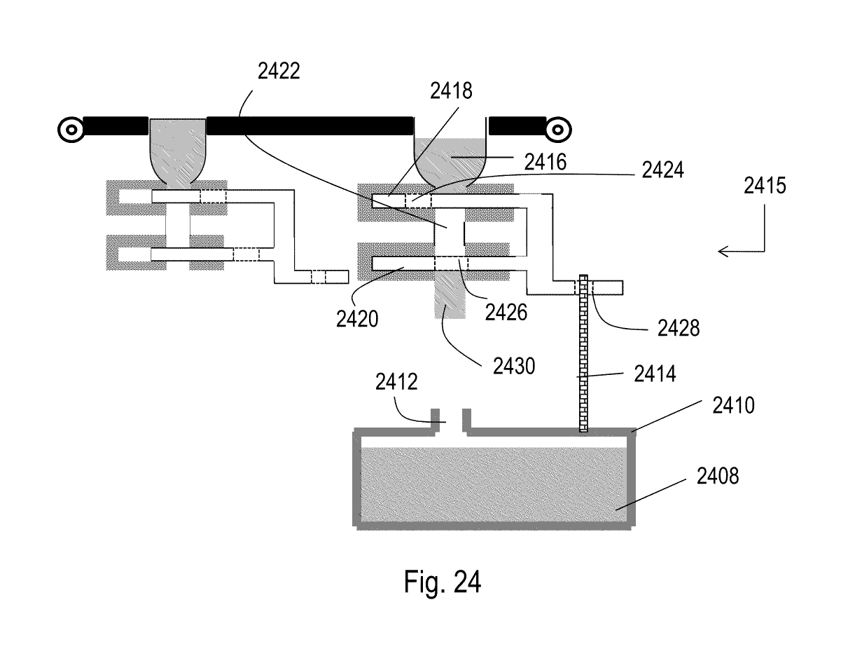

FIG. 24 illustrates a next step in the ingredient dispensing function. The example portions of automated cooking machine/apparatus 1499 illustrated in FIG. 24 may include food item being cooked 2408, cooking vessel 2410, opening 2412 through which ingredients may be dispensed, and protrusion 2414 which may be used advantageously in the cooking process, and at least one Cartesian bot with ingredient dispenser 2415, which may include ingredient 2416, first gate valve 2418 and second gate valve 2420, chamber 2422, first opening 2424, second opening 2426 and third opening 2428. FIG. 24 indicates a stage in the ingredient dispensing function wherein the Cartesian bot with ingredient dispenser 2415 has been moved such that first gate valve 2418 may be in closed position and second gate valve 2420 may be in an open position (second opening 2426 is substantially aligned with chamber 2422), so that material 2430 (previously portion of ingredient 2316) may be dispensed into the opening 2412, and ultimately be joined with food item being cooked 2408.

The procedure in FIGS. 21-24 provides a procedure and apparatus which makes it possible to dispense ingredients by intelligently using the motion of the Cartesian bot system and thereby avoiding the need to have solenoid valves in the ingredient dispensing system.

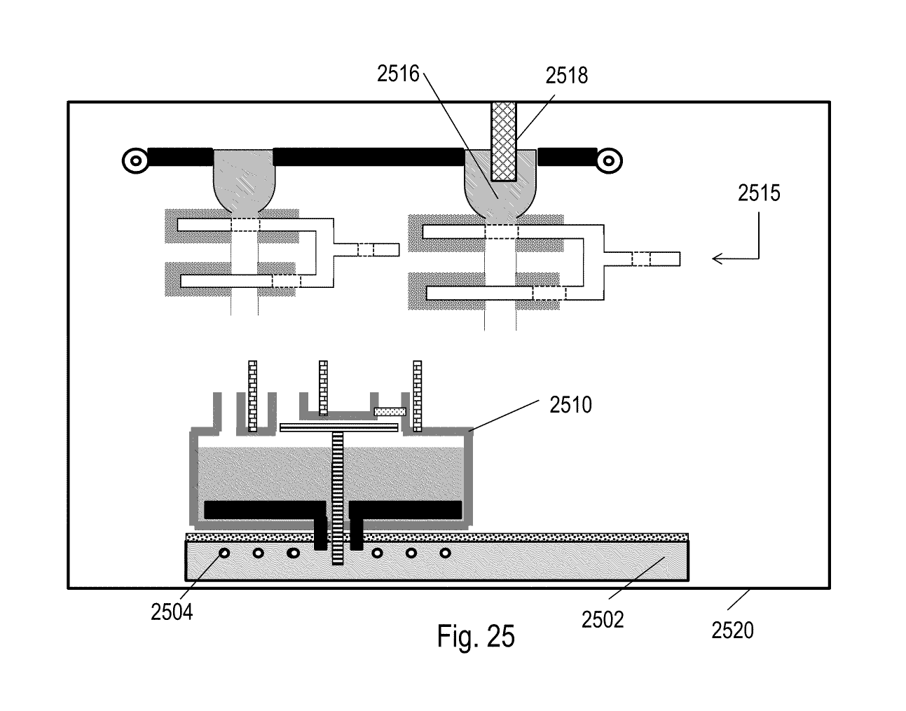

As illustrated in FIG. 25, the motion of the Cartesian bot may be used to help push ingredients down the ingredient dispensing system, and describes at least an embodiment of this invention. Ingredients often tend to get stuck to the sides of the ingredient dispenser and they need a force to push material down into the cooking vessel. FIG. 25 describes a way of using the Cartesian bot motion to apply force and push material down into the cooking vessel. The example portions of automated cooking machine/apparatus 1499 illustrated in FIG. 25 may include portion of electronics 2502, coils for the induction cooktop 2504, cooking vessel 2510, Cartesian bot system having an ingredient dispenser 2515, food material to be dispensed 2516, frame of the automated cooking machine/apparatus 2520 and protrusion 2518 which may, for example, be attached to the frame of the automated cooking machine 2520. Using a procedure similar to the one described in FIGS. 21-24, the Cartesian bot may be moved/located such that a force is applied to push food material to be dispensed 2516 down the ingredient dispenser system, thus ultimately into cooking vessel 2510.

A Valve System, which may be Associated with a Food Module

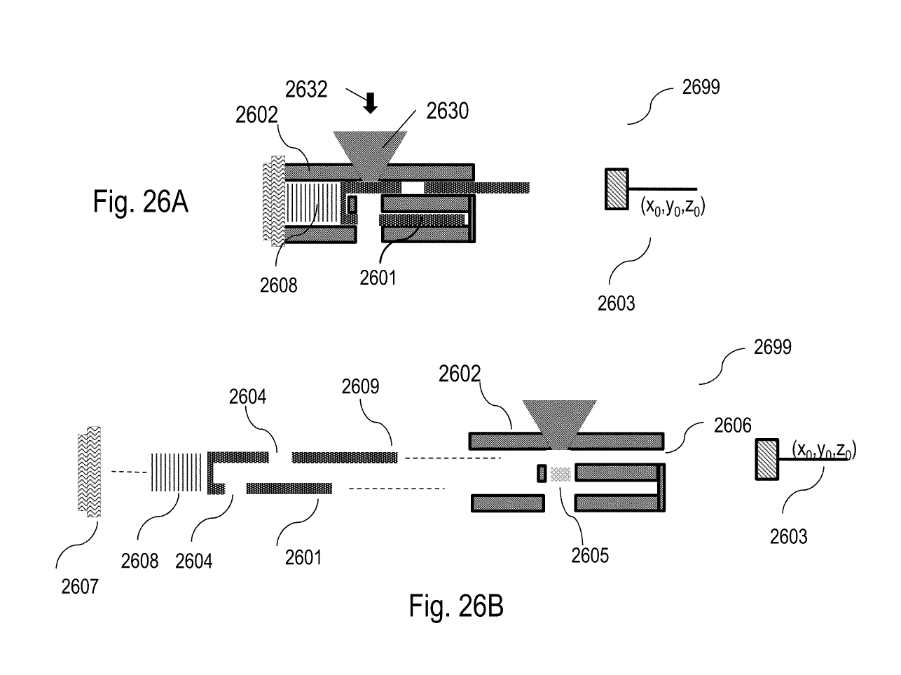

FIG. 26-FIG. 32 illustrate at least one embodiment of this invention, which describe the design and working of a valve system that may be attached to a food module in an automated ingredient delivery system, thus providing a controlled amount of ingredients to the cooking vessel of an automated cooking machine, the components of which may be all be washed in a dishwasher without the electronic wires getting spoiled by exposure to water. It being appreciated that the figures that illustrate the subject matter may not be to scale or to measure. Analogously numbered and/or illustrated objects in FIG. 26-FIG. 32 may have similar meanings and functions.

FIGS. 26A and 26B describe an embodiment of this invention, a sliding valve to control the delivery of food ingredients to an automated cooking device. As illustrated in FIG. 26A, example sliding valve 2699 may include a sliding valve assembly for attachment to a food module at the filler funnel 2630 on the top of the valve housing and filler funnel 2602. As shown, the actuator is in the remote idle default position, allowing a substantially full extension of the sliding valve spring 2608, thus pushing the sliding valve 2601 to the idle, or post-dispenses position.

As illustrated in FIG. 26B, an exploded view of example sliding valve 2699 of one form of a sliding valve assembly for delivering food ingredients. This figure shows that this valve may be disassembled for cleaning. Sliding valve 2699 may easily be separated into four parts; screw-cap cover 2607, tensioning spring 2608, slide valve 2601, valve housing and filler funnel 2602.

The slider valve 2601 in this assembly may include O-rings at/on the inside surface of each of the two sliding valve apertures to seal the interface and improve sliding motion.

Sliding valve 2699 may also include a remote actuator 2603 to control the operation of the valve for ingredient delivery. The remote actuator 2603 is shown parked out of the way, at a default idle position (x₀, y₀, z₀), with the sliding valve spring 2608 fully extended, thus the valve in its default position.

It may be appreciated by those skilled in the art that several designs exist for a movable ingredient stage, and also several mechanisms for moving a stage of food modules with attached sliding valves are possible.

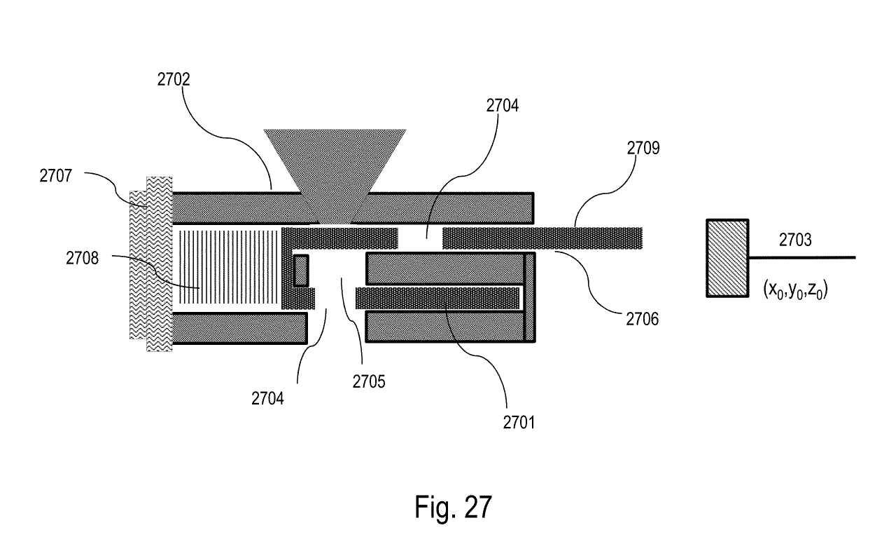

FIG. 27 illustrates a sliding valve assembly for attachment to a food module at the filler funnel on the top of the valve housing and filler funnel 2702. The actuator is in the remote idle position, allowing full extension of the sliding valve spring 2708, pushing the sliding valve 2701 to the default idle position.

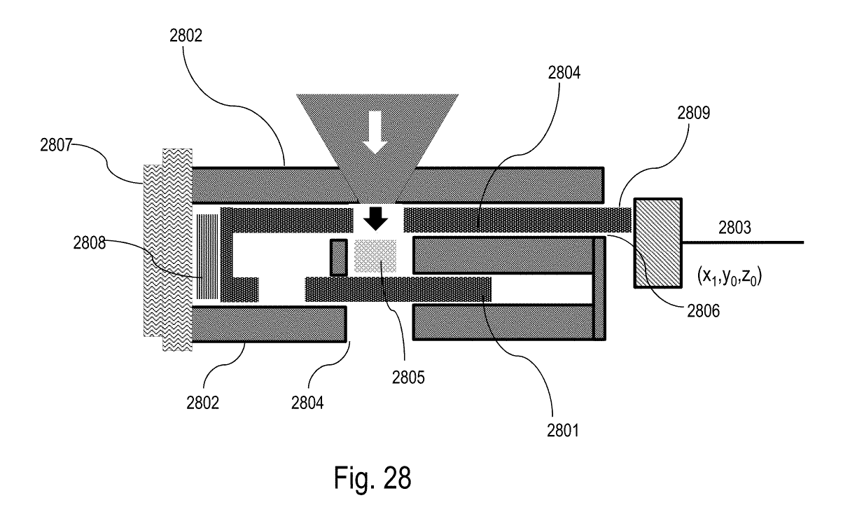

FIG. 28 illustrates an actuator 2803 that moved from its “idle position” (x₀, y₀, z₀) to the “load position” (x₁, y₀, z₀). In doing so, the actuator 2803 may make contact with the pusher shaft 2809, moving the sliding valve 2801 from its idle position to the load position, aligning the top hole 2804 in the sliding valve 2801 with the filler funnel of the valve housing 2802, and the calibrated reservoir 2805 of the valve housing 2802. The resulting vibration, from impact of the sliding valve with the sliding valve spring 2808 and the valve housing screw-on cover 2807, may facilitate maximum transfer of food ingredients from the food module above to load the calibrated reservoir 2805 in the sliding valve assembly.

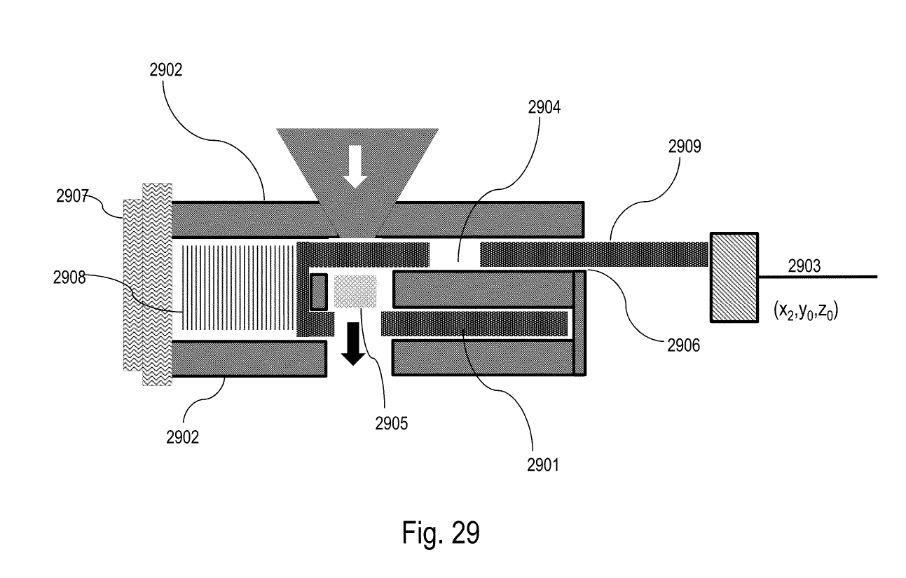

FIG. 29 illustrates an actuator 2903 that is moved from the “Load position” (x₁, y₀, z₀) to the “Dispense position” (x₂, y₀, z₀). In doing so, the actuator 2903, in contact with the pusher shaft 2909, may allow the compressed sliding valve spring 2908 to expand and move the sliding valve 2901 from its load position to the dispense position, now aligning the bottom hole in the sliding valve 2901 with the calibrated reservoir 2905 of the valve housing 2902 and a cooking pot below. The resulting vibration from impact of the sliding valve 2901 with the sliding valve housing 2902, may facilitate total transfer of food ingredients from the calibrated reservoir 2905 in the sliding valve housing and filler funnel 2902 assembly to a cooking pot or other vessel.

It may be appreciated by those skilled in the art that larger quantities of food ingredients may be achieved (in multiples of the calibrated reservoir), when the sliding valve 2901 is cycled between the Load state and Dispense state multiple times.

In the default idle position (x₀, y₀, z₀), the actuator 2903 is in a remote location to minimize interference with other operations in the automated cooking machine. Movement of the actuator 2903 to either of the other two defined positions, the load position (x₁, y₀, z₀) or the dispense position (x₂, y₀, z₀), may be achieved with a change in the x-position alone. With suitable design of the size of the sliding valve shaft 2909 end and the actuator 2903 head, the system may be adapted to be insensitive to significant misalignments in the y, z axis. It may be appreciated by those skilled in the art that several designs exist for a movable ingredient stage, and several mechanisms for moving a stage of food modules with attached sliding valves are possible.

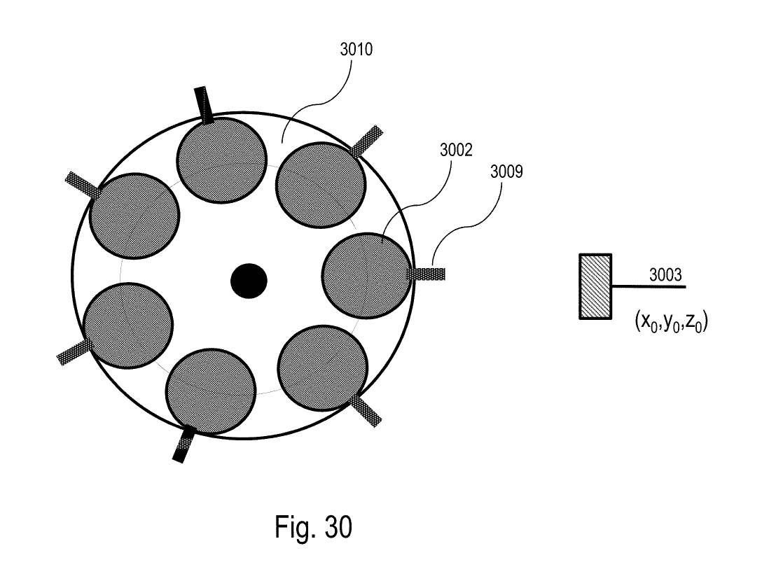

As illustrated in FIG. 30, an example configuration for a rotary assembly of a sliding valve system with a remote manual actuator for a cooking machine in the idle state may be formed, and describes at least an embodiment of this invention. A multiplicity of sliding valve and valve housing 3002 assemblies may be mounted on a rotary platen 3010, with the valve pusher shaft 3009 extending substantially perpendicular to the tangent of the rotary platen 3010.

Each sliding valve and valve housing 3002 assembly may be loaded with a food module. The platen may be rotated to align the desired food module and valve assembly with the remote actuator.

Movement of the actuator 3003 from the idle position (x₀, y₀, z₀) to at least either of the other two defined valve positions, the load position (x₁, y₀, z₀) or the dispense position (x₂, y₀, z₀), may be achieved with a change in the x-position alone. With suitable design of the size of the sliding valve pusher shaft 3009 end and the actuator 3003 head, the system may be insensitive to significant misalignments in the y, z axis.

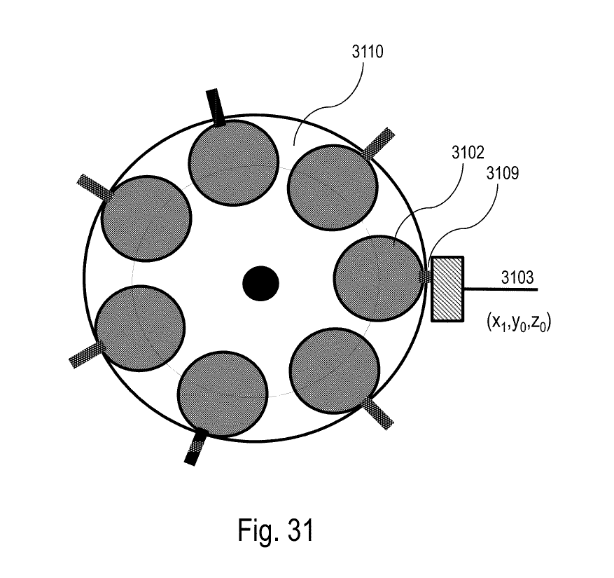

FIG. 31 illustrates one example configuration for a rotary assembly of a sliding valve system with a remote manual actuator for a cooking machine in the load state. The sliding valve and valve housing 3102 assembly is shown mounted on a rotary platen 3110, with the valve pusher shaft 3109 extending perpendicular to the tangent of the rotary platen 3110.

Each sliding valve and valve housing 3102 assembly may be loaded with a food module. The platen may be rotated to align the desired food module and valve assembly with the remote actuator.

Movement of the actuator 3103 from the idle position (x₀, y₀, z₀) to the load position (x₁, y₀, z₀) may be achieved with a change in the x-position alone. With suitable design of the size of the sliding valve pusher shaft 3109 end and the actuator 3103 head, the system may be insensitive to significant misalignments in the y, z axis.

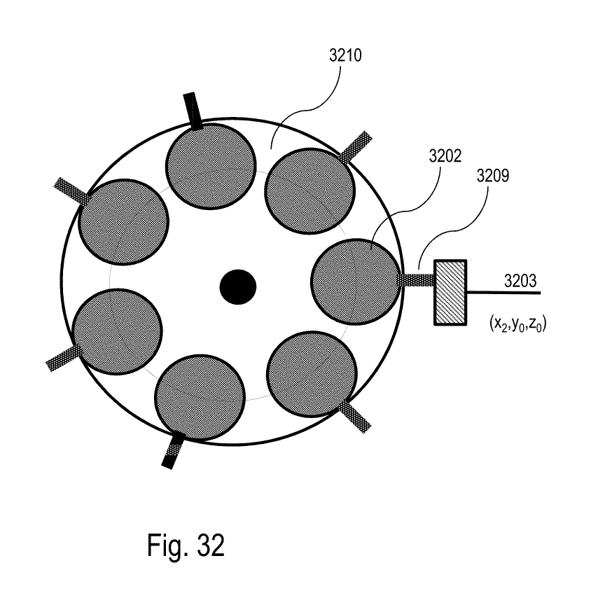

FIG. 32 illustrates one configuration for a rotary assembly of a sliding valve system with a remote manual actuator for a cooking machine in the dispense state. The sliding valve and valve housing 3202 assembly is shown mounted on a rotary platen 3210, with the valve pusher shaft 3209 extending perpendicular to the tangent of the rotary platen 3210.

Each sliding valve and valve housing 3202 assembly may be loaded with a food module. The platen may be rotated to align the desired food module and valve assembly with the remote actuator.

Movement of the actuator 3203 from the load position (x₁, y₀, z₀) to the dispense position (x₂, y₀, z₀) may be achieved with a change in the x-position alone. With suitable design of the size of the sliding valve pusher shaft 3209 end and the actuator 3203 head, the system may be insensitive to significant misalignments in the y, z axis.

The automated cooking machines described in this patent application may include a number of power hungry components: induction heaters, stepper motors, AC motors/universal motors and other components. Lowering the overall power consumption of the automated cooking machine is important. In this scenario, designing the system such that multiple power hungry components are not activated at the same time may be useful. For example, when grinding of food is necessary for a certain recipe, one could turn off the induction heater during the time the AC motor/universal motor for grinding may be activated. This could reduce system maximum power levels. The fast turn-on and fast turn-off abilities of induction heaters makes this possible.

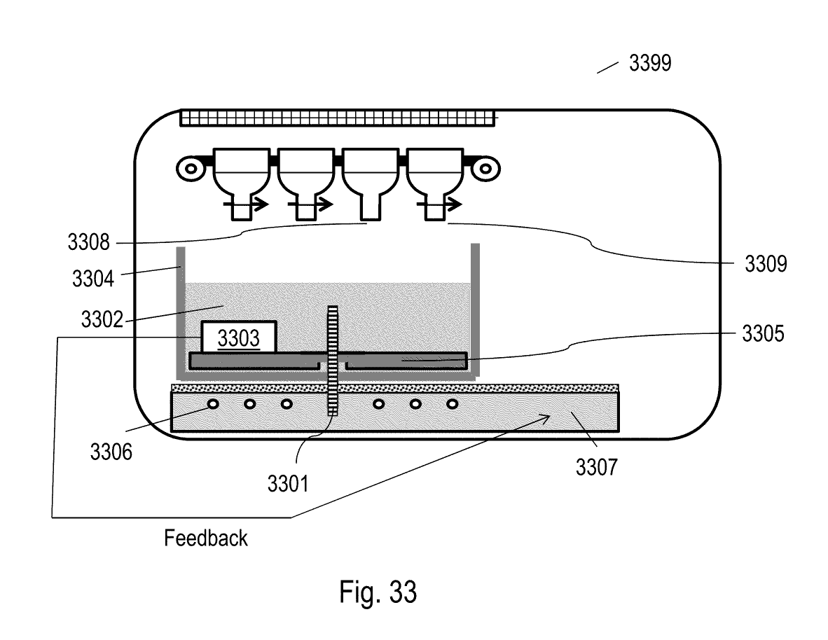

As illustrated in FIG. 33, example automated cooking machine/apparatus 3399 may be constructed with and adapted to use chemical sensors placed in physical contact with the food to measure attributes of the food being cooked, for example, such as measure the flavor of the food being cooked, the extent of cooking (such as carbohydrate to sugar conversion), and then modify the cooking procedure accordingly. An array of sensors 3303 may be present inside the cooking vessel 3304 or on the shaft 3301, or immersed in the food being cooked 3302 (which may be stirred by blade 3305). The sensors 3303 may also be mounted on a moving arm that can be immersed into the food temporarily to take a reading. The moving arm may move in 1, 2 or 3 dimensions, and optionally the sensors 3303 may be mounted on a Cartesian bot system. These sensors 3303 may measure the presence and concentration of chemicals, such as, for example, sodium chloride, glucose, acetic acid, amino acid and other chemicals that contribute to the basic flavor of the food being cooked (e.g., saltiness, sweetness, bitterness, sourness, savoriness (or umami)), as well as other gustatory components such as pungency, astringency and so on. The data measured by the sensors 3303 may optionally be fed back to the control mechanism 3307. This may be used to adjust the temperature of the induction heater 3306 to prevent ingredients from being burnt and thereby turning bitter. This data may also be used to control the ingredient dispensers' first dispenser 3308 and second dispenser 3309 to incrementally add spices or other ingredients to obtain the desired flavor.

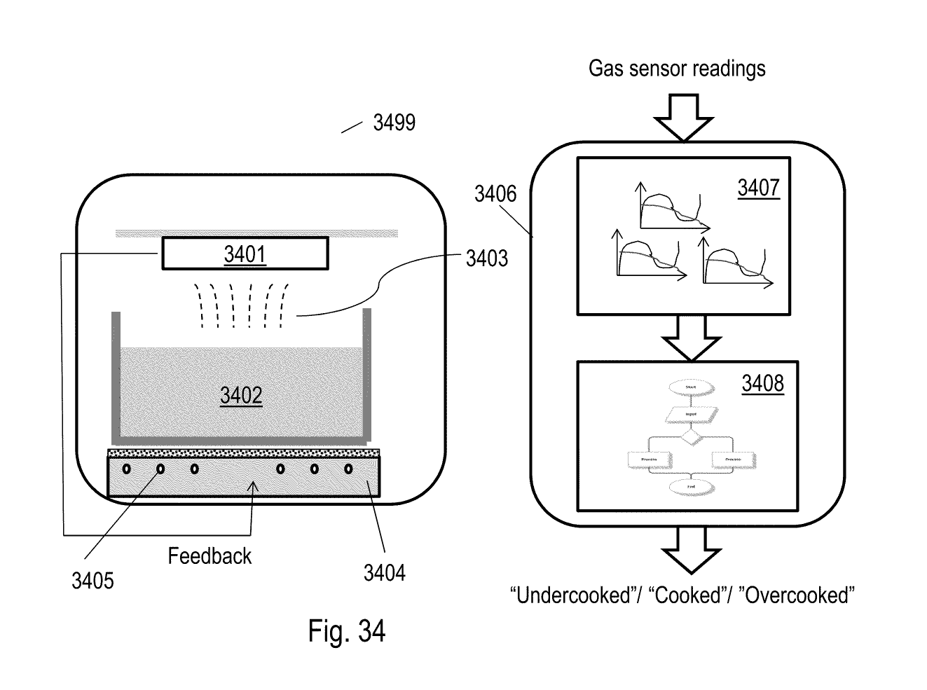

As illustrated in FIG. 34, example automated cooking machine/apparatus 3499 may be constructed with and adapted to use a system of gas sensors which may be used to determine the degree to which the ingredients have been cooked and thereby adjust the time and temperature of cooking until the ingredients have been appropriately cooked or cooked to desired characteristics. Automated cooking machine/apparatus 3499 may be equipped with an array of gas sensors 3401 that may measure the concentration of gases above the cooking vessel such as, but not limited to, carbon monoxide, carbon dioxide, ammonia hydrogen, water vapor, methane, alcohols, hydrocarbons, etc. As the ingredients 3402 change chemically due to the application of heat, they may emit a combination of gases 3403. The gas sensor readings may be fed to the control system 3404 for processing through an expert system 3406. The expert system may consist of (a) a knowledge base of fingerprints 3407 (e.g., elements) of gases emitted when ingredients are cooked, including the varying the concentration of gases over time, and (b) a decision engine 3408 that may use various pattern recognition and classification algorithms to determine the level to which ingredients have been cooked (for example under-cooked, cooked, over-cooked, burnt). The heat applied through the induction heater 3405 may be controlled based on this information till ingredients reach a level of preparation as required by the recipe. Ingredients may be dropped in to fix or cover the result as well.

The expert system described earlier may have the ability to extrapolate the fingerprints of ingredients and adjust its decision making algorithms to account for different quantities of ingredients, for instance when food is being prepared for a different serving size. This allows the avoiding the need to build a knowledge base for every possible ingredient quantity (a time consuming activity) as well as makes the knowledge base smaller.

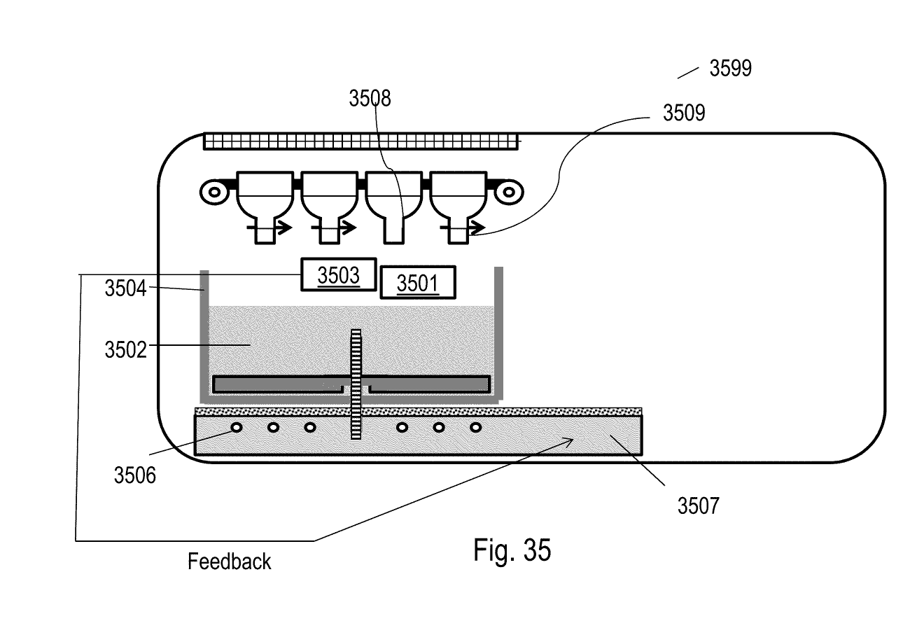

As illustrated in FIG. 35, example automated cooking machine/apparatus 3599 may be constructed with and adapted to use light or image sensors placed above the food to measure how cooked the ingredients are based on the change in color and modify the cooking procedure accordingly. An array of sensors 3503 (e.g., photo-sensors) may be present inside the cooking vessel 3504, but above the food being cooked 3502. A light source 3501 may optionally be present to shine light on the ingredients in the vessel. The photo sensors may read the light and detect the change in color of the ingredients, such as but not limited to the browning of onions or meat, blanching of vegetables, etc. The data measured by the sensors 3503 may be fed back to the control mechanism 3507 which may apply image processing algorithms that identify the change in color of the areas of interest. This may be used to determine whether the ingredients are cooked to the desired level and move to the next step of the recipe. This may also be used to detect whether the ingredients are getting burnt and then adjust the temperature of the induction heater 3506. If required, additional steps may also be taken to add certain spices from the ingredient dispenser's first dispenser 3308 and second dispenser 3309 to, for example, accelerate the browning process, retard the browning process, control blanching, and so on.

It may be desired to adapt the automated cooking machine/apparatus to use heat sensors placed above the food to measure how cooked the ingredients are and optionally modify the cooking procedure. Hence, alternatively or additionally, the sensors 3503 of FIG. 35 may include an array of infrared sensors 3503 which may be disposed, for example, inside the cooking vessel 3504, but above the food being cooked 3502. The data measured by the array of infrared sensors 3503 may be fed back to the control mechanism 3507 which may apply image processing algorithms to generate a heat map of the contents of the cooking vessel. This may be used to determine whether large pieces of the ingredients, such as large and or dense pieces of meat or vegetables, have been heated uniformly, and therefore cooked to the desired level. Based on this, the control system may choose to move to the next step of the recipe or adjust the temperature of the induction heater 3506 or time of the cooking, and so on. The illustration includes the ingredient dispenser's first dispenser 3508 and second dispenser 3509

It may be desired to adapt the automated cooking machine/apparatus to use a spectrometer as sensor 3503 to measure various parameters of the food being cooked 3502. Hence, alternatively or additionally, the sensors 3503 of FIG. 35 may include a spectrometer 3503 (or sensor end of a spectrometer) which may be disposed above the food being cooked 3502. Based on the spectrometer reading, nutritional information on the food may be obtained. This may be used to operate a control system 3507 to control the nutritional value of the food being cooked, or to modify the cooking procedure, or to just display the nutritional content of the food, or to do something else. It will be appreciated by one skilled in the art that several variations of these embodiments may be possible. For example, sensors for detecting food spoilage may be present in the automated cooking machine, as could other types of sensors.

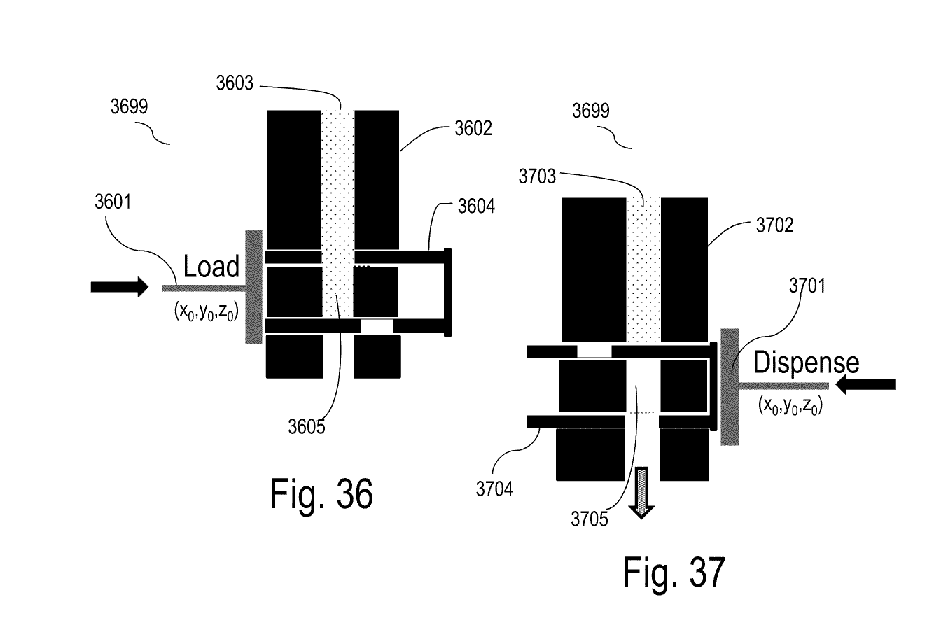

As illustrated in FIG. 36, a dual-slider valve system 3699 with sliders may be constructed and operated, and is drawn in the load position, and describes at least an embodiment of this invention. Dual-slider valve system 3699 may be utilized to dispense many types of ingredients, for example, spices, which will be used as an example illustration herein. The linear actuator 3601 may be used to push the slider 3604 to a position, such that the upper slider opening may align with the spice reservoir 3603 in the valve body 3602, which may allow spices stored in the reservoir 3603 to fall and substantially fill the calibrated space 3605.

As illustrated in FIG. 37, the dual-slider valve system 3699 of FIG. 36 is shown in the dispense position, at a step in the dispensing process which may follow FIG. 36. The linear actuator 3701 may be used to push the slider 3704 to a position, such that the upper slider opening may no longer be aligned with the spice reservoir 3703, and the lower slider opening may align with open via/chute below, which may allow the calibrated amount of spice stored in the calibrated space 3705 to fall into a cooking vessel (not shown). The illustration includes valve body 3702.

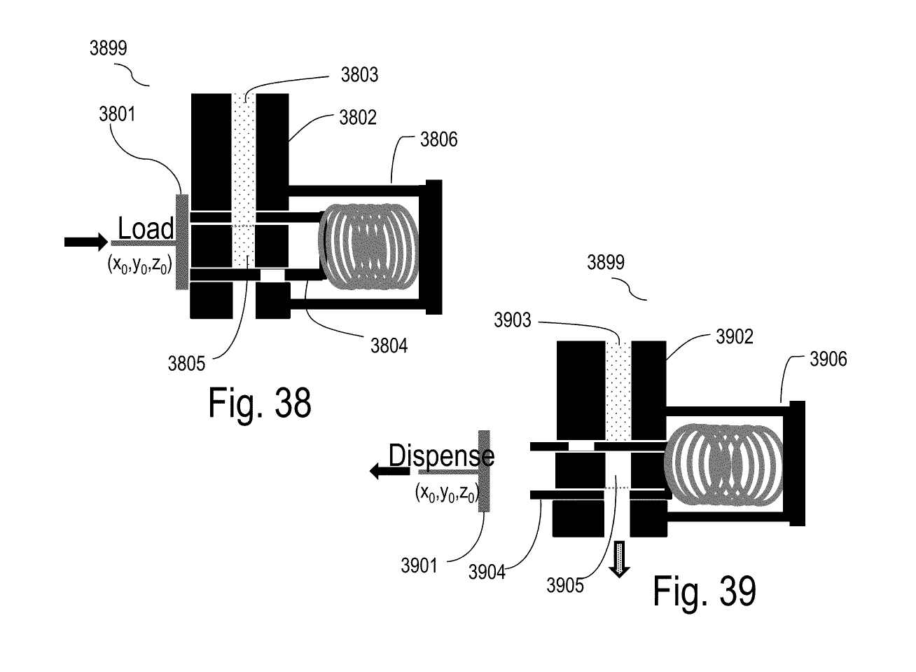

An alternative to the dual-slider spice valve system described in FIG. 36 and FIG. 37 may include a spring mechanism assembly on one side of the dual slider, to reduce the approach of an actuator to one side only. As illustrated in FIG. 38, a spring-loaded, dual slider, spice valve system 3899 with sliders may be constructed and operated, and is drawn in the load position, and describes at least an embodiment of this invention. The linear actuator 3801 may be used to push the slider 3804, compressing the spring in the spring assembly 3806, while moving the slider 3804 to a position, such that the upper slider opening may align with the spice reservoir 3803 in the valve body 3802, which may allow spices stored in the reservoir 3803 to then fall and substantially fill the calibrated space 3805.

As illustrated in FIG. 39, the spring-loaded, dual slider, spice valve system 3899 of FIG. 38 is shown in the dispense position, at a step in the dispensing process that may follow FIG. 38. The linear actuator 3901 may be used to release pressure on the compressed spring in the spring assembly 3906, which may allow the spring to move the slider 3904 to a position, such that the upper slider opening may no longer align with the spice reservoir 3903, and the lower slider opening may align with the open via below, which may allow the calibrated amount of spice stored in the calibrated space 3905, to drop into a cooking vessel (not shown). The illustration includes valve body 3902.

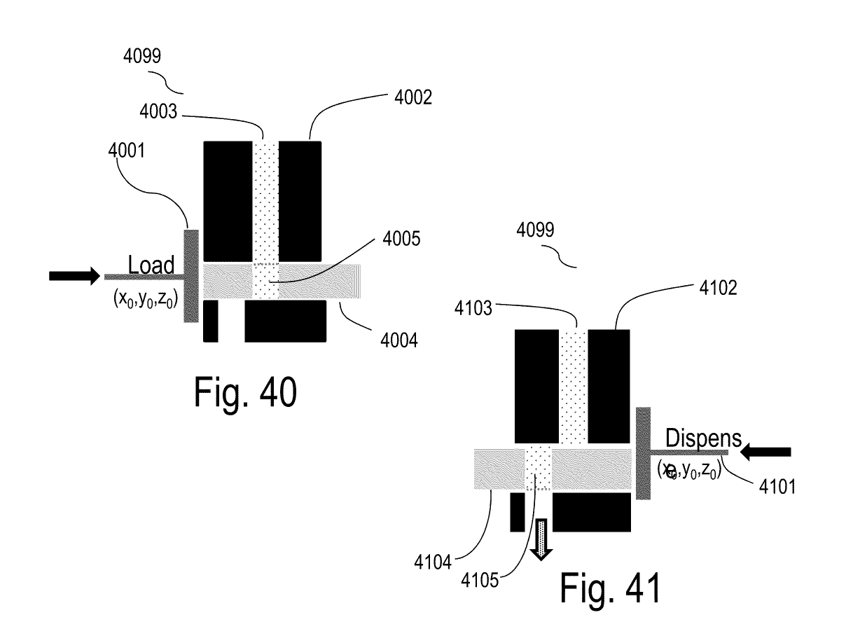

An additional alternative to the dual-slider, spice valve system described in FIG. 36 and FIG. 37, may be to use only one slider thus reducing the number of moving parts. As illustrated in FIG. 40, a single slider, spice valve system 4099 may be constructed and operated, and is drawn with the slider in the load position, and describes at least an embodiment of this invention. The linear actuator 4001 may be used to push the slider 4004 to a position, such that the slider opening may align with the spice reservoir 4003 in the valve body 4002, which may allow spices stored in the reservoir 4003 to fall and substantially fill the calibrated space 4005 within the slider 4004.

As illustrated in FIG. 41, the single slider, spice valve system 4099 is shown with the slider in the dispense position, at a step in the dispensing process that may follow FIG. 40. The linear actuator 4101 may be used to push the slider 4104 to a position, such that the slider opening may align with the open via/chute below, which may allow the calibrated amount of spice stored in the calibrated space 4105, within the slider 4104, to fall into a cooking vessel (not shown). The illustration includes spice reservoir 4103 in the valve body 4102.

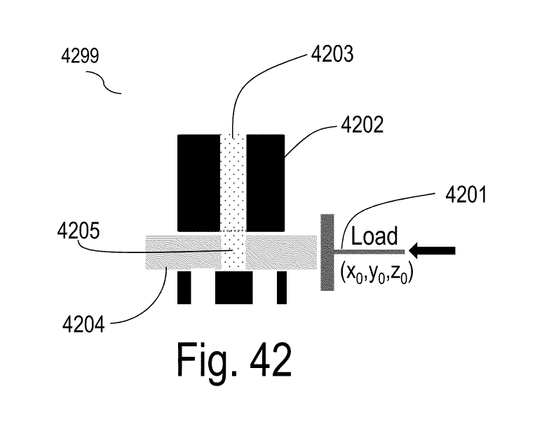

An alternative to the one slider, spice valve system described in FIG. 40 and FIG. 41, may be to add one more via/chute. As illustrated in FIG. 42, a dual via, single slider, spice valve system 4299 may be constructed and operated, and is drawn with the slider in the load position, and describes at least an embodiment of this invention. The linear actuator 4201 may be used to push the slider 4204 to a position, such that the slider opening may align with the spice reservoir 4203 in the valve body 4202, which may allow spices stored in the reservoir 4203 to fall and substantially fill the calibrated space 4205, within the slider 4204.

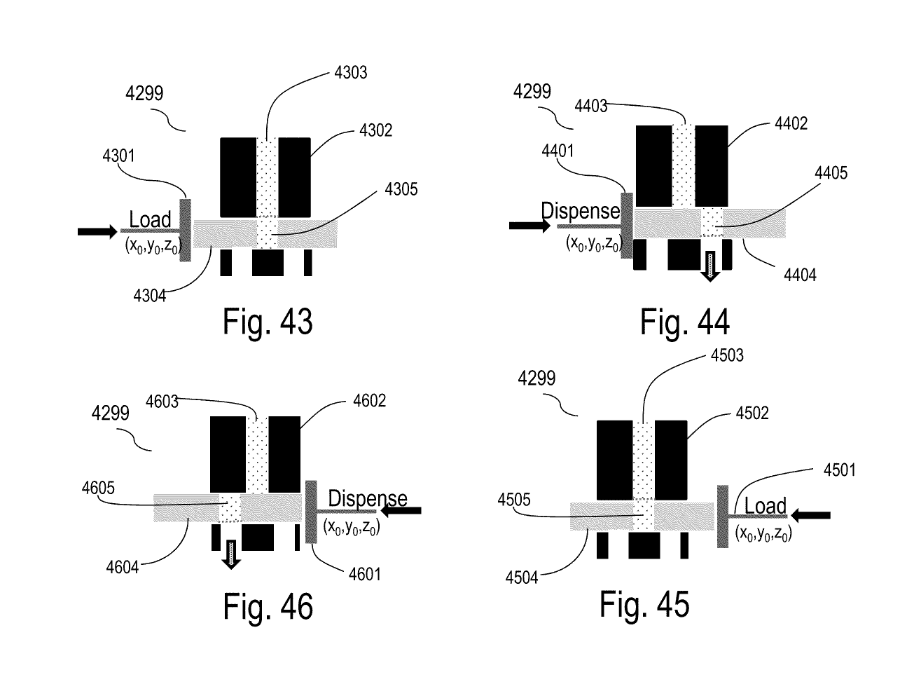

As illustrated in FIG. 43, the dual via, single slider, spice valve system 4299 is shown with the slider in the load position. The linear actuator 4301 may be used to push the slider 4304 to a position, such that the slider opening may align with the spice reservoir 4303 in the valve body 4302, which may allow spices stored in the reservoir 4303 to fall and substantially fill the calibrated space 4305, within the slider 4304.

As illustrated in FIG. 44, the dual via, single slider, spice valve system 4299 is shown with the slider in the dispense position, at a step in the dispensing process that may follow FIG. 43. The linear actuator 4401 may be used to push the slider 4404 to a position, such that the slider opening may align with an open via/chute below, which may allow the calibrated amount of spice stored in the calibrated space 4405, within the slider 4404, to fall into a cooking vessel (not shown). The illustration may include valve body 4402 and reservoir 4403.

As illustrated in FIG. 45, the dual via, single slider, spice valve system 4299 is shown with the slider in the load position, at a step in the dispensing process that may follow FIG. 44. The linear actuator 4501 may be used to push the slider 4504 to a position, such that the slider opening may align with the spice reservoir 4503 in the valve body 4502, which may allow spices stored in the reservoir 4503 to fall and substantially fill the calibrated space 4505, within the slider 4504.

As illustrated in FIG. 46, the dual via, single slider, spice valve system 4299 is shown with the slider in the dispense position, at a step in the dispensing process that may follow FIG. 45. The linear actuator 4601 may be used to push the slider 4604 to a position, such that the slider opening may align with an open via/chute below, which may allow the calibrated amount of spice stored in the calibrated space 4605, within the slider 4604, to fall into a cooking vessel (not shown). The illustration includes valve body 4602 and reservoir 4603.

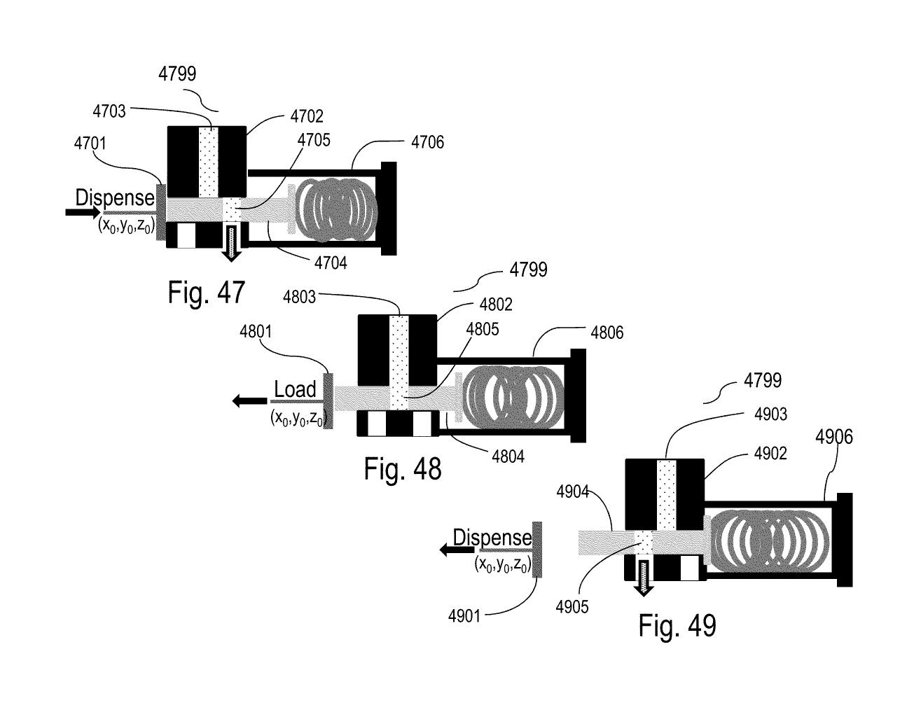

An alternative to the dual via, single slider, spice valve system described in FIG. 42, FIG. 43, FIG. 44, FIG. 45 and FIG. 46, may include a spring mechanism assembly on one side of the single slider, which may reduce the approach of an actuator to one side only. As illustrated in FIG. 47, a dual delivery via, single slider, spring loaded, spice valve system 4799 may be constructed and operated, and is drawn with slider in the dispense position, and describes at least an embodiment of this invention. The linear actuator 4701 may be used to push the slider 4704, compressing the spring in the spring assembly 4706, while moving the slider 4704 to a position, such that the slider opening may align with an open via/chute below, to allow the calibrated amount of spice stored in the calibrated space 4705, within the slider 4704, to fall into a cooking vessel (not shown).

As illustrated in FIG. 48, the dual delivery via, single slider, spring loaded, spice valve system 4799 is shown with slider in the load position, at a step in the dispensing process that may follow FIG. 47. The linear actuator 4801 may be used to release pressure of the slider 4801 on the compressed spring in the spring assembly 4806, which may allow the spring to move the slider 4804 to a position, such that the slider opening may align with the spice reservoir 4803, in the valve body 4802, which may allow spices stored in the reservoir 4803 to substantially fill the calibrated space 4805, within the slider 4804.

As illustrated in FIG. 49, the dual delivery via, single slider, spring loaded spice valve system 4799 is shown with slider in the dispense position, at a step in the dispensing process that may follow FIG. 48. The linear actuator 4901 may be used to release pressure of the slider 4901 on the compressed spring in the spring assembly 4906, which may allow the spring to move the slider 4904 to a position, such that the slider opening may align with an open via/chute below, which may allow the calibrated amount of spice stored in the calibrated space 4905, within the slider 4904, to fall into a cooking vessel (not shown).

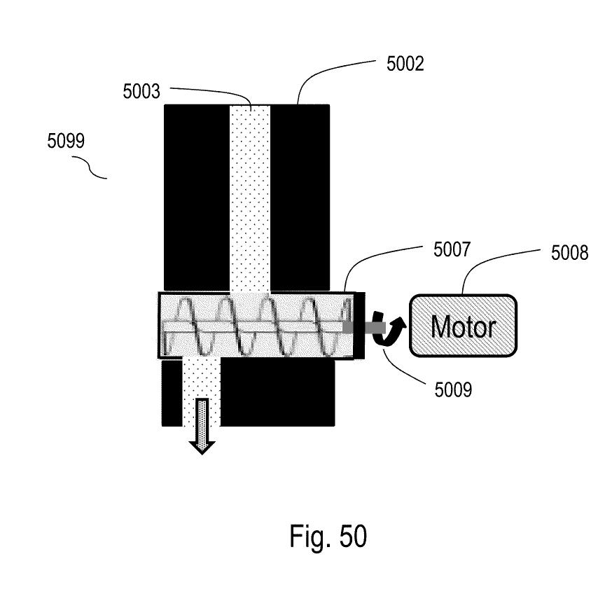

An alternative to the slider spice valve system described in FIG. 36 through FIG. 49 may include replacing the slider valve with a screw-auger, for easier control, more precise dispensing of amounts of spices, and reduced clogging. As illustrated in FIG. 50, a motor driven screw-auger spice dispensing system 5099 may be constructed and operated, and describes at least an embodiment of this invention. The screw-auger motor 5008, may connect to the screw-auger 5007, by means of a shaft coupler 5009. The spice reservoir 5003, in the valve body 5002, may be located directly above the screw-auger. As the screw-auger motor 5008 turns the screw-auger 5007, the screw-auger may move spice from the spice reservoir 5003 to the end of the screw-auger 5003 to an open via/chute below to dispense spice to a cooking vessel (not shown) below. It will be clear to one skilled in the art that several variations of the embodiment shown in FIG. 50 are possible. For example, the screw auger 5007 may be coupled to a rack and pinion mechanism to convert linear motion of an external actuator to motion of the screw auger.

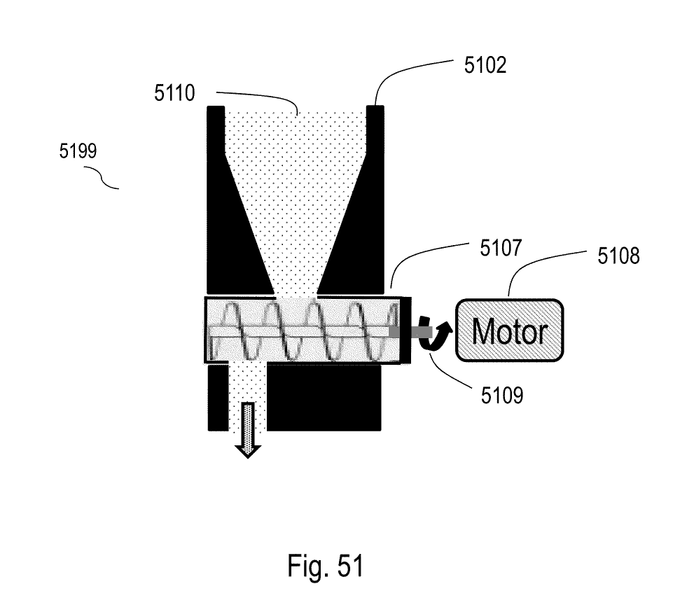

An alternative to the motor driven screw-auger spice dispensing system 5099 shown in FIG. 50 may include a funnel shaped reservoir. The funnel geometry of the spice reservoir may improve flow characteristics of the spice powders, and reduce the height of the vertical space required for the spice dispenser. As illustrated in FIG. 51, a motor driven screw-auger spice dispensing system 5199 with a funnel shaped reservoir may be constructed and operated, and describes at least an embodiment of this invention. The screw-auger motor 5108, may connect to the screw-auger 5107 by means of a shaft coupler 5109. The spice reservoir 5110, in the valve body 5102, may be located directly above the screw-auger. As the screw-auger motor 5108 turns the screw-auger 5107, the screw-auger may move spice from the spice reservoir 5110 to the end of the screw-auger 5107 and to an open via/chute below, to dispense spice to a cooking vessel (not shown) below.

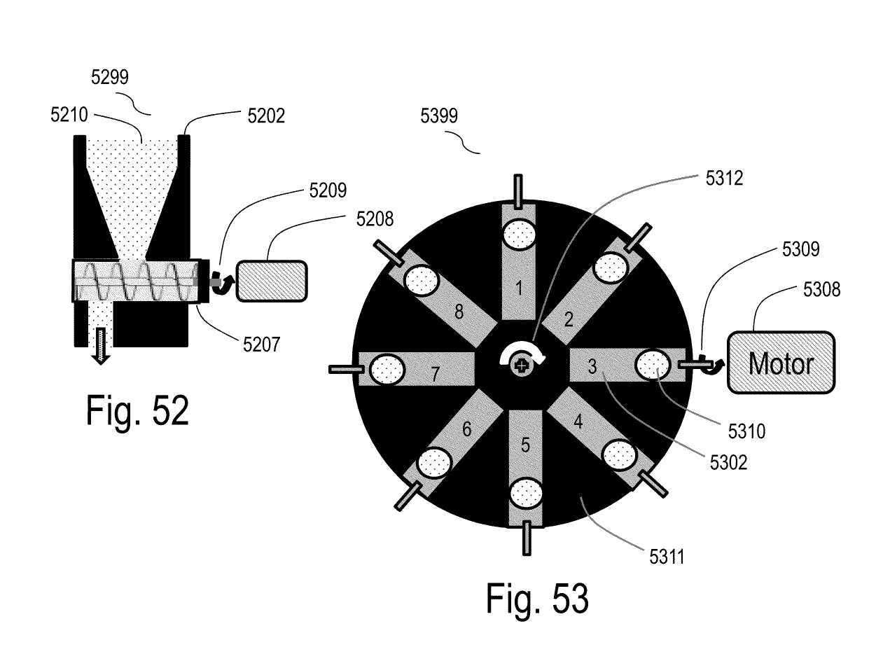

An alternative to the motor driven screw-auger spice dispensing systems shown in FIG. 50 and FIG. 51 may include a rotary assembly of multiple motor driven screw-auger spice valves with funnel shaped reservoirs, on a rotating index plate, which may take up less space and operate more efficiently. As illustrated in FIG. 52, a motor driven screw auger spice valve system 5299 with a funnel shaped reservoir may be constructed and operated, and describes at least an embodiment of this invention. The screw-auger motor 5208, may connect to the screw-auger 5207 by means of a shaft coupler 5209. The spice reservoir 5210, in the valve body 5202, may be directly above the screw-auger 5207. As the screw-auger motor 5208 turns the screw-auger 5207, the screw-auger may move spice from the spice reservoir 5210 to the end of the screw-auger 5207, dropping spice through an open via/chute to a cooking vessel (not shown) below.

As illustrated in FIG. 53, a rotary assembly 5399 of, for example, eight motor driven screw-auger spice valves with funnel shaped reservoirs mounted on a rotating index plate may be constructed and operated, with auger #3 (a single motor driven screw auger spice valve system 5299) aligned to the auger drive motor, and describes at least an embodiment of this invention. Each valve body 5302, with individual spice reservoir 5310 may be attached to the rotating indexing plate 5311, which may be driven by an indexing motor (not shown), through an indexing plate coupler shaft 5312. Shown is screw-auger #3 valve body 5302, which may be aligned to the auger drive motor 5308. The screw-auger motor 5308, may connect to the indexed screw-auger (5207) by means of a screw-auger drive shaft coupler 5309. The spice reservoir 5310, in valve body 5302, may be located directly above the screw-auger 5307. As the screw-auger motor 5208 turns the screw-auger 5207, the screw-auger may move spice from the spice reservoir 5210 to the end of the screw-auger 5307, and the spice may drop through an open via/chute, to a cooking vessel (not shown) below.

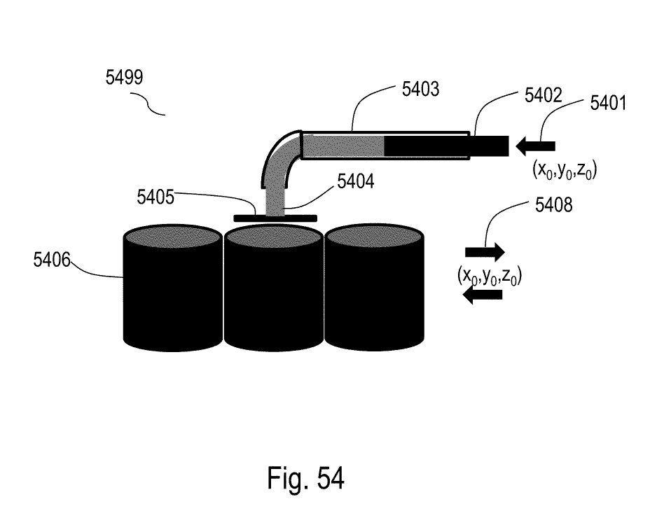

Vertical space in an automated appliance may be tight. As illustrated in FIG. 54, an ingredient delivery system with a horizontal actuator assembly 5499 to transfer horizontal force downward to a vertical pusher which may push food into a food processor and automated cooker, may be constructed and operated, and describes at least an embodiment of this invention. Ingredient delivery system with a horizontal actuator assembly 5499 may save vertical space. An array of food modules 5406 may be located to a preselected position using an automated Cartesian bot 5408. The pusher assembly mechanism may be composed of a solid flexible polymer rod 5404 (for example), which may be Teflon, with an attached solid metal rod 5402 at one end, which may provide rigidity and a good connection to a Cartesian bot 5401, and a pusher plate 5405 at the other end of the flexible polymer rod 5403, all inside a metal tube with a 90 degree bend at one end 5403. Proper alignment of the food module 5406 with the pusher assembly may allow the Cartesian bot 5408 to supply suitable horizontal force to provide suitable vertical downward force, to push food through the food module 5406 into a food processor and automated cooker. It will be clear to one skilled in the art that several variations of the proposed embodiment may be possible. One may use air pressure to push food, and other mechanisms may also be possible.

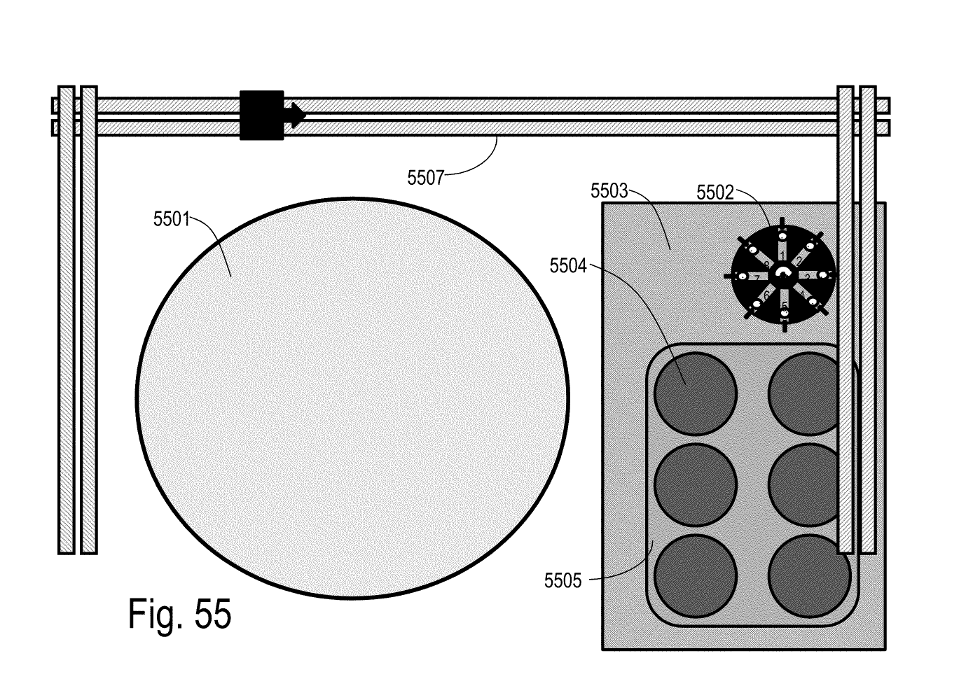

FIG. 55 shows a top-down view of a configuration to park cassettes of spices and food ingredients out of the way of the food processing and cooking areas of an automated cooking appliance. Food items and spices may need to be isolated for short term storage in a food-safe area, which may provide protection from airborne contamination, mechanical processes, and potential problems of heat and cooking vapors. FIG. 55 shows a cooking vessel 5501, which may be disposed and isolated to one side of the available space within an automated cooking appliance, but within the frame and/or locating extent of the Cartesian bot 5507. An array of food modules 5504 may be loaded on a cassette 5505 that may be mounted to a food tray 5503. Also mounted on this food tray may be a spice cassette 5502. This food tray 5503 may be in the form of a drawer that may slide out from the front of the automated cooking appliance for convenient access for loading and unloading. Food tray 5503 may also be adapted to be a temperature and/or humidity controlled unit, such as a refrigerator and/or dehumidifier, and may have temperature, humidity, motion, and gas sensors for monitoring the food and tray status.

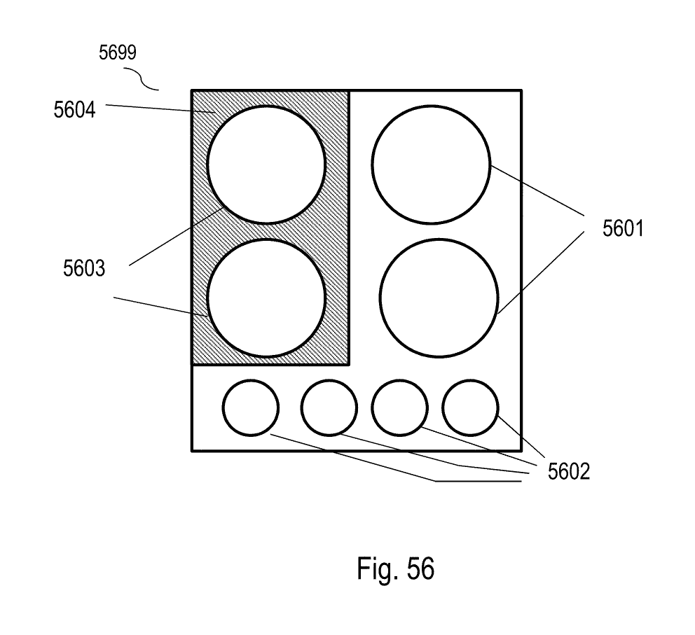

Some users of an automated cooking machine may want to load their ingredients into the machine in the morning when they leave for work, and would like to come home and see hot food waiting for them. The challenge with this paradigm is that meat items such as chicken and other items may often become spoiled if left at room temperature for too long. As illustrated in FIG. 56, an example ingredient dispenser 5699 may be constructed and operated (top view shown), and describes at least an embodiment of this invention. First ingredient container 5601 and second ingredient container 5602 are where food items may not need to be kept cool until use, while cooled ingredient containers 5603 are where food items may need to be kept cool until use. The regions 5604 around cooled ingredient containers 5603 may have space and fittings available for housing ice packs and thereby preserve perishable food items until these are used. It will be clear to one skilled in the art that other passive or active cooling schemes may be used. These could include refrigeration systems, Peltier cooling systems, etc.

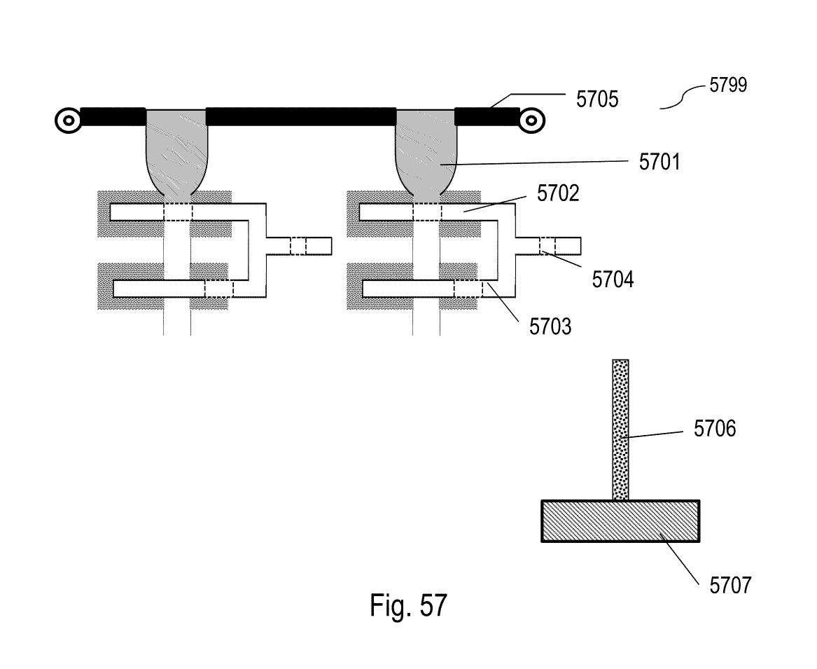

As illustrated in FIG. 57, an alternative system for the ingredient dispenser 5799 function may be constructed an operated, and describes at least an embodiment of this invention. Ingredient dispenser 5799 may include food 5701 that needs to be dispensed, first slide gate valve 5702 and second slide gate valve 5703, and opening 5704 which may be moved (for example, along rail 5705) to in turn move the slider valves back and forth. Moving the slider valves first slide gate valve 5702 and second slide gate valve 5703 back and forth may allow the ingredient to be dispensed. The actuator 5706 may be used to move the opening 5704. The actuator 5706 may be fitted onto a system 5707 that can be moved in one direction (in X, Y or Z), in two directions (in XY, YZ and ZX) or three directions (XYZ) using a robot arm fitted with one or more motors. In some embodiments, the system 5707 may not be movable. To one skilled in the art, it will be apparent how the system in FIG. 57 operates, based on this description and the description provided for in FIGS. 20-24 herein.

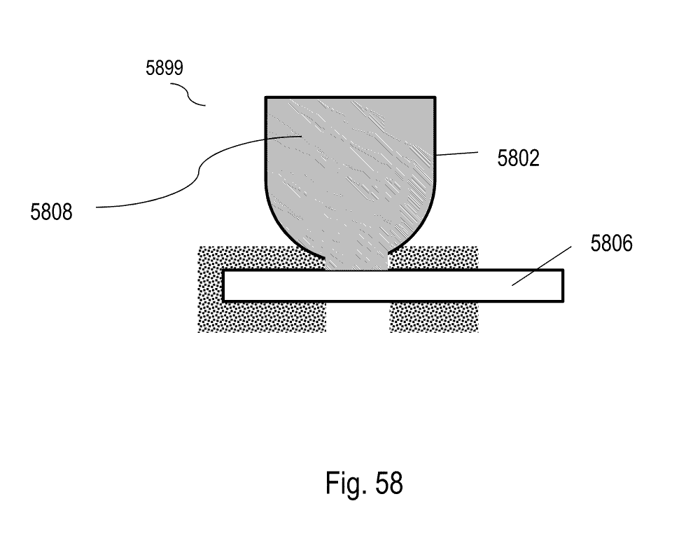

As illustrated in FIG. 58, an ingredient container may be placed/coupled with/in an ingredient dispenser, thus forming an ingredient dispenser 5899 which may be constructed and operated, and describes at least an embodiment of this invention. A single slider valve 5806 may be present which may dispense food item 5808 from ingredient container 5802. This may be used for multiple applications. Such as, for example, dispensing perishable quantities that may not be reused. It will be clear to one skilled in the art that several alternative embodiments may be possible. This may include a trapdoor at the bottom of the container which helps dispense the food item instead of having a slider as shown in FIG. 58. Liquid ingredients, may, for example, be dispensed using a system with solenoid valves. Various other embodiments may be possible.

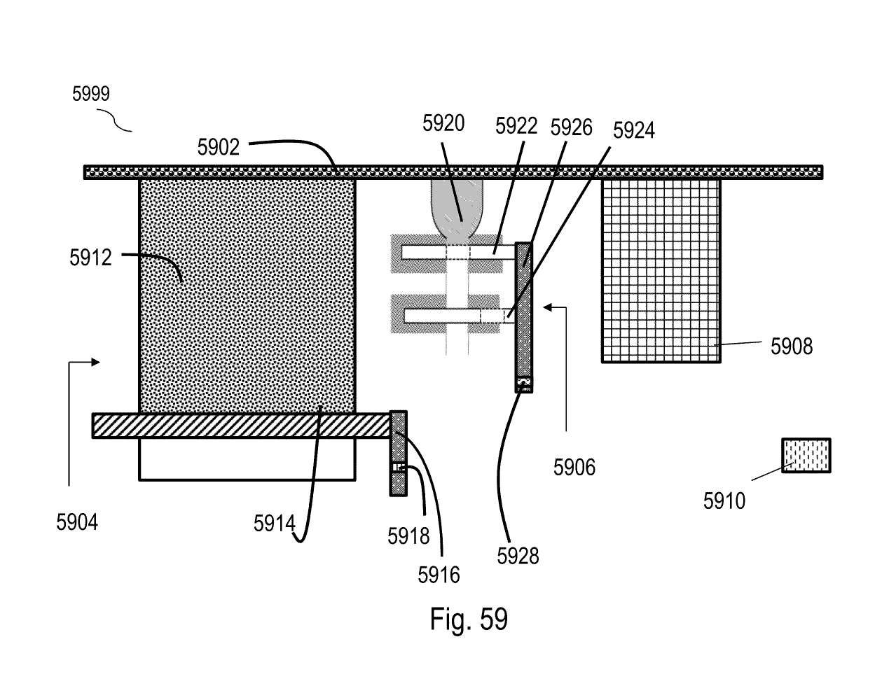

As illustrated in FIG. 59, an example ingredient dispenser system 5999 may be constructed and operated, and describes at least an embodiment of this invention. Ingredient dispenser system 5999 may include solid dispenser 5904, powder dispenser 5906, and liquid dispenser 5908 (a “black-box view”). Although just these three dispensers solid dispenser 5904, powder dispenser 5906, and liquid dispenser 5908 are shown in FIG. 59, it will be clear to one skilled in the art that various other dispensers may also be present. Dispensers solid dispenser 5904, powder dispenser 5906, and liquid dispenser 5908 may be mounted on a Cartesian robot arm 5902 (i.e., may share the same robot arm) which may be moved to various points in the (x, y, z) plane using motors (not shown). Solid ingredients 5912 may be dispensed on to a cooking vessel (not shown) by moving a slide gate valve 5914. Slide gate valve 5914 may be attached to piece 5916 which may be actuated, for example, using a robot arm 5910. Robot arm 5910 may push region 5918 back and forth to move the slide gate valve 5914, which in turn could result in dispensing solid ingredients 5912 into the cooking vessel (not shown). Robot arm 5910 may optionally be a non-moving arm. The powder dispenser 5906 may operate using principles shown in FIGS. 4-7 herein, for example. The powder dispensed 5920 may be a spice, sugar, salt or some other powder used in food applications. The sliders first slider 5922 and second slider 5924 may be connected to the arm 5926 which may be actuated using robot arm 5910. By pushing robot arm 5910 against the arm region 5928, the sliders solid ingredients may be used for dispensing the powder 5920. The heights of the solid dispenser 5904 and powder dispenser 5906 may be strategically chosen to make best use of the available space in the machine. For example, by making the solid dispenser 5904 taller than the powder dispenser 5906, one may be able to pack the dispensers more tightly into the automated cooking machine. The liquid dispenser 5908 may include solenoid valves or may be built using other techniques. Ingredient dispenser system 5999 may be integrated into at least the automated cooking machine/apparatus described herein.

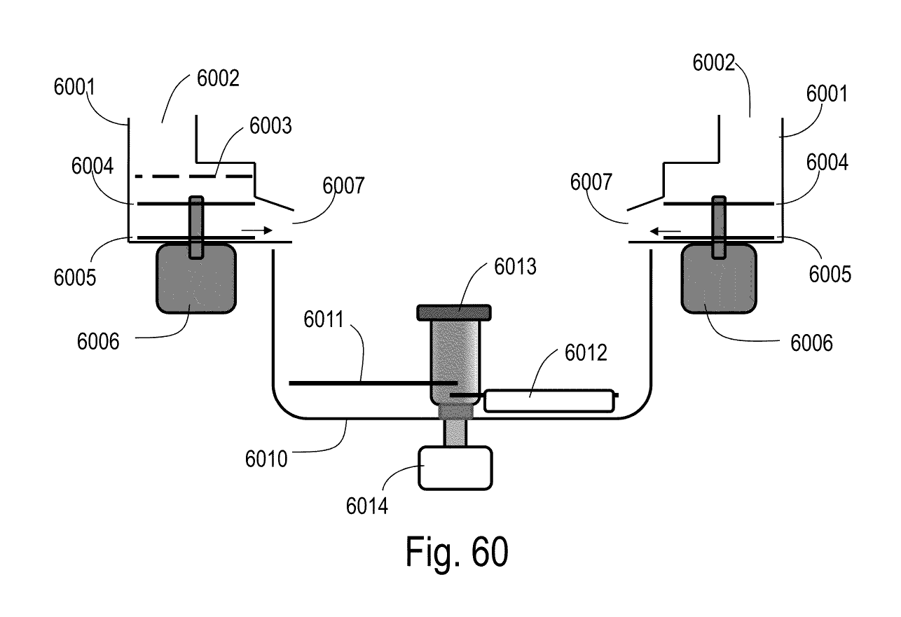

As illustrated (side view) in FIG. 60, a portion of an automated cooking system/apparatus (for example, such as described in at least FIGS. 1, 3, 8, 9, 14, 33, 34 and 35 herein, which includes perimeter food slicing modules 6001 and a chopping and stirring module 6013 in the bottom of the cooking pot/vessel 6010 may be constructed and operated, and describes at least an embodiment of this invention. Food slicing modules 6001 may also include dicing and cutting apparatuses and functions. These perimeter food slicing modules 6001 may be strategically located about the perimeter of the automated cook pot/vessel 6010 to facilitate the delivery of food to the loading hopper 6002, by an ingredient dispenser (not shown) mounted on a Cartesian bot system (not shown). Outfitted with a suitable spinning blade 6004, food delivered to the loading hopper 6002 may be sliced, and then ejected by a rotating food ejector plate 6005, through the ejection port 6007 optimized to deliver food to the cooking pot/vessel 6010. Spinning blade 6004 and food ejector plate 6005 may be attached/coupled to motor 6006.

The food slicing modules 6001 may also include a pre-slicing gridded knife 6003. Each individual food slicing module 6001 may have a different size of pre-slicing gridded knife 6003. The pre-slicing gridded knives 6003 may be have openings as small as ⅛″×⅛″ and larger. Food pressed through a food slicing and cutting module 6001, with a gridded knife and no spinning blade 6004, may result in strips of food with a cross-section defined by the geometry of the gridded knife. Food pressed through a food slicing and cutting module 6001 with a gridded knife and a spinning blade 6004 may result in cubes of food with a cross-section defined by the geometry of the gridded knife and a length defined by the distance between the two blades.

Each individual food slicing module 6001 may be driven by separate motors 6006, or they may be driven by a single motor and a system of gears, belts and cables.

The multi-purposed stirring and cutting module 6013 at the bottom of the cook pot/vessel 6010 may include a chopping blade 6011 and a stirring module 6012, and may be driven by a separate motor system 6014. The variable motor 6014 may be switched to operate in either a clockwise or counter-clockwise direction. The chopping blade 6011 may be designed using a suitable food chopping blade design, such that the cutting and chopping process may be optimized in one preferred direction and at an optimized speed used for cutting food. The stirring module 6012 may be designed using a suitable polymer such as silicone or other soft durable food-safe polymer, in a shape that may be optimized to mix and scrape food, mounted and integrated into to a cutting blade, such that the stirring process may be optimized in the reverse direction and at a lower speed than what might be used for cutting food.

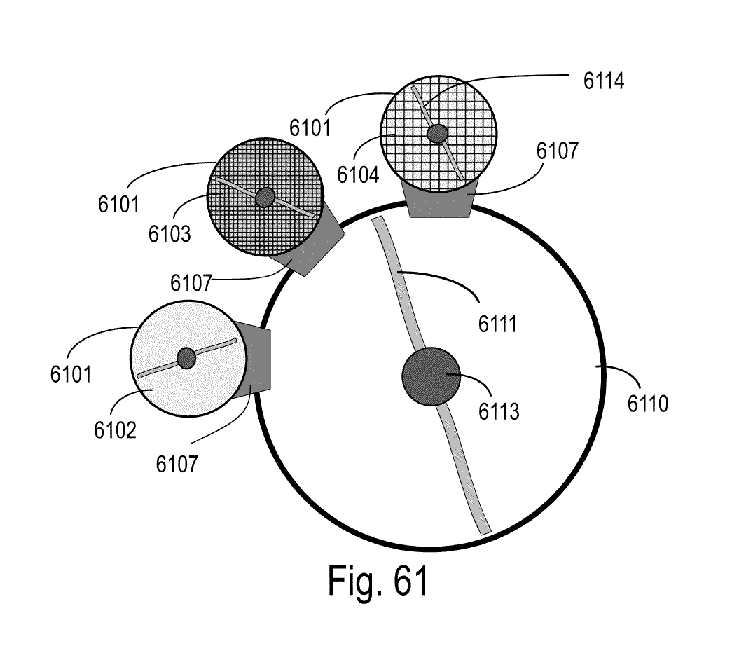

As illustrated (top-down view) in FIG. 61, a configuration for an automated cookpot/vessel 6110 having perimeter slicing and cutting modules 6101, and a chopping and stirring module 6113 in the bottom of the pot/vessel may be constructed and operated, and describes at least an embodiment of this invention. The perimeter slicing and cutting modules may also be referred to as continuous flow food processors in this patent application. The perimeter food slicing modules 6101 may be strategically located about the perimeter of the automated cook pot 6110 to facilitate the delivery of food to the loading hopper 6102, by an ingredient dispenser (not shown) mounted on a Cartesian bot system (not shown). Food delivered to the loading hopper 6102 of a perimeter food slicing module 6101 configured with a suitable spinning blade 6114, may be sliced, and then ejected by a rotating food ejector plate, through the ejection port 6107, optimized to deliver food to the cooking pot/vessel 6110. The perimeter food slicing modules 6101 may also include a pre-slicing gridded knives such as first gridded knife 6103 and second gridded knife 6104. Each individual food slicing modules 6101 may have a different size of pre-slicing gridded knives first gridded knife 6103 and second gridded knife 6104 to provide unique food shapes and sizes. The pre-slicing gridded knives first gridded knife 6103 and second gridded knife 6104 may have openings as small as ⅛″×⅛″ and larger. Food pressed through a food slicing and cutting module 6101, with a gridded knife and no spinning blade 6114, may result in strips of food with a cross-section defined by the geometry of the gridded knives first gridded knife 6103 and second gridded knife 6104. Food pressed through a food slicing and cutting module 6101, with gridded knives first gridded knife 6103 and second gridded knife 6104, and a spinning blade 6114, may result in cubes of food with a cross-section defined by the geometry of the gridded knife and a length defined by the distance between the two blades. Each individual food slicing module 6101 may be driven by separate motors, or they may be driven by a single motor and a system of belts and cables.

The multi-purposed stirring and cutting module 6113 at the bottom of the cook pot/vessel 6110, includes a chopping blade 6111 that may include a stirring module, mounted and integrated into one arm of the cutting blade 6111. The stirring and cutting module 6113 may be driven by a variable motor system that may operate in either the clockwise or counter-clockwise direction. The chopping blade 6111 may be designed using a suitable food chopping blade design, such that the cutting and chopping process may be optimized in one preferred direction and at an optimized speed used for cutting food. The attached stirring module may be designed using a suitable polymer, such as silicone or other soft durable food-safe polymer, in a shape that may be optimized to mix and scrape food, mounted and integrated into to a cutting blade, such that the stirring process may be optimized in the reverse direction and at a lower speed than what might be used for cutting food.

It will be clear to one skilled in the art that several variations of the embodiments in FIG. 61 are possible. For example, one may use just a stirrer (device, functions and motions) for the bottom of the cookpot 6110 and not include any cutting functions or dual purpose blades. Moreover, the food processor shown in FIG. 11 may be used in the perimeter of the automated cookpot 6110.

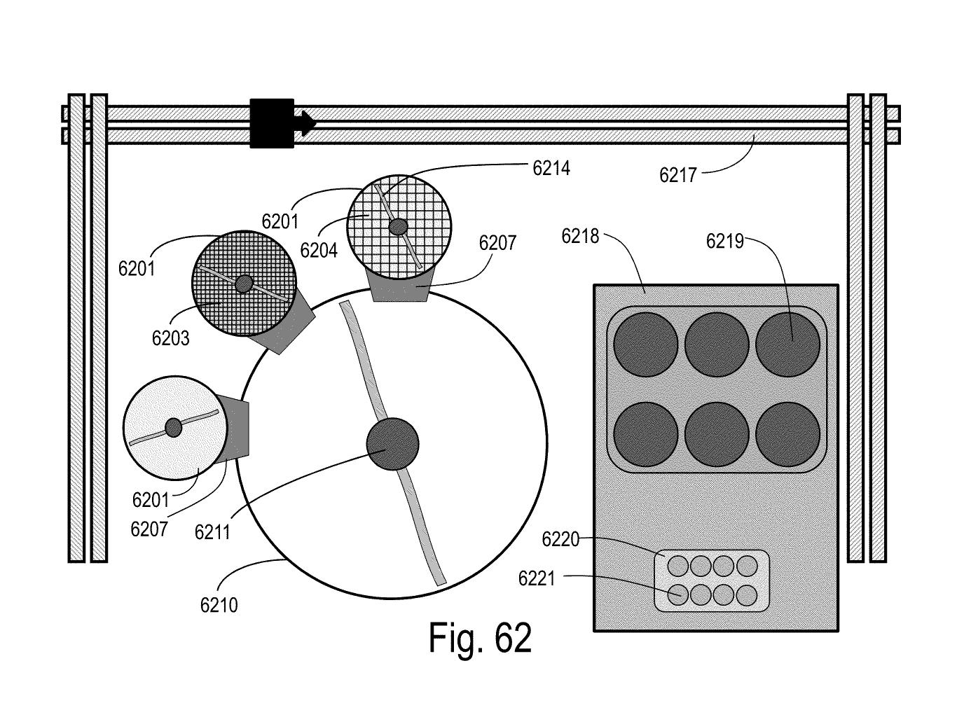

FIG. 62 shows a top-down view of an example configuration for an automated cookpot/vessel 6210 with perimeter slicing and cutting modules 6201, a chopping and stirring module 6211 in the bottom of the cooking pot/vessel 6210, a food drawer 6218 with food modules 6219, a spice cassette 6220 with individual spice modules 6221, and a Cartesian food delivery system 6217. These perimeter food slicing modules 6201 may be strategically located about the perimeter of the automated cook pot 6210 to facilitate the delivery of food and spices to the loading hopper 6201 by an automated Cartesian food delivery system 6217 which may be controlled by a recipe based program. Configured with a suitable spinning blade 6214, food delivered to the loading hopper 6201, may be sliced, and then ejected by a rotating food ejector plate, through the ejection port 6207 optimized to deliver food to the cooking pot/vessel 6210. The perimeter food slicing modules 6201 may also include pre-slicing gridded knives first gridded knife 6203 and second gridded knife 6204. Each individual food slicing module 6201 may have a different size of pre-slicing gridded knives first gridded knife 6203 and second gridded knife 6204 to provide unique food shapes and sizes. The pre-slicing gridded knives first gridded knife 6203 and second gridded knife 6204 may have openings as small as ⅛″×⅛″ and larger. Food pressed through a food slicing and cutting module 6201, with a gridded knives first gridded knife 6203 and second gridded knife 6204 and no spinning blade 6214, may result in strips of food with a cross-section defined by the geometry of the gridded knives first gridded knife 6203 and second gridded knife 6204. Food pressed through a food slicing and cutting module 6201, with a gridded knives first gridded knife 6203 and second gridded knife 6204, followed by a spinning blade 6214, may result in cubes of food with a cross-section defined by the geometry of the gridded knives first gridded knife 6203 and second gridded knife 6204 and a length defined by the distance between the two blades. Recipes defined within the automated cooking control system may specify the cutting required to provide unique food shapes and sizes for each food stored in the food tray 6218. The Cartesian food delivery system 6217 may allow the automated cooking system to direct the correct food module 6219, stored on the food tray 6218, to the correct perimeter slicing and cutting modules 6201 for the recipe defined food shape and size, or directly to the cooking pot/vessel 6217 with no pre-cutting. The Cartesian food delivery system 6217, which can also be referred to by the term Cartesian bot, may push the food item to be chopped down the continuous flow food processor's inlet. Each individual food slicing module 6201 may be driven by separate motors, or they may be driven by a single motor and a system of gears, belts and cables (e.g., a motor shared).

The multi-purposed stirring and cutting module 6211 at the bottom of the cook pot 6210, may include a one purpose chopping blade, a one purpose stirring blade or it may also include a multi-purposed stirring and cutting blade with a stirring module, mounted and integrated into one arm of the cutting blade in the bottom of the cooking pot 6210. The stirring and cutting module 6211 may be driven by a variable motor system that may operate in either clockwise or counter-clockwise directions. The chopping blade may be designed using a suitable food chopping blade, such that the cutting and chopping process may be optimized in one preferred direction at an optimized speed used for cutting food. The attached stirring module may be designed using a suitable polymer such as silicone or other soft durable food-safe polymer, in a shape that may be optimized to mix and scrape food, mounted and integrated into to a cutting blade, such that the stirring process may be optimized in the reverse direction at a lower speed than might be used for cutting food.

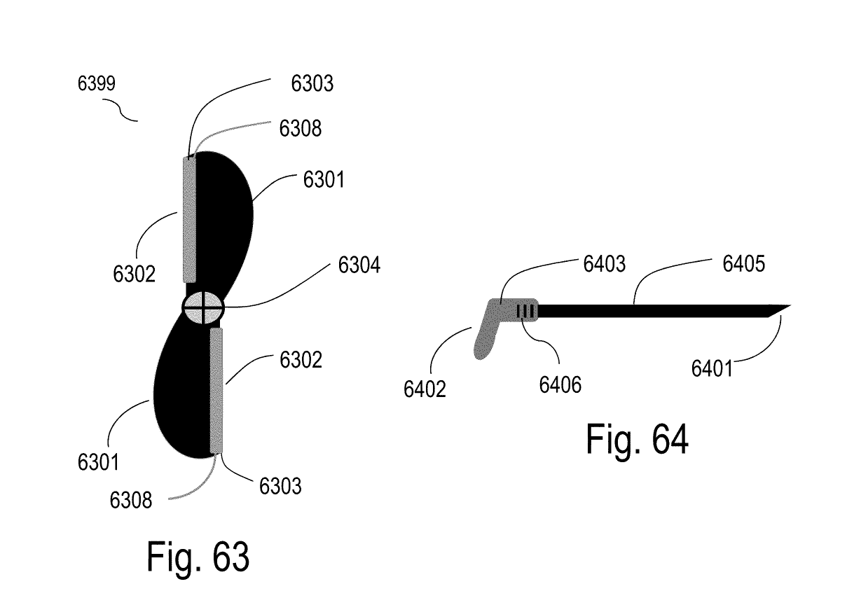

As illustrated (top-down view) in FIG. 63, a dual-purpose cutting/stirring blade 6399 may be constructed and operated, and describes at least an embodiment of this invention. Clock-wise rotational power may be applied to dual-purpose cutting/stirring blade 6399 by a motor drive shaft 6304. Clock-wise rotation of the dual-purpose cutting/stirring blade 6399 in FIG. 63 may provide sufficient cutting capability for the sharpened leading edge 6301 to chop or slice food. Counter-clock-wise rotational power may be applied to a dual-purpose cutting/stirring blade by a motor drive shaft 6304. Counter-clock-wise rotation of the dual-purpose cutting/stirring blade in FIG. 63 may provide sufficient pushing capability for the leading edge 6302 to mix and/or stir food. One configuration of this leading edge 6302 to mix and/or stir food may include an augmentation of the leading edge 6302 to mix and/or stir food, in the form of a molded polymer scraper 6303, which may be made of silicone, or other soft durable food-safe polymer, in a shape that may be optimized to mix and scrape food in a cooking pot. The line of perforations 6308 along the stirring edge 6302 of the dual-purpose cutting/stirring blade may provide a method to securely attach a directly molded polymer scraper 6303 to the stirring edge 6302 of the dual-purpose cutting/stirring blade.

FIG. 64 shows a cross-sectional view of the dual-purpose cutting/stirring blade 6399 shown in FIG. 63, oriented to show top surface 6405 of the dual-purpose cutting/stirring blade 6399, sharpened cutting edge 6401 of the augmented stirring edge dual-purpose cutting/stirring blade 6399, and dual-purpose cutting/stirring blade 6402. One configuration of this stirring edge, 6402 to mix and/or stir food, may include an augmentation of edge 6402 to mix and/or stir food, in the form of a molded polymer scraper 6403, which may be made of silicone, or other soft durable food-safe polymer, in a shape that may be optimized to mix and scrape food in a cooking pot. The perforations 6406 of the stirring edge 6402 of the dual-purpose cutting/stirring blade may provide a method to securely attach a directly molded polymer scraper 6303 to the stirring edge 6302 of the dual-purpose cutting/stirring blade 6399.

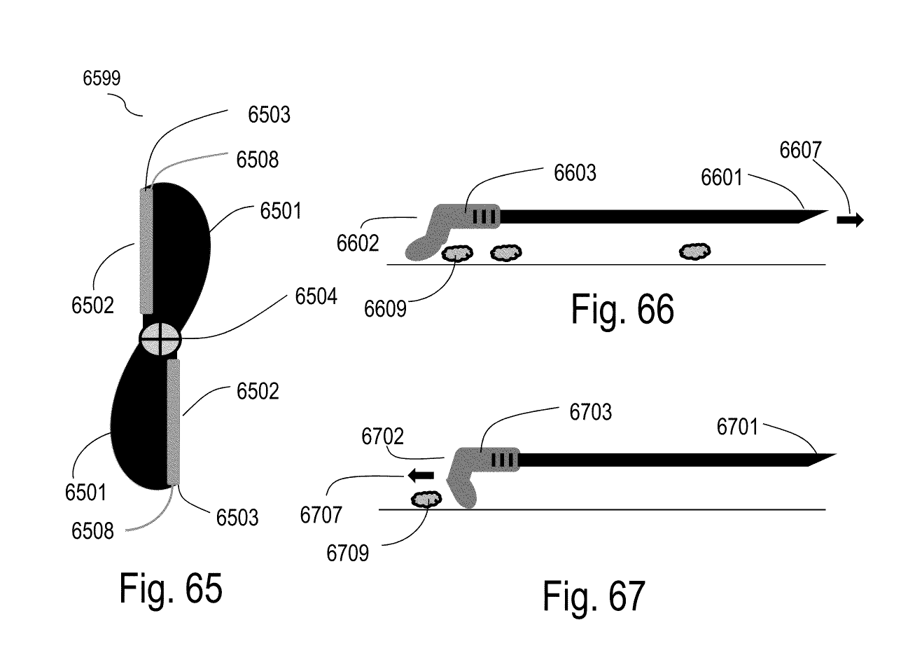

FIG. 65 shows a top-down view of a configuration of a dual-purpose cutting/stirring blade 6599. Clock-wise rotational power may be applied to a dual-purpose cutting/stirring blade 6599 by a motor drive shaft 6504. Clock-wise rotation of the dual-purpose cutting/stirring blade 6599 in FIG. 65 may provide sufficient cutting capability for the sharpened leading edge 6501 to chop or slice food. Counter-clock-wise rotational power may be applied to a dual-purpose cutting/stirring blade by a motor drive shaft 6504. Counter-clock-wise rotation of the dual-purpose cutting/stirring blade in FIG. 65 may provide sufficient pushing capability for the leading edge 6502 to mix and/or stir food. One configuration of this stirring edge 6502 to mix and/or stir food may include an augmentation of the stirring edge 6502 to mix and/or stir food, in the form of a molded polymer scraper 6503, which may be made of silicone, or other soft durable food-safe polymer, in a shape that may be optimized to mix and scrape food in a cooking pot/vessel (not shown). The line of perforations 6508 along the stirring edge 6502 of the dual-purpose cutting/stirring blade 6599 may provide a method to securely attach a directly molded polymer scraper 6503 to the stirring edge 6502 of the dual-purpose cutting/stirring blade.

FIG. 66 shows a cross-sectional view of the dual-purpose cutting/stirring blade shown in FIG. 65, simulating rotation of the dual-purpose cutting/stirring blade 6599 with movement in direction 6607, such that the leading sharpened edge 6601 results in cutting. The shape of the augmented polymer scraper 6603 molded to the trailing stirring edge 6602 of the dual-purpose cutting/stirring blade 6599, may be optimized to allow cut food 6609 to pass under the stirring scraper 6603.

FIG. 67 shows a cross-sectional view of the dual-purpose cutting/stirring blade 6599 shown in FIG. 65, simulating rotation of the of the dual-purpose cutting/stirring blade 6599 with movement in direction 6707, such that the leading augmented edge 6702 results in stirring and mixing of food 6708. The shape of the augmented polymer scraper 6703 molded to the stirring edge 6702 of the dual-purpose cutting/stirring blade 6599, may be optimized to scrape and stir food 6709 in a cooking pot/vessel (not shown). The blade may include leading sharpened edge 6701.

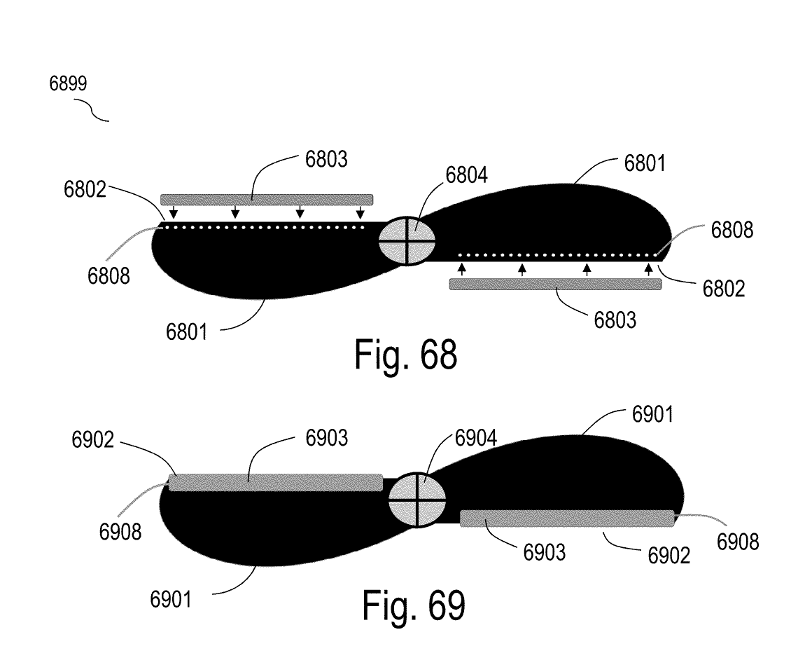

FIG. 68 shows a top down view of a pre-assembly configuration of a dual-purpose cutting/stirring blade 6899. Counter-clock-wise rotational power may be applied to a dual-purpose cutting/stirring blade 6899 by a motor drive shaft 6804. Counter-clock-wise rotation of the dual-purpose cutting/stirring blade 6899 in FIG. 68 may provide sufficient cutting capability for the sharpened leading edge 6801 to chop or slice food. Clock-wise rotational power may be applied to a dual-purpose cutting/stirring blade 6899 by a motor drive shaft 6804. Clock-wise rotation of the dual-purpose cutting/stirring blade 6899 may provide sufficient pushing capability for the leading edge 602 to mix and/or stir food. One configuration of this stirring edge 6802 to mix and/or stir food may include an augmentation of the stirring edge 6802 to mix and/or stir food, in the form of a molded polymer scraper 6803, which may be made of silicone, or other soft durable food-safe polymer, in a shape that may be optimized to mix and scrape food in a cooking pot/vessel (not shown). The molded scraper 6803 is shown in FIG. 68 prior to direct molding to the dual-purpose cutting/stirring blade. The line of perforations 6808 along the stirring edge 6802 of the dual-purpose cutting/stirring blade may provide a method to securely attach a directly molded polymer scraper 6803 to the stirring edge 6802 of the dual-purpose cutting/stirring blade 6899.

FIG. 69 shows a top down view of a post-assembly configuration of a dual-purpose cutting/stirring blade 6899. Counter-clock-wise rotational power may be applied to a dual-purpose cutting/stirring blade 6899 by a motor drive shaft 6904. Counter-clock-wise rotation of the dual-purpose cutting/stirring blade in FIG. 69 may provide sufficient cutting capability for the sharpened leading edge 6901 to chop or slice food. Clock-wise rotational power may be applied to a dual-purpose cutting/stirring blade by a motor drive shaft 6904. Clock-wise rotation of the dual-purpose cutting/stirring blade in FIG. 69 may provide sufficient pushing capability for the leading edge 702 to mix and/or stir food. One configuration of this stirring edge 6902 to mix and/or stir food may include an augmentation of the stirring edge 6902 to mix and/or stir food, in the form of a molded polymer scraper 6903, which may be made of silicone, or other soft durable food-safe polymer, in a shape that may be optimized to mix and scrape food in a cooking pot/vessel (not shown). The molded scraper 6903 is shown in FIG. 69 after direct molding to the dual-purpose cutting/stirring blade. The line of perforations 6908 along the stirring edge 6902 of the dual-purpose cutting/stirring blade may provide a method to securely attach a directly molded polymer scraper 6903 to the stirring edge 6902 of the dual-purpose cutting/stirring blade.

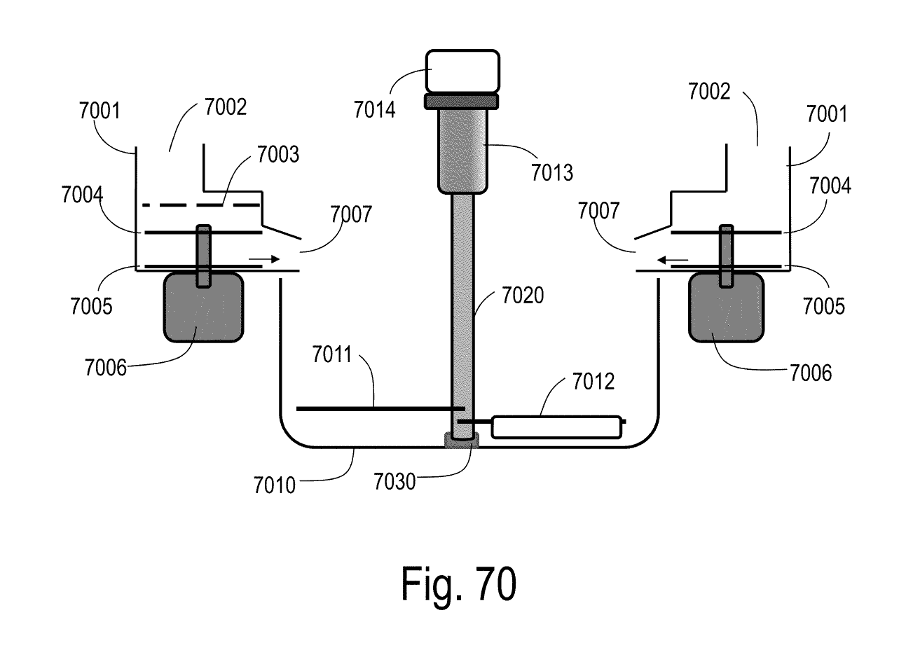

As illustrated (side view) in FIG. 70, a portion of an automated cooking system/apparatus which includes side-mounted perimeter slicing modules 7001, and a chopping and stirring module 7013 in the bottom of the cooking pot/vessel 7010 may be constructed and operated, and describes at least an embodiment of this invention. Food slicing modules 7001 may also include dicing and cutting apparatuses and functions. These perimeter food slicing modules 7001 may be strategically located about the perimeter of the automated cook pot/vessel 7010 to facilitate the delivery of food to the loading hopper 7002, by an ingredient dispenser (not shown) mounted on a Cartesian bot system (not shown). Outfitted with a suitable spinning blade 7004, food delivered to the loading hopper 7002, may be sliced, and then ejected by a rotating food ejector plate 7005, through the ejection port 7007 optimized to deliver food to the cooking pot/vessel 7010.

The food slicing modules 7001 may also include a pre-slicing gridded knife 7003. Each individual food slicing module 7001 may have a different size of pre-slicing gridded knife 7003. The pre-slicing gridded knives 7003 may be have openings as small as ⅛″×⅛″ and larger. Food pressed through a food slicing and cutting module 7001, with a gridded knife and no spinning blade 7004, may result in strips of food with a cross-section defined by the geometry of the gridded knife. Food pressed through a food slicing and cutting module 7001 with a gridded knife and a spinning blade 7004, may result in cubes of food with a cross-section defined by the geometry of the gridded knife and a length defined by the distance between the two blades.

Each individual food slicing module 7001 may be driven by separate motors 7006, or they may be driven by a single motor and a system of gears, belts and cables.

The multi-purposed top-down chopping and stirring module 7013, coming from above the cooking pot/vessel 7010 to substantially the bottom of the pot/vessel, where the shaft 7020 may engage a shaft stabilizer 7030, may include a chopping blade 7011 and a stirring module 7012, and may be driven by a separate motor system 7014. The variable motor 7014 may operate in either a clockwise or counter-clockwise direction. The chopping module 7011 may be designed using a suitable food chopping blade design, such that the cutting and chopping process may be optimized in one preferred direction and at an optimized speed used for cutting food. The stirring module 7012 may be designed using a suitable polymer such as silicone or other soft durable food-safe polymer, in a shape that may be optimized to mix and scrape food, mounted and integrated into to a cutting blade, such that the stirring process may be optimized in the reverse direction and at a lower speed than might be used for cutting food. Alternatively, the module 7013 may have just stirring functions and may not be involved in chopping.

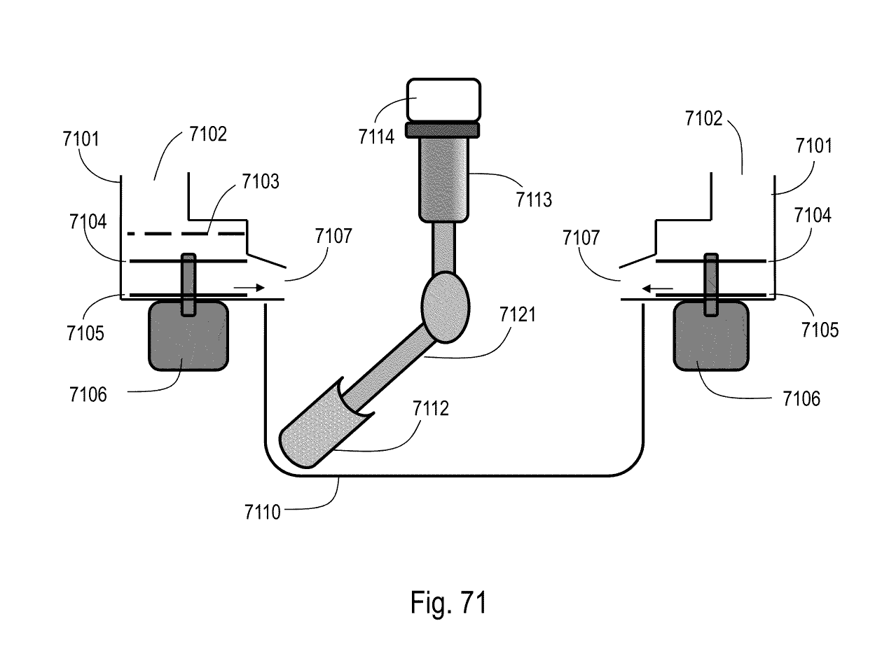

FIG. 71 shows a side view of a configuration for an automated cookpot having side-mounted perimeter slicing and cutting modules 7101, and a stirring module 7113 that extends substantially to the bottom of the cooking pot/vessel 7110. The perimeter food slicing modules 7101 may be strategically located about the perimeter of the automated cook pot/vessel 7110 to facilitate the delivery of food to the loading hopper 7102, by an ingredient dispenser (not shown) mounted on a Cartesian bot system (not shown). Outfitted with a suitable spinning blade 7104, food delivered to the loading hopper 7102, may be sliced, and then ejected by a rotating food ejector plate 7105, through the ejection port 7107 optimized to deliver food to the cooking pot 7110.

The food slicing modules 7101 may also include a pre-slicing gridded knife 7103. Each individual food slicing module 7101 may have a different size of pre-slicing gridded knife 7103. The pre-slicing gridded knives 7103 may be have openings as small as ⅛″×⅛″ and larger. Food pressed through a food slicing and cutting module 7101, with a gridded knife and no spinning blade 7104, may result in strips of food with a cross-section defined by the geometry of the gridded knife. Food pressed through a food slicing and cutting module 7101 with a gridded knife and a spinning blade 7104, may result in cubes of food with a cross-section defined by the geometry of the gridded knife and a length defined by the distance between the two blades.

Each individual food slicing module 7101 may be driven by separate motors 7106, or they may be driven by a single motor and a system of belts and cables.

The top-down articulated stirring arm module 7113, coming from above the cooking pot/vessel 7110, may consist of a an extended articulated-arm 7121 driven by a separate motor system 7114, with a stirring module 7112 mounted at the end to stir substantially to the bottom of the cooking pot/vessel 7110. The stirring module 7112 may be designed using a suitable polymer such as silicone or other soft durable food-safe polymer, in a shape that may be optimized to mix and scrape food. The variable motor 7114 may operate in either a clockwise or counter-clockwise direction and with adequate articulation control electronics may be able to mix, beat, froth or flip food.

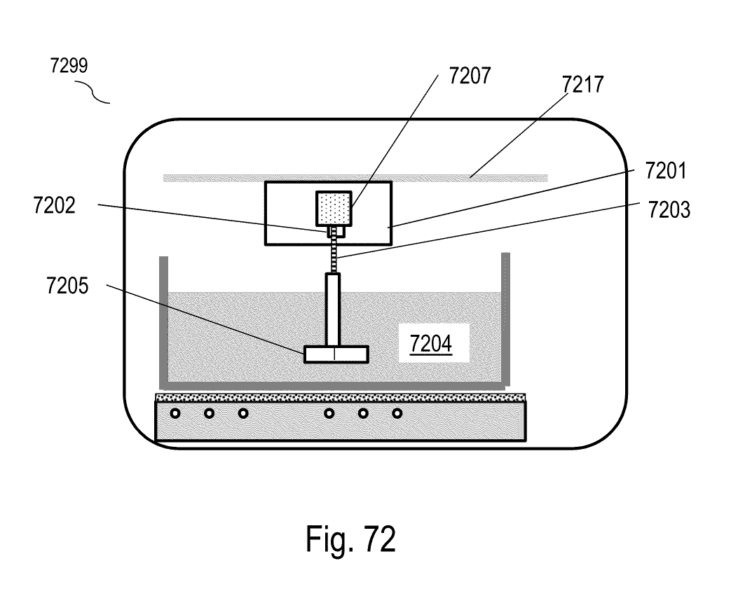

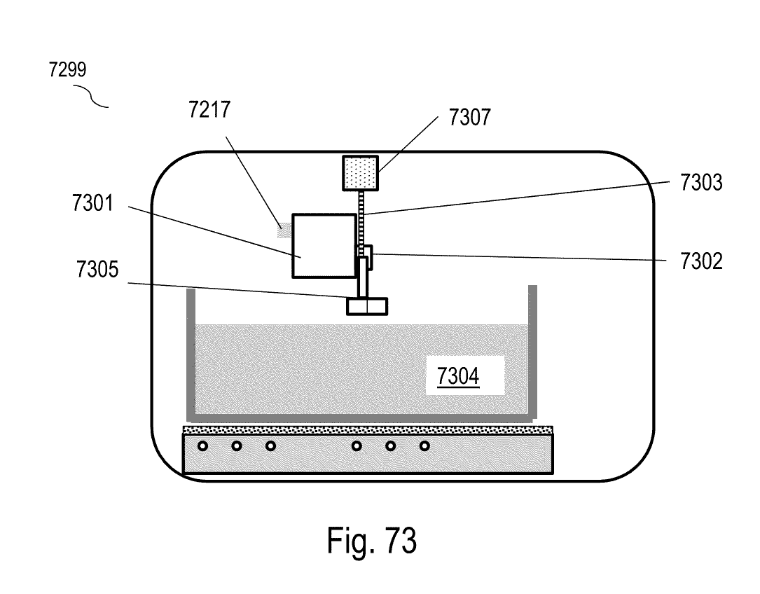

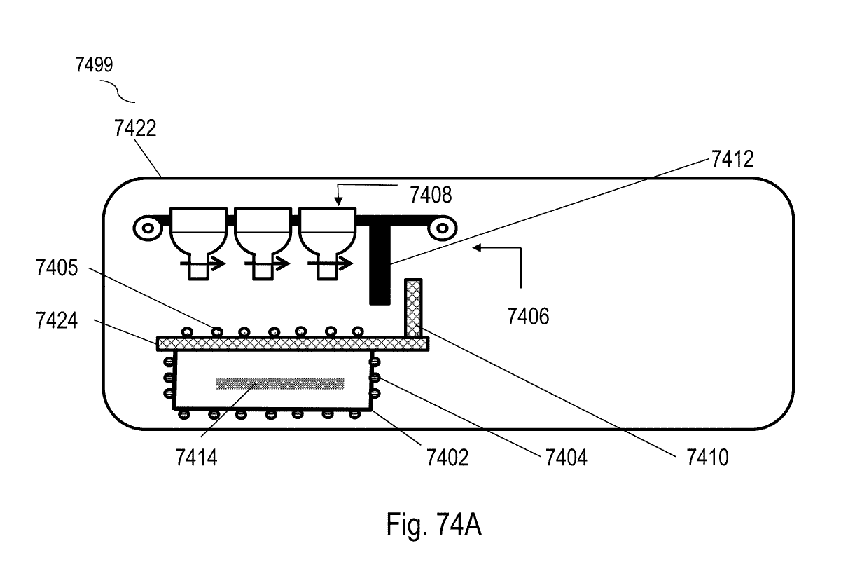

As illustrated (front view) in FIG. 72, an automated cooking machine/apparatus 7299 which uses a stirring mechanism whose motion may be controlled by a Cartesian bot may be constructed and operated, and describes at least an embodiment of this invention. The stirrer 7203 may be mounted on a Cartesian bot such as rails 7217, which may control the movement of the stirrer 7203 in multiple axes, including X, Y and Z, while the stirrer blade 7205 may be in contact with the food being cooked 7204. Such an arrangement may allow the stirrer's motion to be mechanically coupled to the Cartesian bot's motion, in part or in whole. A Cartesian bot portion 7201 can be moved to any point in the X, Y, Z plane using a set of motors and other robotic arm components. The Cartesian bot may be programmed to move the stirrer 7203 and the ingredients in the pot/vessel along with it, thereby ensuring that the food may be uniformly cooked and ingredients do not stick to the pot/vessel. The stirrer may optionally be attached to a robot arm, which may optionally control the position of the stirrer by retracting it, that is, lifting the blades away from the cooking pot when unnecessary, for example, while ingredients are being dispensed, and lowering the stirring blades into the food when stirring is required. Having this robot arm may allow the motion of the stirrer to be decoupled from the motion of the ingredient containers in at least one axis, which may help with flexibility and size issues. The motor 7207 and leadscrew 7203 may form part of the robot arm, and the robot arm may be attached to the Cartesian bot using an attachment 7202. Attaching (including mechanically coupled) the stirrer to the robot arm and the Cartesian bot may allow the stirrer to scrape the sides of the cooking vessel and the bottom when required, and may not do that otherwise. Thus the stirrer may have or be adapted to have many functions and motions in the automated cooking machine/apparatuses described at least herein. It will be clear to one skilled in the art that several types of robot arms are possible, and one is not limited to using the robot arm arrangement shown in FIG. 72. One skilled in the art will know the robot arm shown in FIG. 72 is a high-level pictorial view to show the concept. FIG. 73 illustrates the side view of the automated cooking machine/apparatus 7299 which uses a stirring mechanism whose motion may be controlled by a Cartesian bot. FIG. 73 shows the robot arm described in FIG. 72 retracting and moving the stirrer blades 7305 above the cooking pot/vessel and the ingredients 7304 when stirring is not required. The motor 7307 may be attached to the aforementioned Cartesian bot and the attachment may include leadscrew 7303 and attachment 7302. A portion of the Cartesian bot system is depicted as 7301, and it may be moved to any point in the X, Y, Z plane using a set of motors and other robotic arm components. The Cartesian bot may lift the blades 7305 above the cooking pot and the ingredients 7304, when stirring is not required.

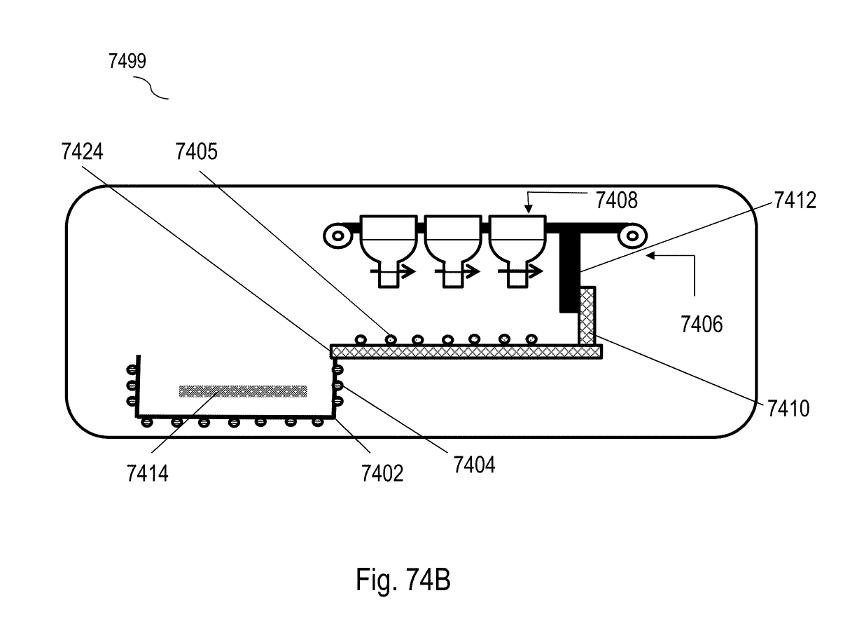

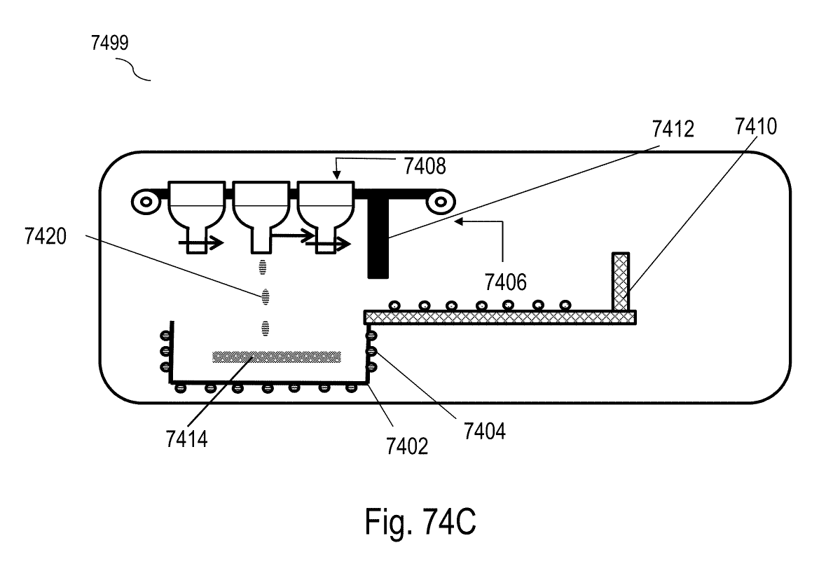

As illustrated in FIGS. 74A-74C, an automated cooking machine/apparatus 7499 including a multi-sided heating arrangement may be constructed and operated, which may be used to cook food, and describes at least an embodiment of this invention. Such an arrangement may be used, for example, for baking food. Automated cooking machine/apparatus 7499 may include baking chamber 7402, heating elements 7404 for the baking chamber 7402, portion of a Cartesian robot arm 7406, ingredient dispensers 7408, element 7410, pushers 7412, example food item being cooked 7414, cooking machine boundary 7422, and baking chamber top cover 7424. The system may be designed to heat on 1 side, 2 sides, 3 sides and/or all 4 slides of the baking chamber 7402. Portion of a Cartesian robot arm 7406 may include a multiplicity of elements, for example, ingredient dispensers 7408 and pushers 7412. The Cartesian bot may use multiple motors and other robotic components to get to most any point in the X, Y, Z plane within the cooking machine boundary 7422. Baking chamber top cover 7424 may be designed so that it may slide, and may slide, for example, by pushing the element 7410 with the pusher 7412. Baking chamber top cover 7424 may include top heating elements 7405, which may act as a top heater for baking chamber 7402. Top heating elements 7405 may be utilized to pre-heat and/or ingredients in ingredient dispensers 7408. Alternatively, one may use techniques utilized in robot arms, such as, for example, the use of motors to slide the top cover 7424. Alternatively, instead of using part of the Cartesian bot arm 7406 to push the element 7410, one may use another separate robot arm to push the element 7410. In FIG. 74A, the baking chamber top cover 7424 covers the baking chamber and may produce multi-sided heating to cook food item 7414. FIG. 74B illustrates the pusher 7412 pushing the baking chamber top cover 7424. FIG. 74C illustrates that once the baking chamber top cover 7424 is moved, then the food ingredients 7420 may be dispensed atop the food item 7414. For example, dough may be dispensed, or toppings for pizza may be dispensed, or something else. It will be clear to one skilled in the art that several variations of the proposed embodiments may be possible. Furthermore, the ideas described in FIG. 74A-74C may be combined with other elements of this disclosure herein, such as the stirrer concept described in FIG. 72 and FIG. 73, the chopping mechanism described in FIG. 60-FIG. 62 and other concepts. It will also be clear to one skilled in the art that FIG. 74A-74C are simplified drawings meant to show the concept. One skilled in the art will also realize that the heating on all 4 sides of the cooking machine may be configurable. That is, the heating on the bottom may be stronger when some foods are cooked, the heating on the sides may be turned off, and in general, the heating to the 4 sides of the vessel may be independently turned on or turned off or made higher or made lower in temperature.

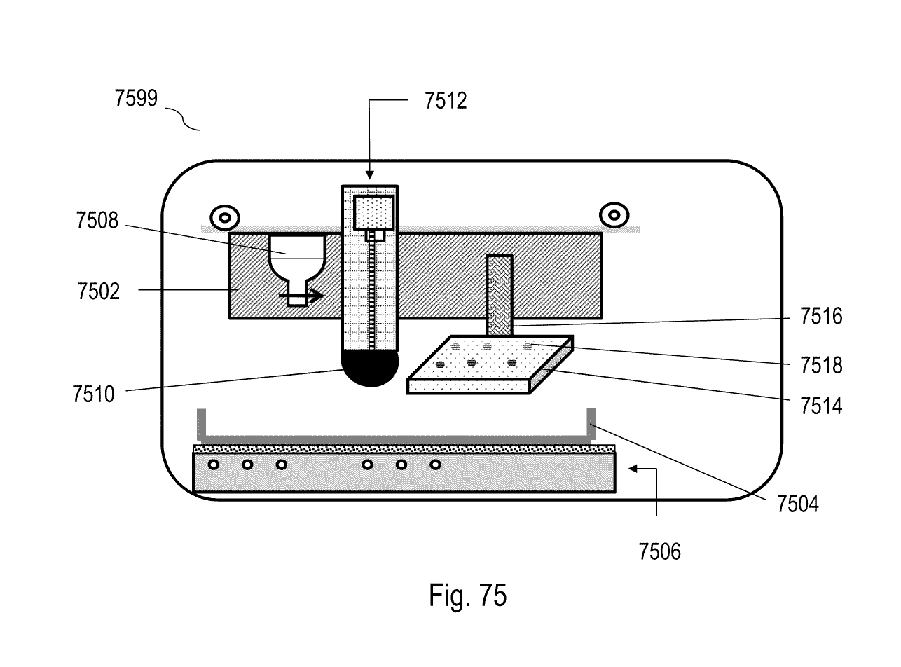

As illustrated in FIG. 75, a cooking machine/apparatus 7599 including a multi-sided heating arrangement may be constructed and operated, which may be used for cooking crepes, pancakes, dosas, rotis, pizzas and other food items which benefit from two sided heating, and describes at least an embodiment of this invention. Cooking machine/apparatus 7599 may include Cartesian bot system 7502, cooking surface/vessel 7504, heating system 7506, ingredient dispenser 7508, spatula 7510, first robot arm 7512, plate 7514, second robot arm 7516 and heaters 7518. For the rest of this description, we will use the term “crepe” for indicating the food item being cooked, for simplicity. One skilled in the art will realize cooking machine/apparatus 7599 and cooking methods herein may be applied to other types of food. The dough for the crepe may be dispensed using the ingredient dispenser system 7508 using techniques described herein this patent application. Cooking machine/apparatus 7599 may include spatula 7510, which may be used for spreading the crepe dough on the cooking surface/vessel 7504. The spatula 7510 may be optionally mounted on a first robot arm 7512, or it may be mounted on a non-movable arm (not shown). Plate 7514 may be a plate which may be heated using heaters 7518. One skilled in the art will realize various techniques and systems may be used to form and heat plate 7514 and one is not limited to just one type of heating apparatus. The plate 7514 may be mounted on a second robot arm 7516. Plate 7514 may be formed in many shapes and formats, for example, such as a substantially flat circle or ellipse or square, or a substantially convex circle or ellipse or square, perforated, and so on. Alternatively, the second robot arm 7516 may be non-movable or movable by human intervention only (not shown). The ingredient dispenser 7508, spatula 7510 with first robot arm 7512 and plate 7514 with second robot arm 7516 may all be mounted on a Cartesian bot system 7502 which may move to points in the x, y, z plane using a set of motors and rails. Heating system 7506 may be utilized for forming/cooking the crepe.

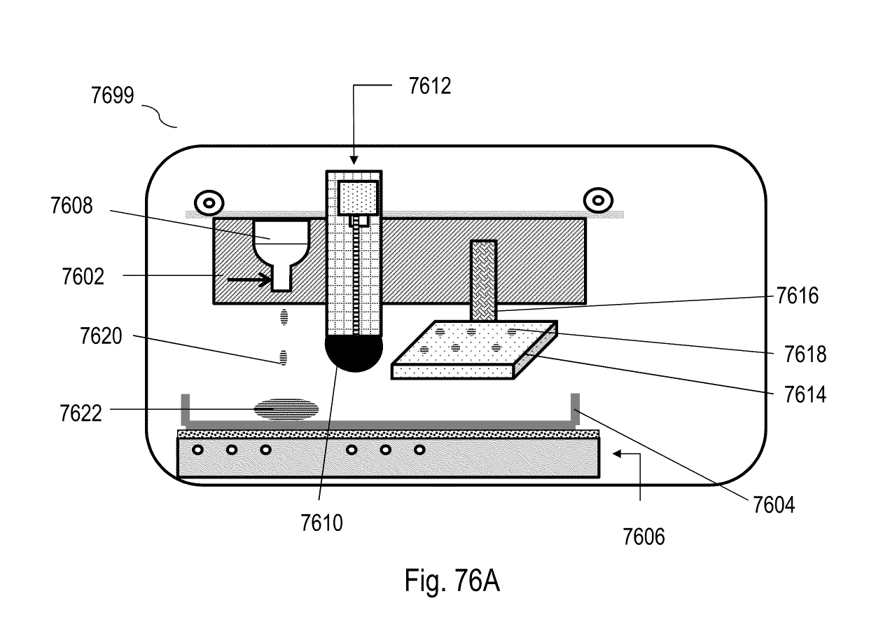

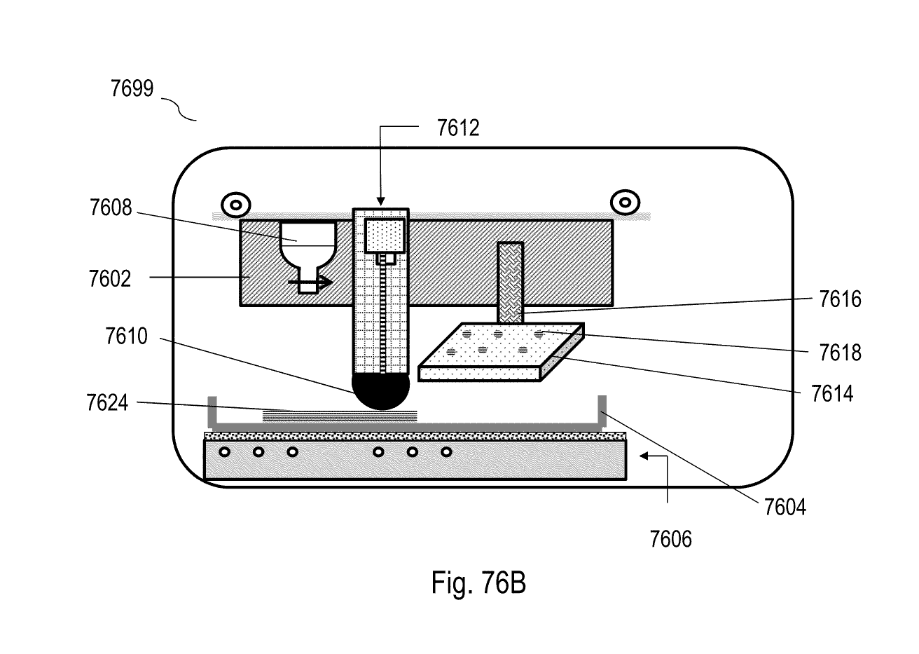

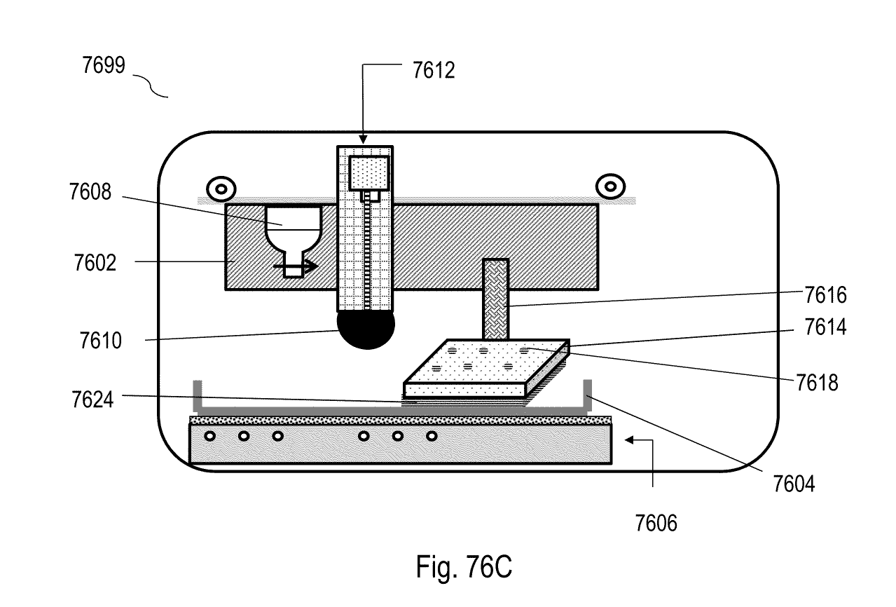

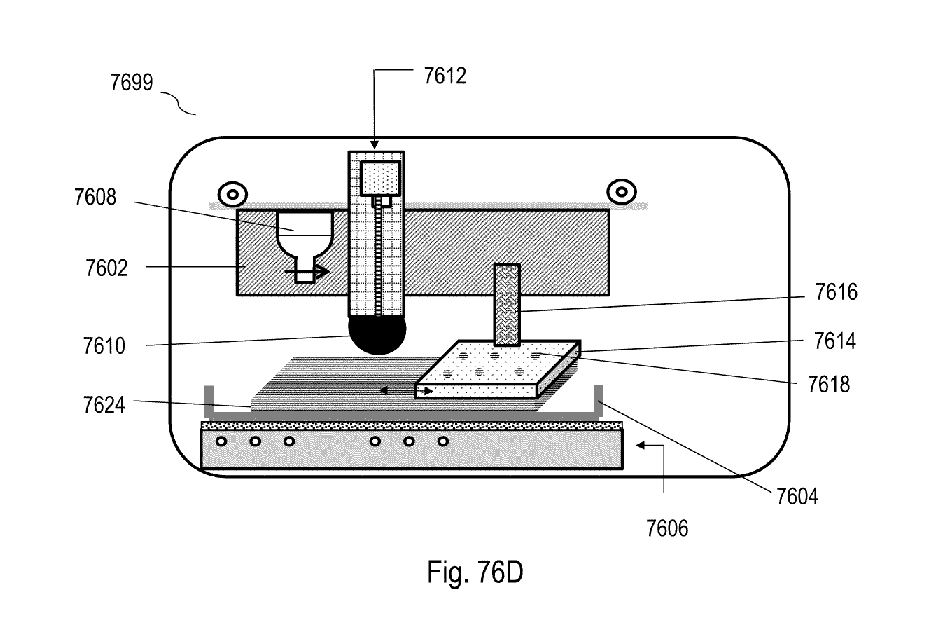

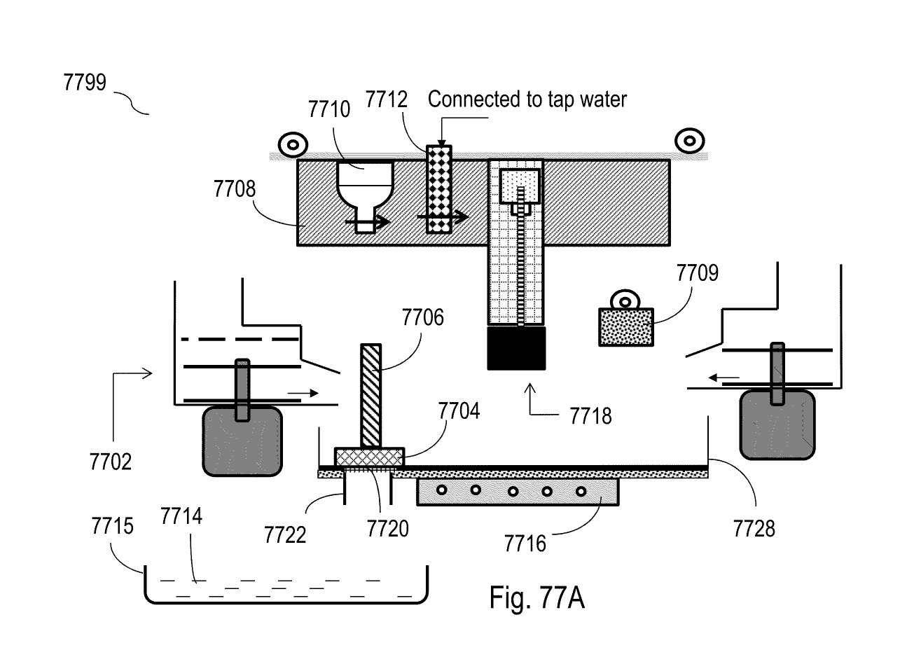

FIGS. 76A-76C illustrate an example method for how a system, such as cooking machine/apparatus 7599 in FIG. 75 herein, may be used for making crepes. Cooking machine/apparatus 7699 may include Cartesian bot system 7602, cooking surface/vessel 7604, heating system 7606, ingredient dispenser 7608, spatula 7610, first robot arm 7612, plate 7614, second robot arm 7616 and heaters 7618. Plate 7614 may be used for heating the top side of the crepe. First robot arm 7612 may be a robot arm that may move spatula 7610 in at least the up/down direction. Cartesian bot system 7602 may be part of the overall Cartesian bot system within cooking machine/apparatus 7699.

At the start of the cooking process, the ingredient dispenser 7608 may dispense dough 7620 to form a pile of dough 7622 as shown in FIG. 76A. FIG. 76B illustrates the next step in the cooking process where the ingredient dispenser 7608 is closed and the first robot arm 7612 moves the spatula 7610 as required to convert the pile of dough 7622 in FIG. 76A into the “crepe-like” shape crepe 7624 in FIG. 76B. Movement of spatula 7610 may include x, y and z directions, either individually or in combination. FIG. 76C illustrates the next step in the process where the heated plate 7614 may be used to heat the crepe on the top side and the heating system 7606 may be used to heat the crepe on the bottom side. The heated plate 7614 may be moved atop the crepe 7624 by using motion of the Cartesian bot or alternatively, by using a movable second robot arm 7616. One may even use a combination of the Cartesian bot motion and robot arm motion to move the heated plate 7614 atop the crepe. The heating to the top plate 7614 and the bottom heating system 7606 may be configured in different ways to obtain optimal cooking of the crepe 7624. These may include use of different temperatures in the top and bottom heaters. It may also include the top plate 7614 being smaller in size than the crepe being cooked, as shown in FIG. 76D. The top plate 7614 may then be moved using the Cartesian bot system over different parts of the crepe 7624 to heat it. This allows space saving compared to using a top plate that is the same size as the crepe. The top heater may use one of multiple types of heating sources: radiative heat, infra-red heat, conductive heat or convective heat or some other heating system altogether. Infra-red heating may allow precise application of heat on the food being cooked and may result in less heating of other parts of the system such as the ingredient dispenser 7608 or the surrounding air. The use of a robot arm for second robot arm 7616 may allow the heater to move close to the food being cooked thereby resulting in less heat loss to the surroundings. Sensors may be used to detect how tall the food item being cooked is and adjust the Z position of the top heating plate 7614. It will be clear to one skilled in the art that several variations of the proposed embodiments may be possible. One may add toppings atop the crepe using other dispensers. One may add oil on the pan using an ingredient dispenser system to prevent the crepe from sticking to the pan. One may use the system shown in FIG. 75 and FIG. 76 for food items other than crepes, such as for example, pizzas, entrees and other items which may require two sided heating systems. One may use the ideas in FIG. 75 and FIG. 76 along with other ideas in the patent application. One may even prepare the dough needed for the crepe by using the Cartesian bot to dispense ingredients for the dough into the cooking vessel and have a stirrer mix it. One may use mass sensors atop the ingredient dispenser to control the amount of dough being dispensed. One may use a solenoid operated valve or some other valve to control the amount of dough being dispensed. Various other embodiments may be possible.

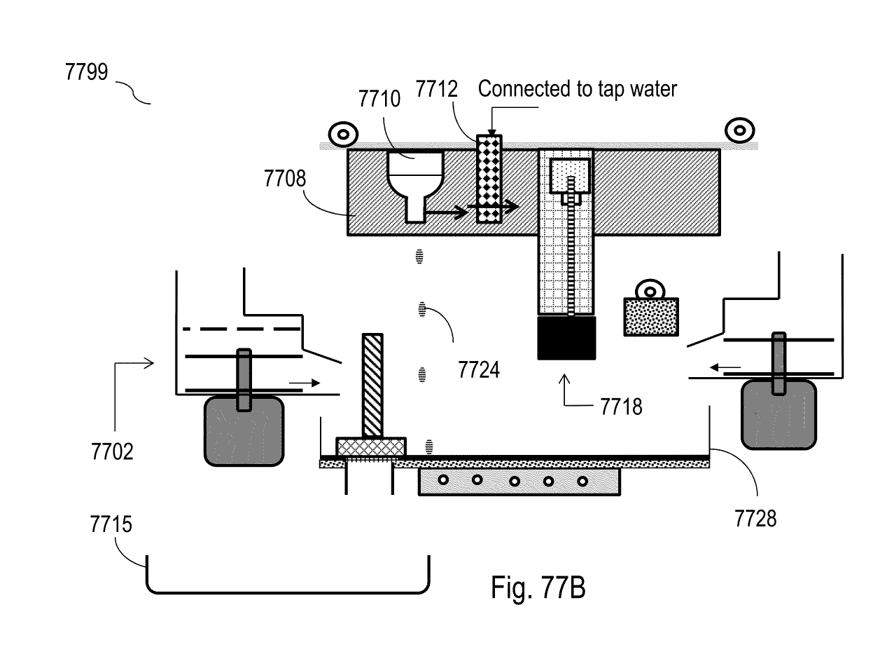

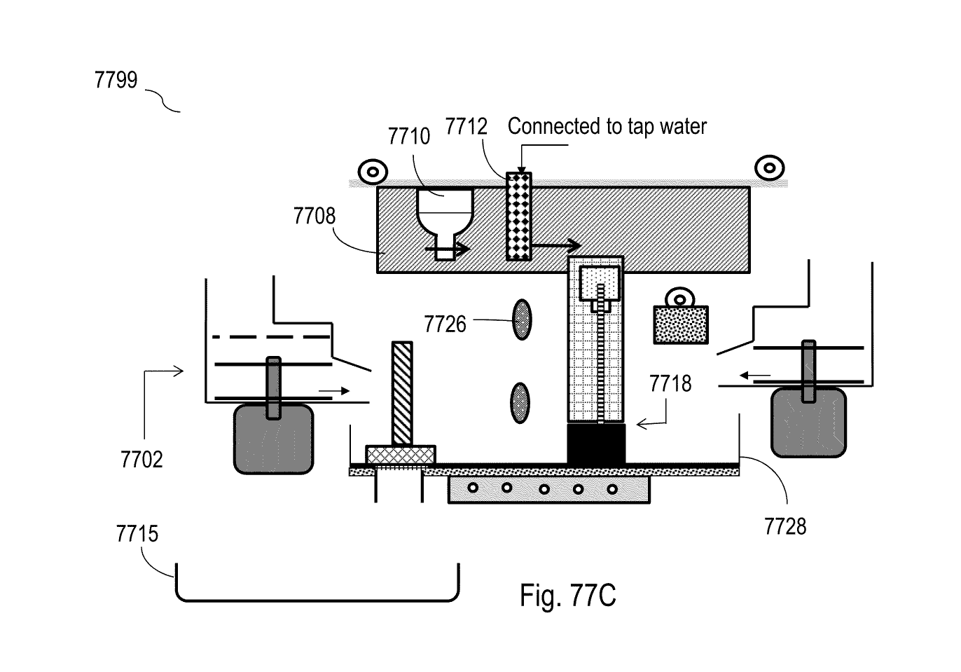

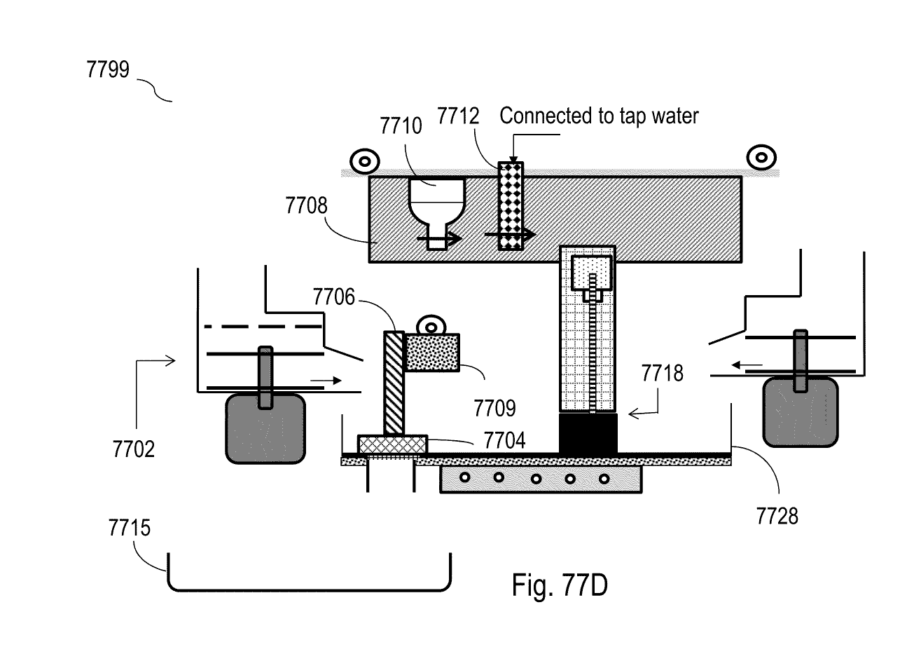

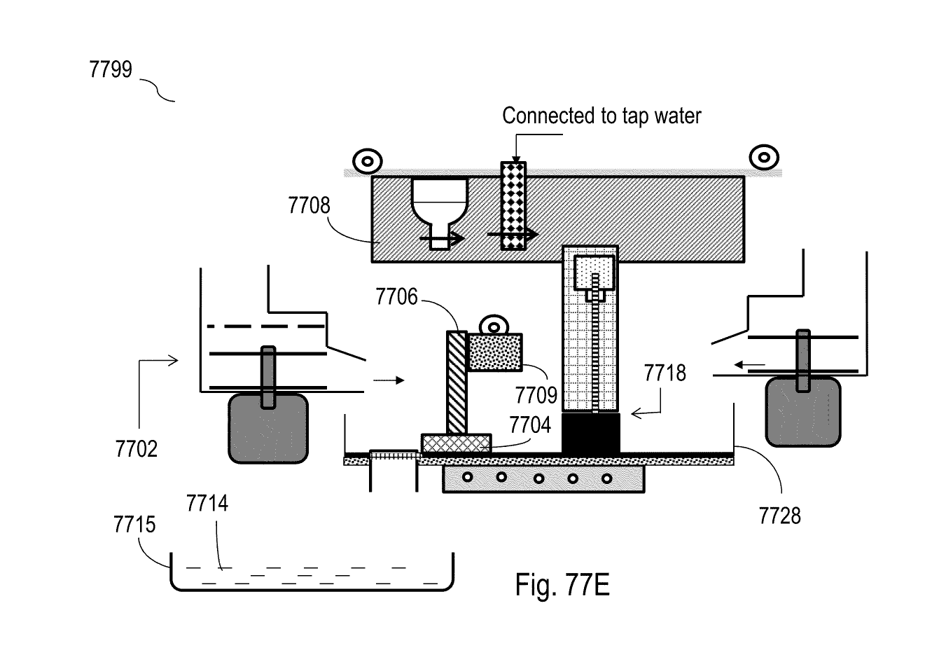

As illustrated in FIGS. 77A-77E, a cooking machine/apparatus 7799 including an automated cleaning system may be constructed and operated, which may be used for cleaning a portion of the cooking machine/apparatus, and describes at least an embodiment of this invention. The portion of cooking machine/apparatus 7799 illustrated in FIGS. 77A-77E may include continuous flow food processor 7702, cover 7704, rod 7706, portion of Cartesian bot system 7708, robot arm 7709, dispenser 7710, water source 7712, residue 7714, pan 7715, heat source 7716, stirring system 7718, filter 7720, hole 7722 and cooking vessel 7728. Continuous flow food processor 7702 may be a continuous flow food processor, such as, for example, the system described in FIG. 60-62. Portion of Cartesian bot system 7708 may be part of a Cartesian bot system that may move to points in the (x, y, z) plane. Stirring system 7718 may be a stirring system, such as, for example, the system described in FIG. 72-73. Cover 7704 may be a cover for the hole 7722 in the cooking vessel 7728. Rod 7706 may be a rod connected to the hole 7722. Filter 7720 may be a filter that blocks certain particle sizes from exiting the cooking vessel 7728. Robot arm 7709 may be a robot arm that may either be coupled to/part of the portion of Cartesian bot system 7708 or may move independently. Residue 7714 may be the residue left after the cleaning process is complete and maybe gathered in pan 7715 or may be connected to a utility/facility drain. Dispenser 7710 for cleanser may be filled with a cleanser compatible with the interior and fittings of the machine/apparatus which it may be applied to, for example, a low-sudsing soap, a light grit cleanser, a stainless steel cleanser, and so on. The word soap shall be used to represent the cleanser in the following.

FIG. 77B may illustrate the first step in the cleaning process. Soap 7724 may be dispensed from the dispenser 7710 into the cooking vessel 7728. Soap 7724 may optionally also be dispensed into the food processor 7702 that may have been used, for example, for chopping. FIG. 77C may illustrate the next step in the cleaning process. Water 7726 may be dispensed from the water source 7712. The water source 7712 may be connected to tap water, or may be connected to an alternative water source, such as, for example, an ozinated water source. The stirring system 7718 may be moved by the portion of Cartesian bot system 7708 and may be used to scrap/remove away particles from the cooking vessel 7728. Water may be optionally dispensed into the food processor 7702 and the food processor 7702 may be operated to circulate the water and soap. Following this, additional water may be dispensed into the food processor 7702 to rinse clean of soap 7724. FIG. 77D may illustrate the next step in the cleaning process. The robot arm 7709 may be pushed against the rod 7706 to move it away from the hole 7722. The soap 7724 and water 7726 left in the vessel 7728 after cleaning may then leave the system using hole 7722. The stirring system 7718 may be used to push water and particles towards the hole 7722 and the residue 7714 may collect in pan 7715. FIG. 77E may show the system when this is complete. The process shown in FIG. 77C, FIG. 77D and FIG. 77E may be repeated multiple times until the system is clean. Soap may optionally be dispensed as well to allow further cleaning. One skilled in the art will understand that several variations of these embodiments are possible. For example, one may use a different drainage system and mechanism that may be controlled by the motion of the Cartesian bot. A portion of the method may not use the Cartesian bot system, for example, an electric or pneumatic valve to control the residue flow from cooking vessel 7728 to pan 7715. Pressurized water with directional nozzles may be used to dispense the water 7726 and/or soap 7724. The nozzles may also be adapted to utilize ultra or mega sonic action to promote cleaning and lessen the use of soap 7724. The drainage system and mechanism shown in FIGS. 77A-77E may be used for cooking types of food where water drainage may be required, such as, for example, pastas.

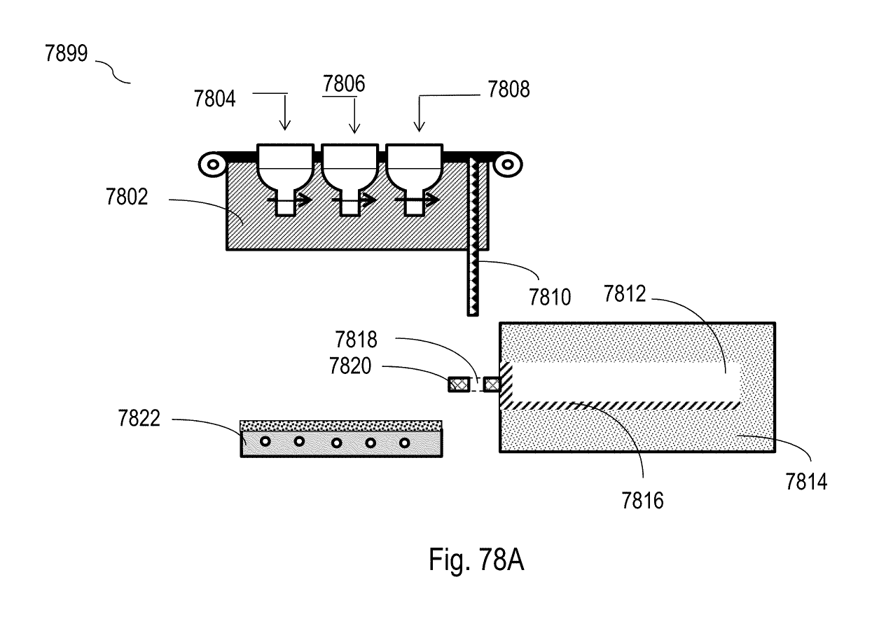

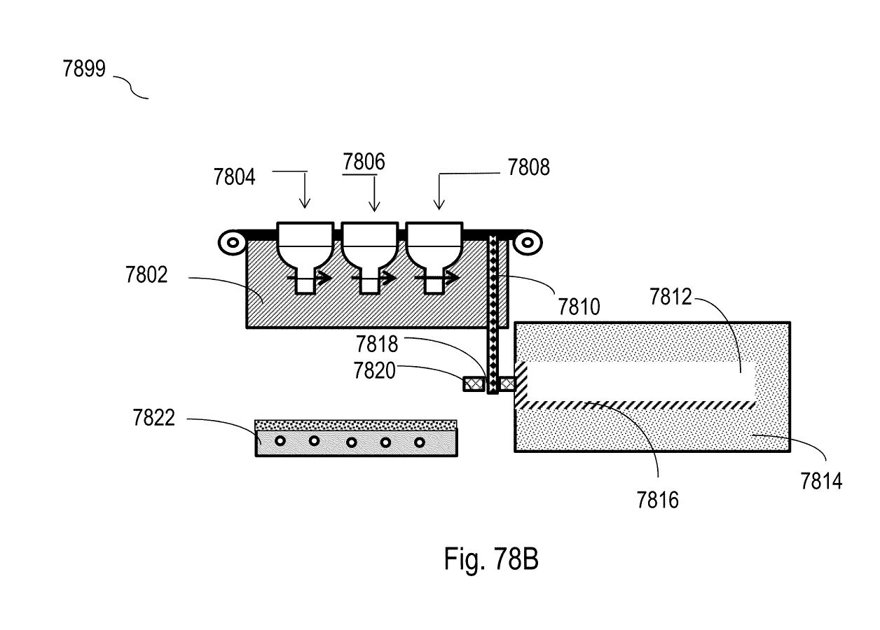

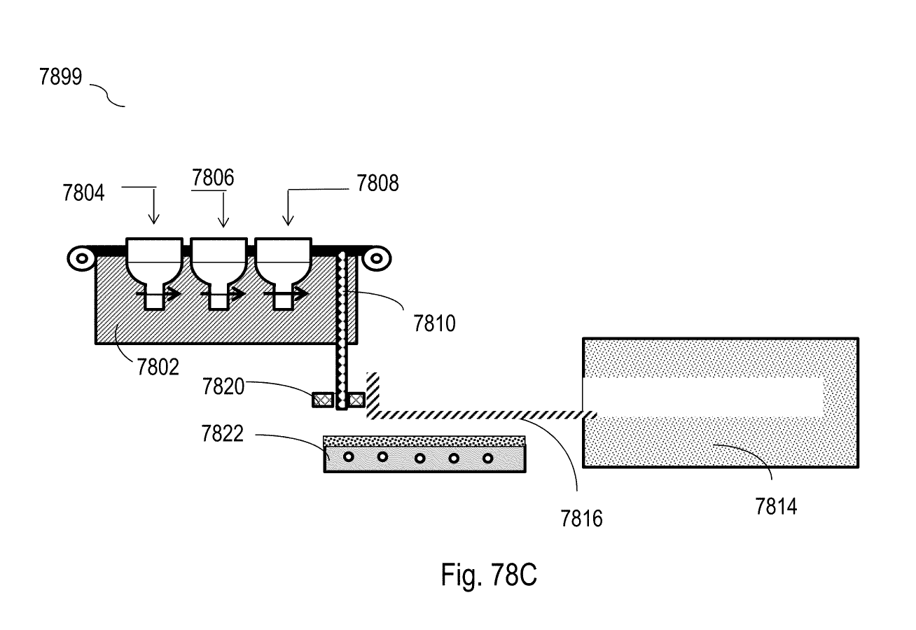

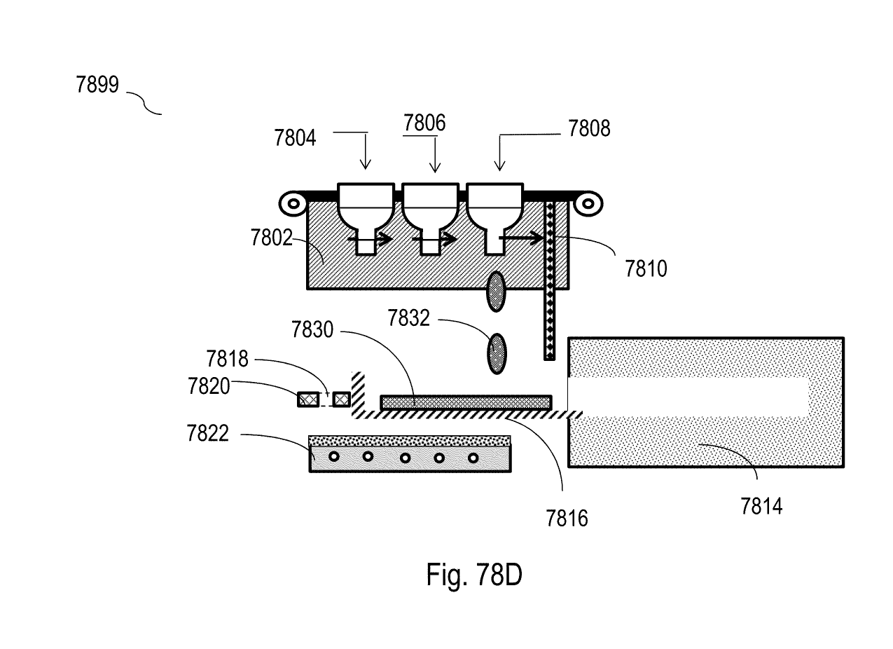

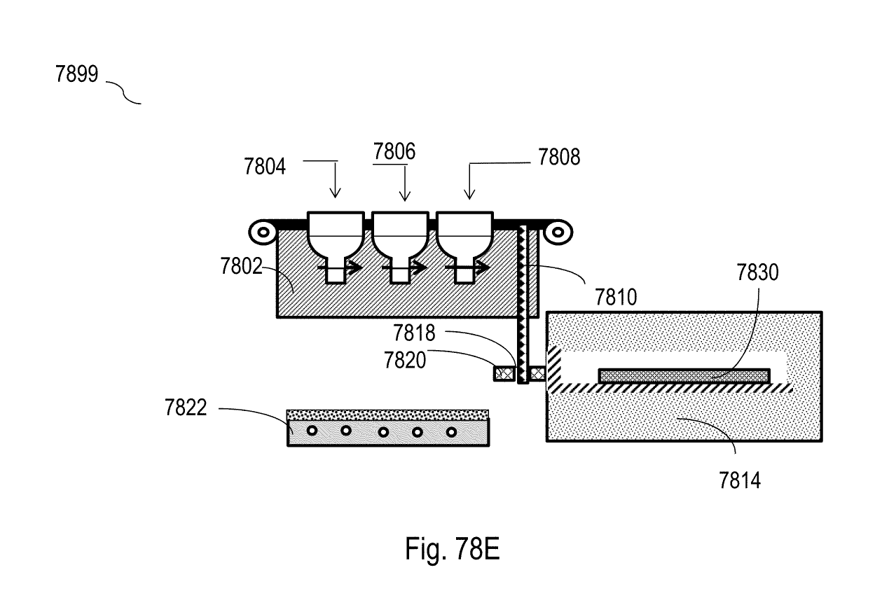

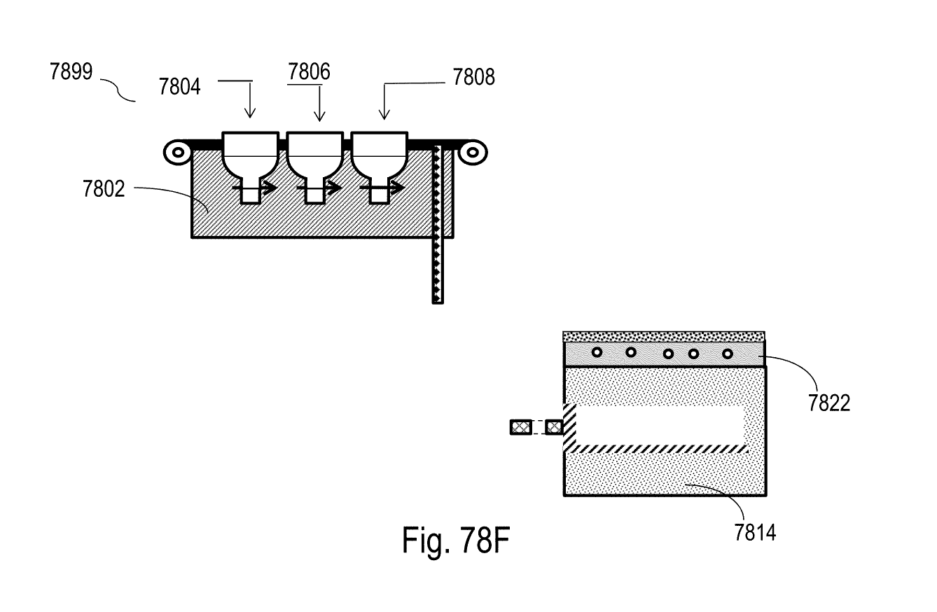

As illustrated in FIGS. 78A-78E, a cooking machine/apparatus 7899 may be constructed and operated, which may be used for making baked food such as, for example, pizza, and describes at least an embodiment of this invention. The portion of cooking machine/apparatus 7899 illustrated in FIGS. 78A-78E may include portion of a Cartesian bot system 7802, first ingredient delivery capsule 7804, second ingredient delivery capsule 7806, third ingredient delivery capsule 7808, actuator arm 7810, heated region 7812, baking chamber 7814, drawer 7816, opening 7818, handle 7820, and bottom side heater 7822. Portion of a Cartesian bot system 7802 may be a part of a Cartesian bot system of cooking machine/apparatus 7899. First ingredient delivery capsule 7804, second ingredient delivery capsule 7806, third ingredient delivery capsule 7808 may contain different toppings for the food to be baked. Bottom side heater 7822 may be a bottom side heater which may be used for making some types of food. Baking chamber 7814 may be a baking chamber with a drawer 7816 which may slide in and out of the baking chamber 7814. The handle 7820 of the baking chamber 7814 may include an opening 7818. Heated region 7812 may be the volume region within the baking chamber that is heated. FIG. 78B-78E may illustrate different steps in the baking process. FIG. 78B may indicate the first step in the baking process, wherein actuator arm 7810 may be inserted into the opening 7818 by the portion of a Cartesian bot system 7802. FIG. 78C indicates the next step in the process. Using the Cartesian bot's motion, the drawer 7816 may be pulled out. FIG. 78D indicates the next step. The user may place some food item to be cooked 7830, for example, pizza base or pizza dough or some other food item, atop the drawer 7816. Following this, different toppings and ingredients 7832 may be dispensed onto the example pizza base food item to be cooked 7830 using ingredient dispensers first ingredient delivery capsule 7804, second ingredient delivery capsule 7806, third ingredient delivery capsule 7808. FIG. 78E indicates the next step in the process where the actuator arm 7810 may be inserted into the opening 7818 and push the drawer 7816 and food item being cooked 7830 into the baking chamber 7814. The cooking, such as baking, then may occur, and then the drawer 7816 may be opened using the actuator arm 7810. The drawer 7816 may then be closed. One skilled in the art may recognize that several variations of this embodiment are possible. For example, instead of using a drawer system, a rotary system may be used for the baking oven and that may be opened by the Cartesian bot using its motion and may include a special attachment on the Cartesian bot or baking chamber. FIG. 78F illustrates an embodiment of this invention wherein the baking chamber 7814 may lie below the bottom side heater 7822. Alternatively, the baking chamber 7814 and the bottom side heater 7822 may be disposed side by side. The actuator arm 7810 may include a robot arm which may independently move upwards and downwards, in addition to utilizing the Cartesian bot system's motion. Various other embodiments may be possible.

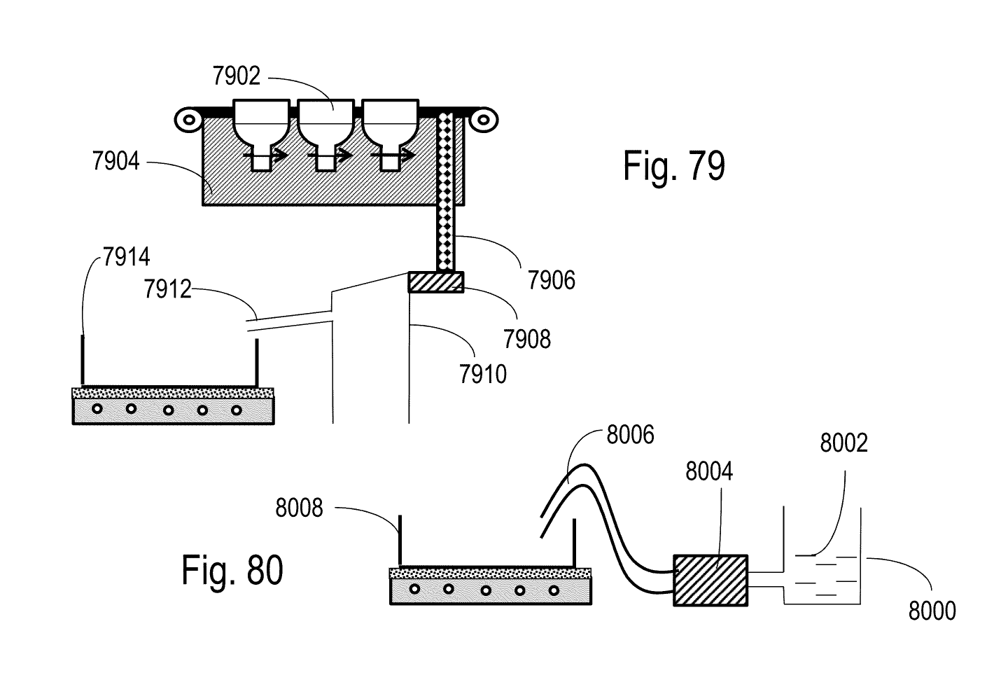

FIG. 79 describes an embodiment of this present invention, which illustrates a technique to dispense liquids which may be integrated into the automated cooking machine/apparatuses herein. Ingredient dispenser containers 7902 may be an ingredient dispenser system mounted on a Cartesian bot 7904. Cooking vessel 7914 may be where the coking primarily takes place, and container 7910 may be used for storing liquids. When a part of the Cartesian bot system 7906 pushes a part of the liquid container 7910 at the region 7908, liquids may be dispensed into the cooking vessel 7914 using the spout 7912. The mechanism of dispensing the liquid may be similar to the mechanism commonly used in soap dispensers. Alternatively, some other mechanism may be used. Multiple pushes may be conducted atop the region 7908 in order to dispense the amount of liquid desired. It will be clear to one skilled in the art that several variations of this embodiment are possible. One may use a sensor activated liquid dispenser, for example. Moreover, a pressurized system may be utilized to dispense the liquids. The region 7908 that is pushed for dispensing may require a horizontal motion instead of a vertical motion such as described in FIG. 79.

FIG. 80 describes an embodiment of this invention, which illustrates an alternative method to deliver liquid ingredients to the cooking robot. Cooking vessel 7914 may be where the coking primarily takes place in the cooking robot. Source 8000 may be a source for the liquid 8002. Pump 8004 may move liquid 8002 and pipe 8006 may be a pipe used to deliver liquid 8002 to the cooking vessel 8008. Based on electronic signals applied to the pump 8004, liquid 8002 may be delivered to the cooking vessel 8008. It will be clear to one skilled in the art that the pump 8004 can be of several types, for example, peristaltic pumps, and various other types of pumps.

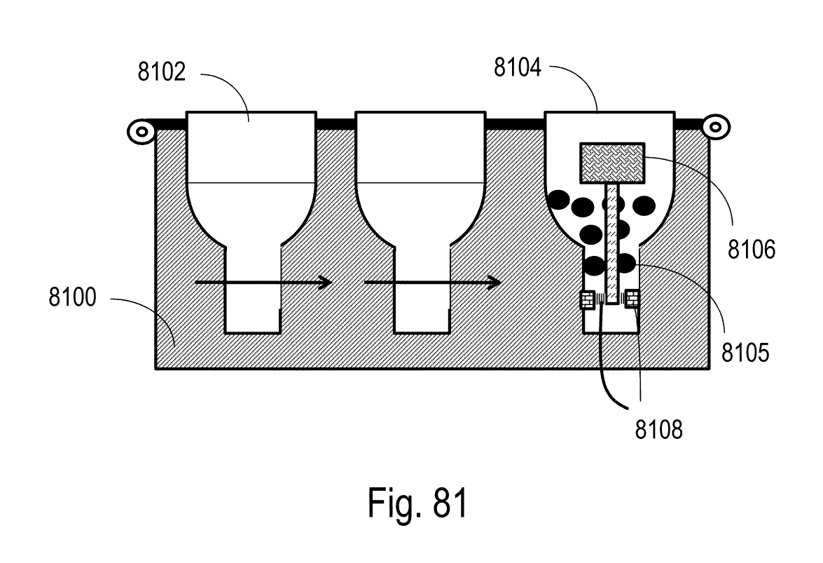

FIG. 81 describes an embodiment of this invention, which may be a way to deliver spices to the cooking robot. Portion of an ingredient dispenser system 8100 may be a mounted on a Cartesian robot. First ingredient dispenser containers 8102 and spice dispenser container 8104 may be coupled to portion of an ingredient dispenser system 8100. Spice dispenser container 8104 may include motor 8106, drive mechanism 8105 and parts of the spice dispensing mechanism 8108. A motor, such as motor 8106, may be a used in each spice container in the ingredient dispenser to allow dispensing spices. The motor and actuation mechanism for dispensing spices may be similar to the ones used in pepper grinders and salt grinders.

An improvement to the one slider, spice valve system may be to add one more delivery via which may improve the efficiency of delivery. Another improvement may be to shape the end of the slider in such a way as to make operation from only one side feasible. An L-shaped slider and an F-shaped slider may offer this option, and may allow the Cartesian bot and a motor-mounted actuator, a push and pull operation to operate the dispensing of calibrated quantities of food and spices.

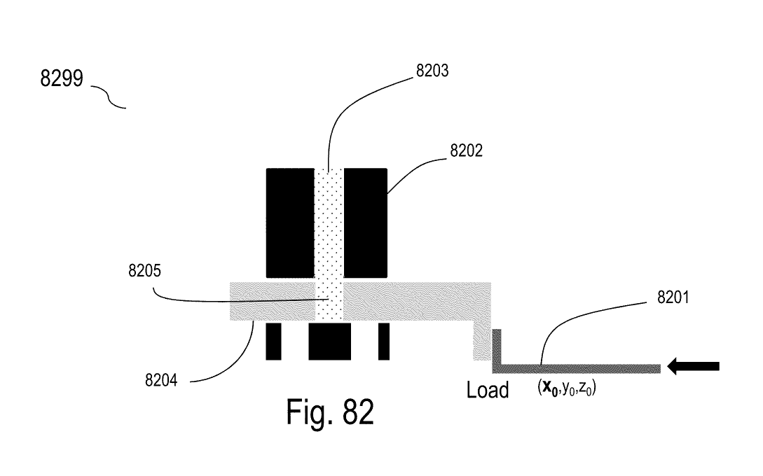

FIG. 82 illustrates an example configuration of a dual via, single L-shaped slider valve system 8299 with the slider 8204 in the load position. The Cartesian bot and a motor-mounted linear actuator 8201 may be used to push the slider 8204 to a position, such that the slider opening may align with the spice reservoir 8203 in the valve body 8202, which may allow food and spices stored in the reservoir 8203 to fall and fill the calibrated space 8205, within the slider 8204.

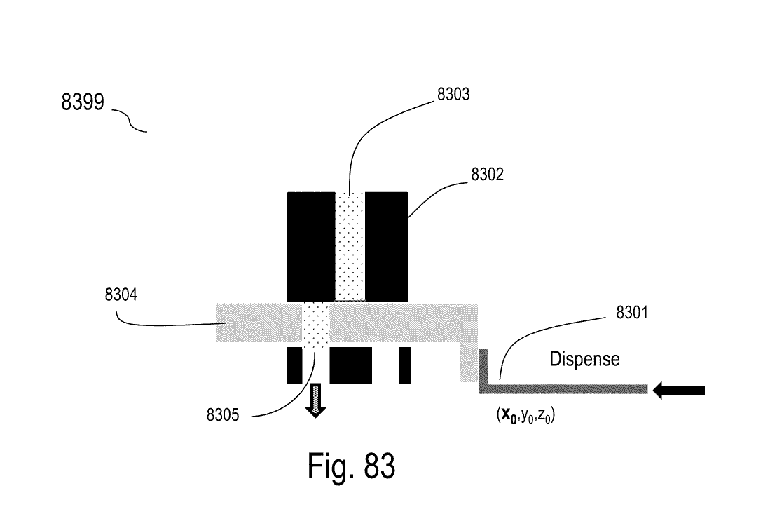

FIG. 83 illustrates an example configuration of a dual via, single L-shaped slider valve system 8399 with the slider 8304 in the dispense position. The Cartesian bot and a motor-mounted linear actuator 8301 may be used to push the slider 8304 to a position, such that the slider opening may align with one of the dispensing vias in the valve body 8302, which may allow food and spices contained in the calibrated space 8305 of the L-shaped slider 8304 to fall and dispense spices to the cooking vessel/pot (not shown). The illustration includes reservoir 8303.

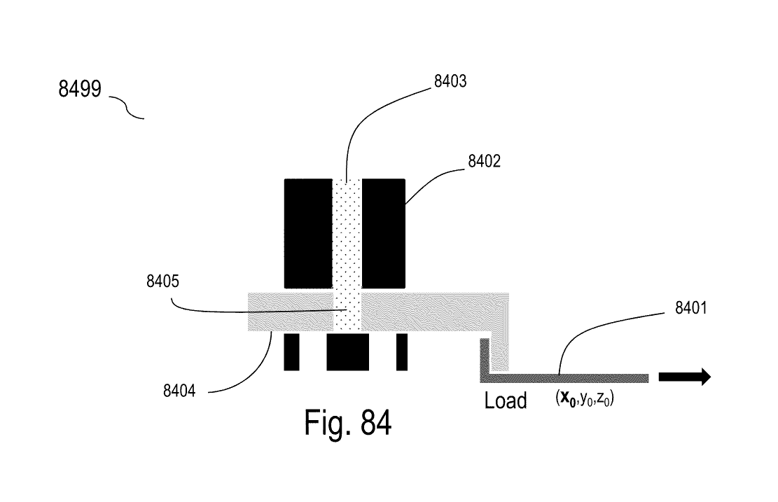

FIG. 84 illustrates an example configuration of a dual via, single L-shaped slider valve system 8499 with the slider 8404 in the load position. The Cartesian bot and a motor-mounted linear actuator 8401 may be used to pull the slider 8404 to a position, such that the slider opening 8405 may align with the reservoir 8403 in the valve body 8402, which may allow food and spices stored in the reservoir 8403 to fall and fill the calibrated space 8405, within the slider 8404.

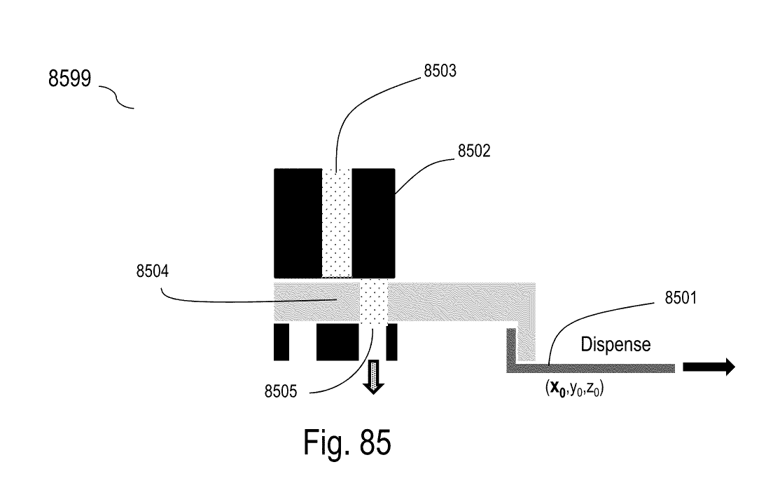

FIG. 85 illustrates an example configuration of a dual via, single L-shaped slider valve system 8599 with the slider 8504 in the dispense position. The Cartesian bot and a motor-mounted linear actuator 8501 may be used to pull the slider 8504 to a position, such that the slider opening 8505 may align with the one of the dispensing vias in the valve body 8502, which may allow food and spices contained in the calibrated space 8505 of the L-shaped slider 8504 to fall and dispense food and spices to the cooking vessel/pot (not shown). The illustration includes reservoir 8503.

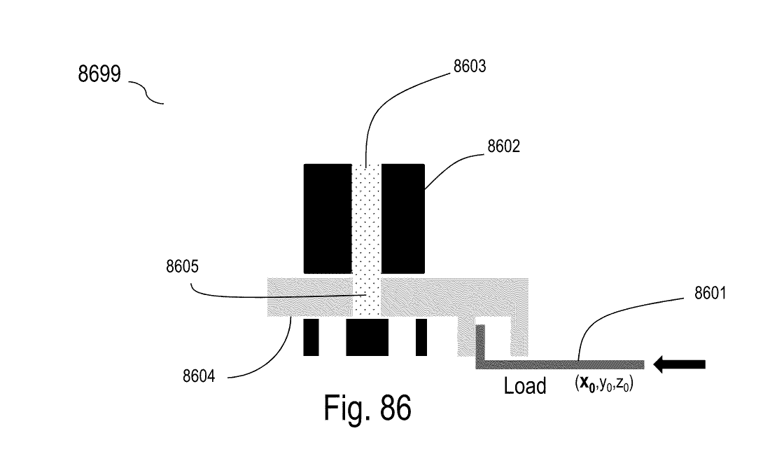

FIG. 86 illustrates an example configuration of a dual via, single F-shaped slider valve system 8699 with the slider 8604 in the load position. The Cartesian bot and a motor-mounted linear actuator 8601 may be used to push the slider 8604 to a position, such that the slider opening may align with the spice reservoir 8603 in the valve body 8602, which may allow food and spices stored in the reservoir 8603 to fall and fill the calibrated space 8605, within the F-shaped slider 8604.

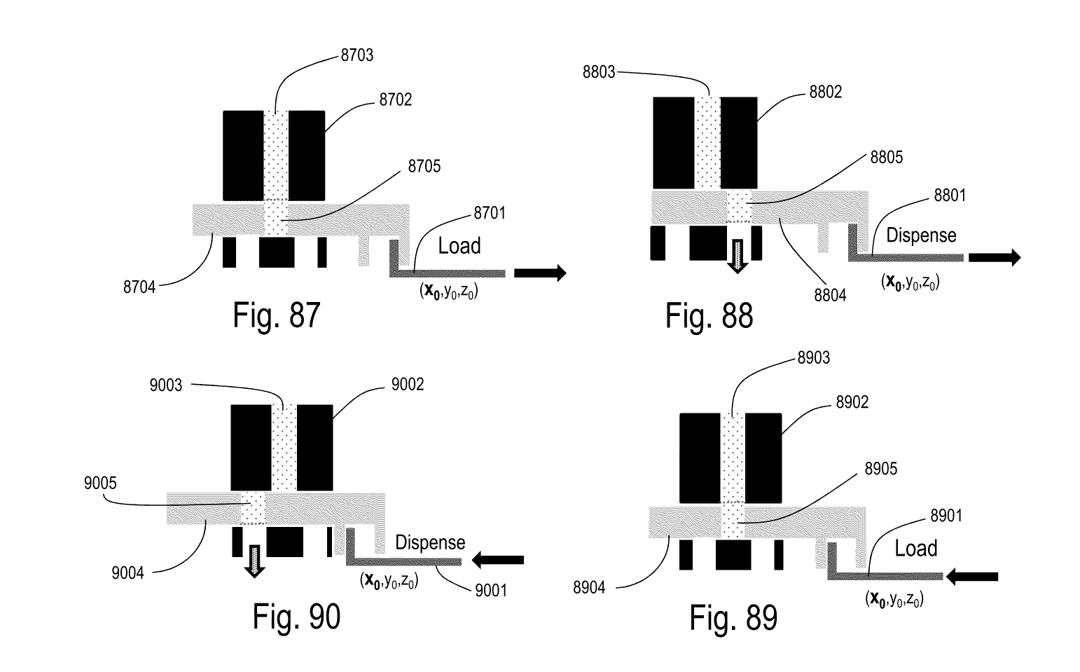

FIG. 87 through FIG. 90 shows an example sequential operation of dual vias, with a single F-shaped slider valve system to efficiently deliver food and spices with a Cartesian bot and a motor-mounted slider using actuation from one side only. This sequential operation with dual vias may also result in self-cleaning and reduced clogging.

FIG. 87 illustrates an example configuration of a dual via, single F-shaped slider valve system with the slider 8704 in the load position. The Cartesian bot and a motor-mounted linear actuator 8701 may be used to pull the slider 8704 to a position, such that the slider opening 8705 may align with the spice reservoir 8703 in the valve body 8702, which may allow food and spices stored in the reservoir 8703 to fall and fill the calibrated space 8705, within the F-shaped slider 8704.

FIG. 88 illustrates an example configuration of a dual via, single F-shaped slider valve system with the slider in the dispense position, which may follow FIG. 87. The Cartesian bot and a motor-mounted linear actuator 8801 may be used to pull the slider 8804 to a position, such that the slider opening 8805 may align with one of the dispensing vias in the valve body 8802, which may then allow food and spices contained in the calibrated space 8805 of the F-shaped slider 8804 to fall and dispense food and spices to the cooking vessel/pot (not shown). The illustration includes reservoir 8803.

FIG. 89 illustrates an example configuration of a dual via, single F-shaped slider valve system with the slider 8904 in the load position, which may follow FIG. 88. The Cartesian bot and a motor-mounted linear actuator 8901 may be used to push the slider 8904 to a position, such that the slider opening 8904 may align with the spice reservoir 8903 in the valve body 8902, which may allow food and spices stored in the reservoir 8903 to fall and fill the calibrated space 8905, within the F-shaped slider 8904.

FIG. 90 illustrates an example configuration of a dual via, single F-shaped slider valve system with the slider in the dispense position, which may follow FIG. 89. The Cartesian bot and a motor-mounted linear actuator 9001 may be used to push the slider 9004 to a position, such that the slider opening 9005 may align with one of the dispensing vias in the valve body 9002, which may then allow food and spices contained in the calibrated space 9005 of the F-shaped slider 9004 to fall and dispense food and spices to the cooking vessel/pot (not shown). The illustration includes spice reservoir 9003.

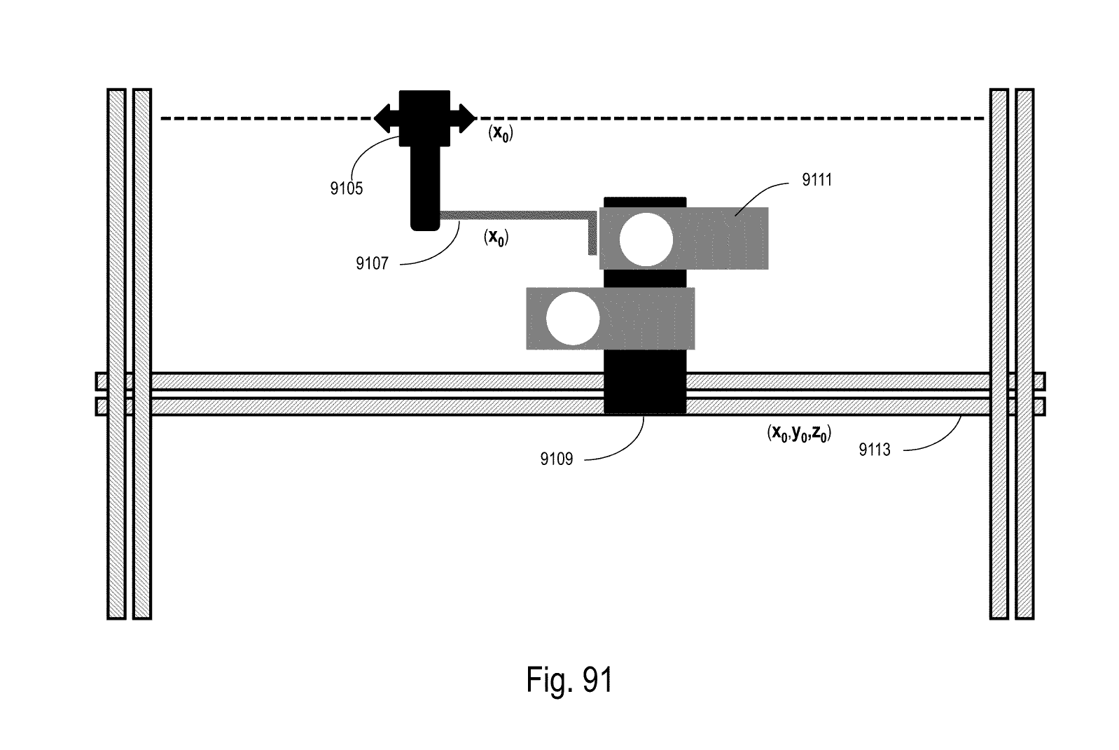

FIG. 91 illustrates an example of a number of possible configurations for a Cartesian bot 9113 with an actuator 9107 attached to an independent motorized robot arm 9105. The Cartesian bot may be used to position food modules in any position within the cooking robot's space (x₀, y₀, z₀). The motorized robot arm 9105 with an attached actuator 9107 may add an independent movement capability in one direction (x₀). An assembly of two food modules 9109 is shown attached to the Cartesian bot 9113 and the motor-mounted actuator 9107 is shown to have opened one of the food module slider valves 9111. The robot arm 9105 may therefore be considered as being shared by all food modules in the ingredient dispenser. The food modules may have solid, liquid or powdered ingredients as mentioned earlier in this patent application. It will be clear to one skilled in the art that several variations of the embodiment in FIG. 91 may be possible. The ideas described in FIG. 1-90 may be used as is or adapted for an apparatus similar to FIG. 91.

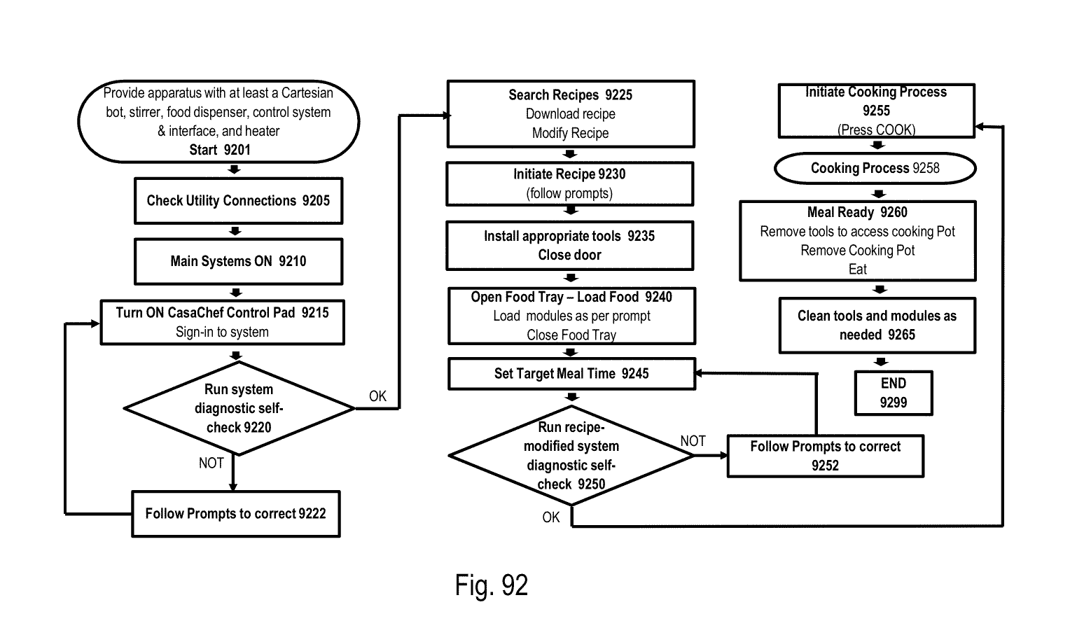

Embodiments and improvements of the present invention are now described with reference to FIG. 92, it being appreciated that the figure illustrates the process flow of the cooking robot, which may be referred to by the term CasaChef. Such an automated cooking appliance may include a control system with user interface, an induction or IR cooking apparatus, an automated ingredient delivery system, a food stirring system, and ventilation. It will be appreciated by those skilled in the art that several variations of the concepts may be possible.

FIG. 92 illustrates a simple process flow diagram of the Casa Chef automated cooking appliance suitably equipped to cook at Start (9201). At Start (9201) it may be important to verify the utility connections (9205) and sources for the automated cooking appliance. This may include power, water, air, and a suitable computer network connection. Main Systems On (9210) may include turning on the electrical power switch to the system, opening water and air valves, and providing power to a wireless router for internet connection. The Casa Chef automated cooking appliance may rely on a wireless (e.g., Wi-Fi) connected touch screen tablet to download and store recipes and to control all procedures in the cooking process. Turn ON Casa Chef Control Pad (9215) may bring up the tablet control system, connection to the wireless Wi-Fi and request to sign-in. After sign-in, the system may initiate a Run System Diagnostic Self-check (9220). Diagnostics may include: Wi-Fi internet check for adequate signal and bandwidth; Electronic checks for line voltage and ground leaks; Water pressure check; Heating system load check; and a mechanical check of the Cartesian bot and other moving components to confirm they have a clear path, they can move freely, and have been homed. A failure in the Run System Diagnostic Self-check (9220) may initiate a series of prompts to check faults, Follow Prompts to Correct (9222) connections and proper installation of components, and then loop back to re-run Run System Diagnostic Self-check (9220). A successful Run System Diagnostic Self-check (9220) may open access to Search Recipes (9225). Recipes may be stored in the tablet memory or found on-line. A recipe may be downloaded and then modified with regard to the number of servings, serving size, and substitutions to the foods and spices based on personal tastes, diet, or nutritional needs.

To facilitate the system to run this defined recipe, one may Initiate Recipe (9230) and follow the prompts. These prompts may include Install Appropriate tools (9235); which may include a specific pot, stirring device, food processors, food and spice trays, and other recipe-specific tools, and it may include a final prompt to close up the system when finished. These prompts may also include Open Food Tray—Load Food (9240); which may include loading small food modules, large food modules, spice modules, and liquid modules as per recipe-specified prompts, and it may include a final prompt to close the food tray when finished. One may want to set up the Casa Chef automated cooking appliance in advance of the time for cooking a meal. Once the recipe is defined and the system is prepared to cook, one may Set Target Meal Time (9245) and the system may calculate the start time in order to be completed at the specified target meal time. This may also initiate a final Recipe-modified System Diagnostic Self Check (9250). A failure in the final Recipe-modified System Diagnostic Self-check (9250) may initiate a series of prompts to check faults, Follow Prompts to Correct (9252) connections and proper installation of components, and then loop back to re-run Run System Diagnostic Self-check (9220). A successful Recipe-modified System Diagnostic Self-check (9250) may open access to Initiate Cooking Process (9255), a prompt to Press COOK, and to begin the Cooking Process (9258) as per the specified target meal time and the Recipe-defined cooking process.

At the specified Target Meal Time the Casa Chef may go to an idle resting state, with reduced warming temperatures only. Meal Ready (9260) may initiate a series of prompts to remove tools in order to access the cooking pot, to remove the cook pot and turn off the heater, and to eat. Clean Tools and Modules as Needed (9265) may suggest the tools and modules that need to be removed and cleaned. The variety of tools, components, and modules may vary between recipes and so may the cleaning procedures required. End (9299) may prompt the shutdown of the main systems, which may include; the control tablet, air, water and the main electrical power switch.

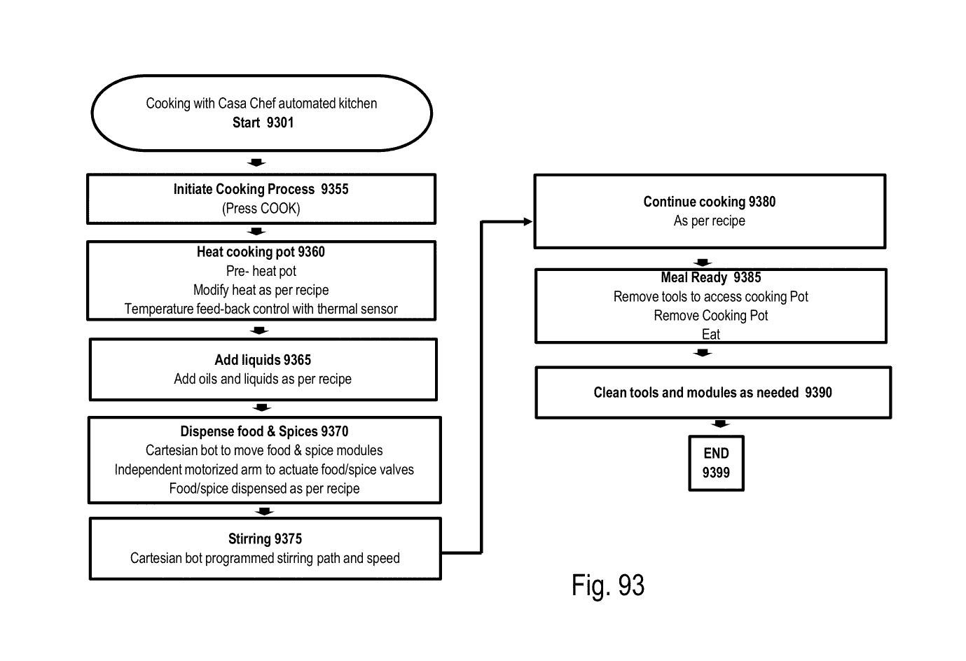

FIG. 93 illustrates a simple process flow diagram of Cooking with the cooking robot which may be referred to by the term Casa Chef. It may begin at Start (9301) with Initiate Cooking Process (9355) Press Cook, of a defined recipe from FIG. 92, and may expand the Cooking Process (9258) of FIG. 92.

The cooking pot may be heated with an induction heater, resistive heater or an IR source heater. Heat Cooking Pot (9360) may heat the cook vessel/pot and change the cooking temperature of the cook pot as per the selected recipe. The temperature of the cooking pot may be monitored with a thermal sensor and controlled with temperature sensor feed-back. The selected recipe may define what liquids to add to the pot, how much liquid to add, and when to add the liquid throughout the cooking process in Add Liquids (9365). These liquids may be delivered in a controlled quantity by a variety of pumping methods that may include pneumatic, peristaltic, piston, and displacement pumping.

The selected recipe may also define what foods and spices to add to the pot thorough out the cooking process, in Dispense Food & Spices (9370). The Casa Chef Automated Kitchen may include a Cartesian bot system that may be used to accurately position tools in the system very precisely in 3D space x₀, y₀, z₀. This Cartesian bot system may also be used to move a food or spice modules from a food storage tray to a specific position over the cooking pot in much the same way that a CNC machine picks up a tool and positions it. In addition, the Casa Chef Automated Kitchen includes an independent motorized arm that only operates in one axis, x₀. This independent motorized arm, in concert with the Cartesian bot's accurate positioning of a food module, may be used to actuate the food/spice valves in order to deliver a calibrated quantity of food or spice. When the food and spices have been dispensed as per the recipe, the Casa Chef Cartesian bot system may move the food & spice modules back from above the cook pot to the food storage tray in much the same way that a CNC machine returns a tool to its tool storage rack.

Stirring may be an important part of the cooking process and may be used to mix food, distribute flavors, provide texture to the food, distribute heat, and prevent burning. The Casa Chef Cartesian bot system may also be used to move a tool, such as a stirring implement, in a programmed path and speed as per the recipe in Stirring (9375).

Continue Cooking (9380); the defined recipe may set in motion the cooking process and the timing of the temperature changes, adding liquids, adding food, adding spices, and stirring.

At the specified Target Meal Time the Casa Chef may go to an idle resting state, with reduced warming temperatures only. Meal Ready (9385) may initiate a series of prompts to remove tools in order to access the cooking pot, to remove the cook pot and turn off the heater, and to eat. Clean Tools and Modules as Needed (9390) may suggest the tools and modules that need to be removed and cleaned. The variety of tools, components, and modules may vary between recipes and so may the cleaning procedures required. End (9399) may prompt the shutdown of the main systems, which may include; the control tablet, air, water and the main electrical power switch.

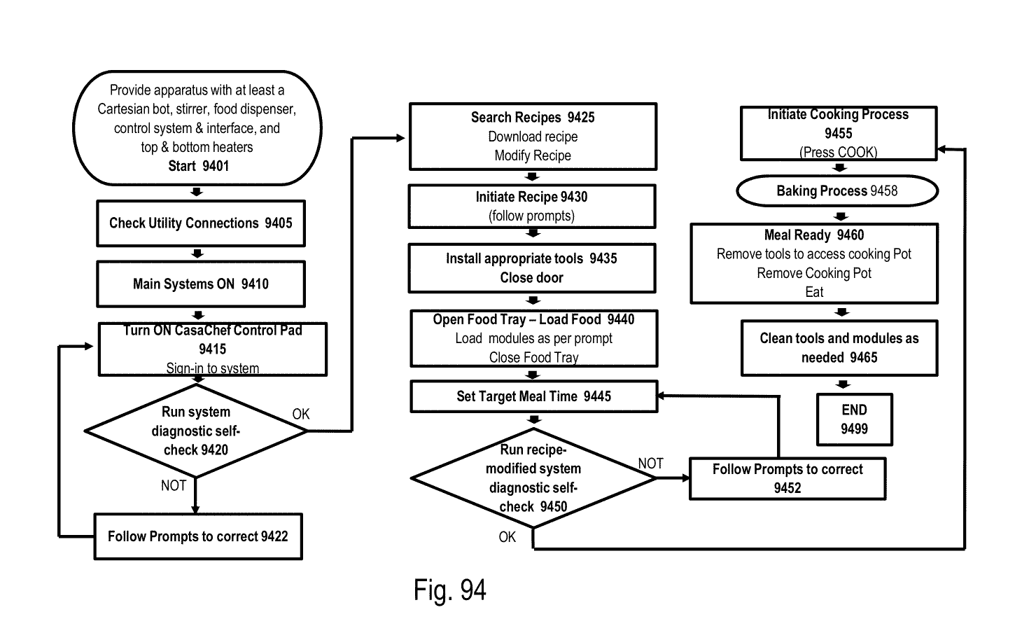

Embodiments and improvements of the present invention are now described with reference to FIG. 94, it being appreciated that the figure illustrates the process flow of the Casa Chef automated cooking appliance. Such an automated cooking appliance may include a control system with user interface, an induction or IR cooking apparatus, an automated ingredient delivery system, a food stirring system, and ventilation. It will be appreciated by those skilled in the art that several variations of the concepts may be possible.

FIG. 94 may illustrate a simple process flow diagram of the Casa Chef automated cooking appliance suitably equipped to cook at Start (9401). At Start (9401) it may be important to verify the utility connections (9405) and sources for the automated cooking appliance. This may include power, water, air, and a suitable computer network connection. Main Systems On (9410) may include turning on the electrical power switch to the system, opening water and air valves, and providing power to a wireless router for internet connection. The Casa Chef automated cooking appliance may rely on a Wi-Fi connected touch screen tablet to download and store recipes and to control all procedures in the cooking process. Turn ON Casa Chef Control Pad (9415) may bring up the tablet control system, connection to the wireless Wi-Fi and request to sign-in. After sign-in, the system may initiate a Run System Diagnostic Self-check (9420). Diagnostics may include: Wi-Fi internet check for adequate signal and bandwidth; Electronic checks for line voltage and ground leaks; Water pressure check; Heating system load check; Air pressure check; and a mechanical check of the Cartesian bot and other moving components to confirm they have a clear path, they can move freely, and have been homed. A failure in the Run System Diagnostic Self-check (9420) may initiate a series of prompts to check faults, Follow Prompts to Correct (9422) connections and proper installation of components, and then loop back to re-run Run System Diagnostic Self-check (9420). A successful Run System Diagnostic Self-check (9420) may open access to Search Recipes (9425). Recipes may be stored in the tablet memory or found on-line. A recipe may be downloaded and then modified with regard to the number of servings, serving size, and substitutions to the foods and spices based on personal tastes, diet, or nutritional needs.

To facilitate the system to run this defined recipe, one may Initiate Recipe (9430) and follow the prompts. These prompts may include Install Appropriate tools (9435); which may include a specific pot, stirring device, food processors, food and spice trays, recipe-specified heaters, and other recipe-specific tools, and it may include a final prompt to close up the system when finished. In order to bake in the Casa Chef automated kitchen, one may provide a closed heating environment with a bottom induction or resistance heater and a top heater that may be an IR or resistance heater.

These recipe prompts may also include Open Food Tray—Load Food (9440); which may include loading small food modules, large food modules, spice modules, and liquid modules as per recipe-specified prompts, and it may include a final prompt to close the food tray when finished.

One may want to set up the Casa Chef automated cooking appliance in advance of the time for cooking a meal. Once the recipe is defined and the system is prepared to cook, one may Set Target Meal Time (9445) and the system may calculate the start time in order to be completed at the specified target meal time. This may also initiate a final Recipe-modified System Diagnostic Self Check (9450). A failure in the final Recipe-modified System Diagnostic Self-check (9450) may initiate a series of prompts to check faults, Follow Prompts to Correct (9452) connections and proper installation of components, and then loop back to re-run Run System Diagnostic Self-check (9450). A successful Recipe-modified System Diagnostic Self-check (9450) may open access to Initiate Cooking Process (9455), a prompt to Press COOK, and to begin the Cooking or Baking Process (9458) as per the specified target meal time and the Recipe-defined cooking process.

At the specified Target Meal Time the Casa Chef may go to an idle resting state, with reduced warming temperatures only. Meal Ready (9460) may initiate a series of prompts to remove tools in order to access the cooking pot, to remove the cook pot and turn off the heater, and to eat. Clean Tools and Modules as Needed (9465) may suggest the tools and modules that need to be removed and cleaned. The variety of tools, components, and modules may vary between recipes and so may the cleaning procedures required. End (9499) may prompt the shutdown of the main systems, which may include; the control tablet, air, water and the main electrical power switch.

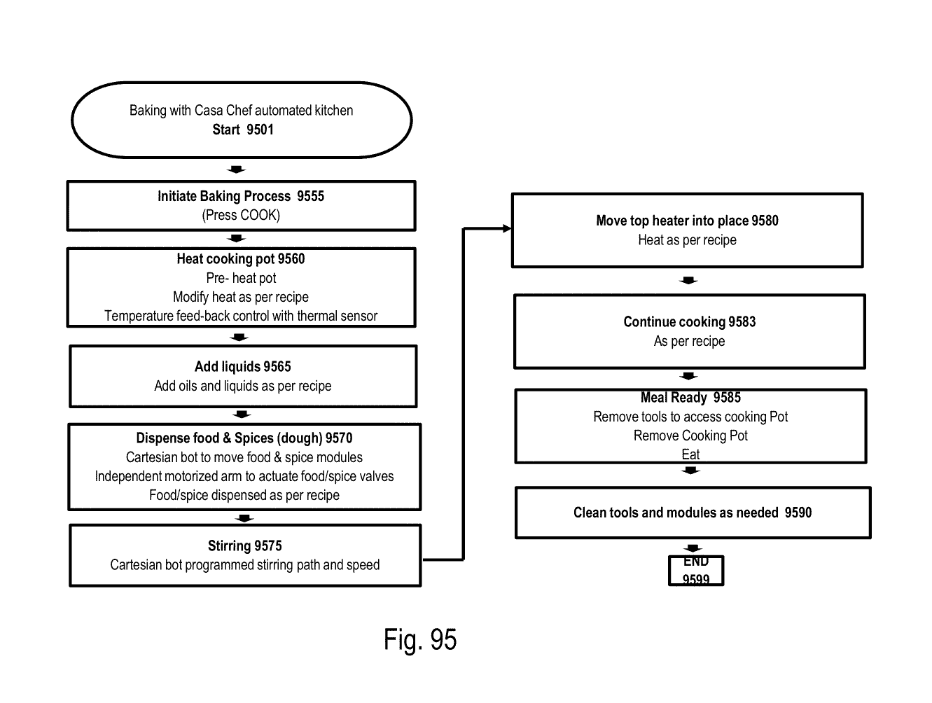

FIG. 95 illustrates a process flow diagram for Baking with the Casa Chef Automated Kitchen at Start (9501). It begins with Initiate Baking Process (9555) Press Cook, of a defined recipe from FIG. 94, and expands the Cooking Process (9458) of FIG. 94.

The cooking pot may be heated with an induction heater, resistive heater or an IR source heater. Heat Cooking Pot (9560) may heat the cook vessel/pot and change the cooking temperature of the cook pot as per the selected recipe. The temperature of the cooking pot may be monitored with a thermal sensor and controlled with temperature sensor feed-back. The selected recipe may define what liquids to add to the pot, how much liquid to add, and when to add the liquid thorough out the cooking process in Add Liquids (9565). These liquids may be delivered in a controlled quantity by a variety of pumping methods that may include pneumatic, peristaltic, piston, and displacement pumping.

The selected recipe may also define what foods, spices, or dough to add to the pot thorough out the cooking process, in Dispense Food & Spices (9570). The Casa Chef Automated Kitchen includes a Cartesian bot system that may be used to accurately position tools in the system very precisely in 3D space x₀, y₀, z₀. This Cartesian bot system may also be used to move a food, spice, or dough module from a food storage tray to a specific position over the cooking pot in much the same way that a CNC machine picks up a tool and positions it. In addition, the Casa Chef Automated Kitchen includes an independent motorized arm that only operates in one axis, x₀. This independent motorized arm, in concert with the Cartesian bot's accurate positioning of a food module, may be used to actuate the food/spice valves in order to deliver a calibrated quantity of food, spice, or dough. When the food, spice, and dough have been dispensed as per the recipe, the Casa Chef Cartesian bot system may move the food & spice modules back from above the cook pot to the food storage tray in much the same way that a CNC machine returns a tool to its tool storage rack.

Stirring may be an important part of the cooking process and may be used to mix and distribute food or dough, distribute flavors, provide texture to the food, distribute heat, and prevent burning. The Casa Chef Cartesian bot system may also be used to move a tool, such as a stirring implement, in a programmed path and speed as per the recipe in Stirring (9575).

In order to bake in the Casa Chef automated kitchen, one may provide a closed heating environment with a bottom induction or resistance heater and a top heater that may be an IR or resistance heater. The Casa Chef Automated Kitchen includes a Cartesian bot system that may be used to very precisely position a recipe-defined top heater (9580) in the system, in 3D space x₀, y₀, z₀, above the cook pot. Throughout the baking process the recipe-defined temperature and positioning of the top heater may be critical for uniform baking of food.

Continue Cooking (9583); the defined recipe sets in motion the cooking process and the timing of the temperature changes, adding liquids, adding food, adding spices, stirring, and positioning of heaters.

At the specified Target Meal Time the Casa Chef may go to an idle resting state, with reduced warming temperatures only. Meal Ready (9585) may initiate a series of prompts to remove tools in order to access the cooking pot, to remove the cook pot and turn off the heaters, and to eat. Clean Tools and Modules as Needed (9590) may suggest the tools and modules that need to be removed and cleaned. The variety of tools, components, and modules may vary between recipes and so may the cleaning procedures required. End (9599) may prompt the shutdown of the main systems, which may include; the control tablet, air, water and the main electrical power switch.

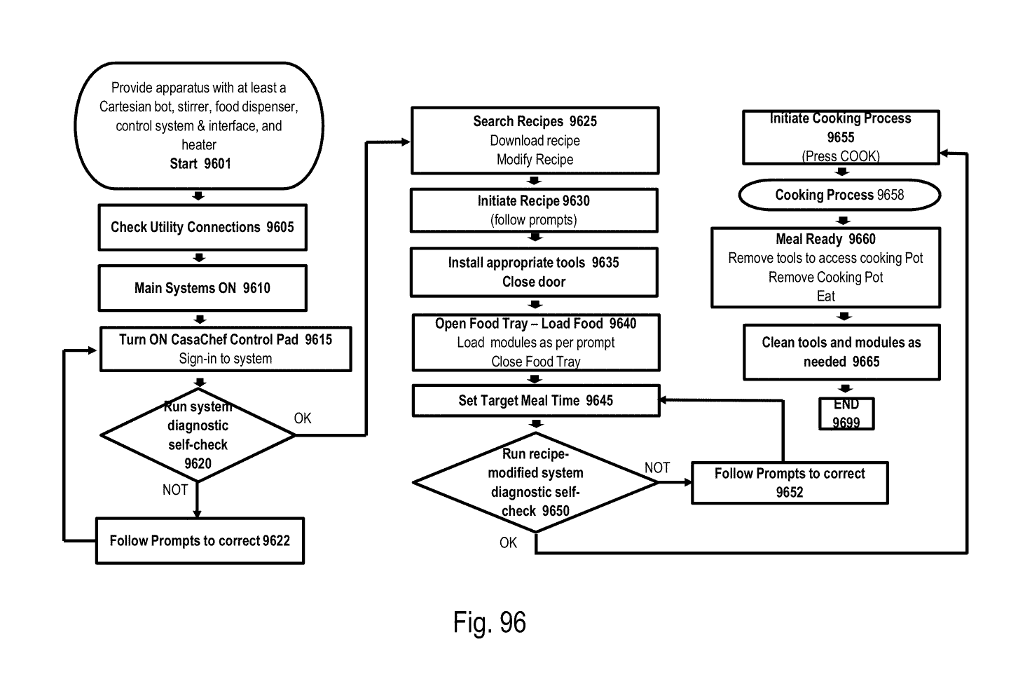

Embodiments and improvements of the present invention are now described with reference to FIG. 96, it being appreciated that the figure illustrates the process flow of the Casa Chef automated cooking appliance. Such an automated cooking appliance may include a control system with user interface, an induction or IR cooking apparatus, an automated ingredient delivery system, a food stirring system, and ventilation. It will be appreciated by those skilled in the art that several variations of the concepts may be possible.

FIG. 96 illustrates a simple process flow diagram of the Casa Chef automated cooking appliance suitably equipped to cook at Start (9601). At Start (9601) it may be important to verify the utility connections (9605) and sources for the automated cooking appliance. This may include power, water, air, and a suitable computer network connection. Main Systems On (9610) may include turning on the electrical power switch to the system, opening water and air valves, and providing power to a wireless router for internet connection. The Casa Chef automated cooking appliance may rely on a Wi-Fi connected touch screen tablet to download and store recipes and to control all procedures in the cooking process. Turn ON Casa Chef Control Pad (9615) may bring up the tablet control system, connection to the wireless Wi-Fi and request to sign-in. After sign-in, the system may initiate a Run System Diagnostic Self-check (9620). Diagnostics may include: Wi-Fi internet check for adequate signal and bandwidth; Electronic & GFI checks for line voltage and ground leaks; Water pressure check; Heating system load check; Air pressure check; and a mechanical check of the Cartesian bot and other moving components to confirm they have a clear path, they can move freely, and have been homed. A failure in the Run System Diagnostic Self-check (9620) may initiate a series of prompts to check faults, Follow Prompts to Correct (9622) connections and proper installation of components, and then loop back to re-run Run System Diagnostic Self-check (9620). A successful Run System Diagnostic Self-check (9620) may open access to Search Recipes (9625). Recipes may be stored in the tablet memory or found on-line. A recipe may be downloaded and then modified with regard to the number of servings, serving size, and substitutions to the foods and spices based on personal tastes, diet, or nutritional needs.

To facilitate the system to run this defined recipe, one may Initiate Recipe (9630) and follow the prompts. These prompts may include Install Appropriate tools (9635); which may include a specific pot, stirring device, food processors, food and spice trays, and other recipe-specific tools, and it may include a final prompt to close up the system when finished. These prompts may also include Open Food Tray—Load Food (9640); which may include loading small food modules, large food modules, spice modules, and liquid modules as per recipe-specified prompts, and it may include a final prompt to close the food tray when finished.

One may want to set up the Casa Chef automated cooking appliance in advance of the time for cooking a meal. Once the recipe is defined and the system is prepared to cook, one may Set Target Meal Time (9645) and the system may calculate the start time in order to be completed at the specified target meal time. This may also initiate a final Recipe-modified System Diagnostic Self Check (9650). A failure in the final Recipe-modified System Diagnostic Self-check (9650) may initiate a series of prompts to check faults, Follow Prompts to Correct (9652) connections and proper installation of components, and then loop back to re-run Run System Diagnostic Self-check (9620). A successful Recipe-modified System Diagnostic Self-check (9650) may open access to Initiate Cooking Process (9655), a prompt to Press COOK, and to begin the Cooking Process (9658) as per the specified target meal time and the Recipe-defined cooking process.

At the specified Target Meal Time the Casa Chef may go to an idle resting state, with reduced warming temperatures only. Meal Ready (9660) may initiate a series of prompts to remove tools in order to access the cooking pot, to remove the cook pot and turn off the heater, and to eat. Clean Tools and Modules as Needed (9665) may suggest the tools and modules that need to be removed and cleaned. The variety of tools, components, and modules may vary between recipes and so may the cleaning procedures required. End (9699) may prompt the shutdown of the main systems, which may include; the control tablet, air, water and the main electrical power switch.

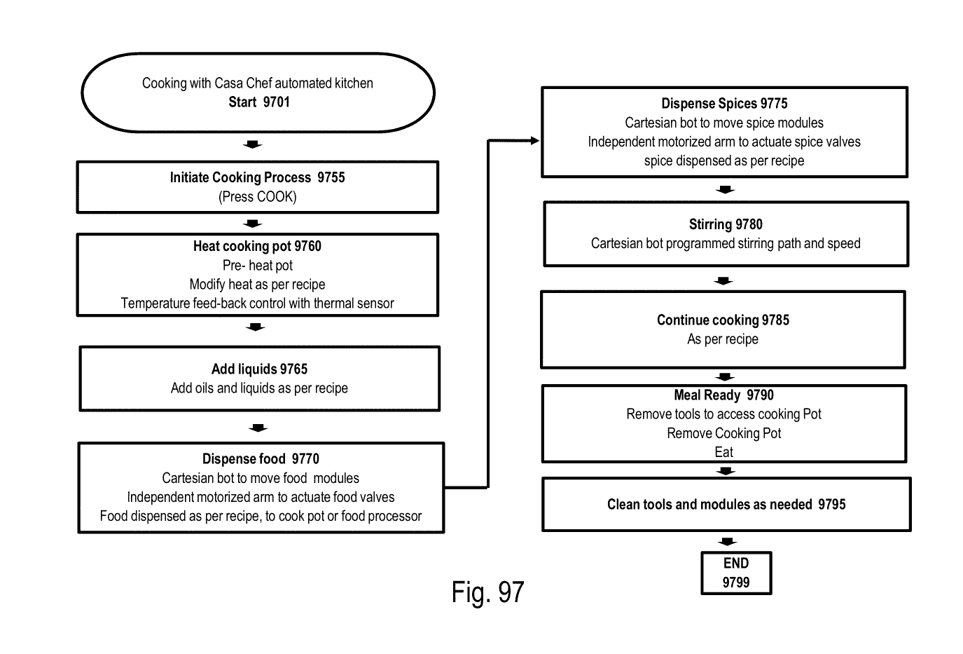

FIG. 97 illustrates a process flow diagram of Cooking with the Casa Chef Automated Kitchen, Start (9701). It begins with Initiate Cooking Process (9755) Press Cook, of a defined recipe from FIG. 96, and expands the Cooking Process (9658) of FIG. 96 to include chopping of food.

The cooking pot may be heated with an induction heater, resistive heater or an IR source heater. Heat Cooking Pot (9760) may heat the cook vessel/pot and change the cooking temperature of the cook pot as per the selected recipe. The temperature of the cooking pot may be monitored with a thermal sensor and controlled with temperature sensor feed-back. The selected recipe may define what liquids to add to the pot, how much liquid to add, and when to add the liquid thorough out the cooking process in Add Liquids (9765). These liquids may be delivered in a controlled quantity by a variety of pumping methods that may include pneumatic, peristaltic, piston, and displacement pumping.

The selected recipe may also define what foods to add to the pot thorough out the cooking process in Dispense Food (9770). The Casa Chef Automated Kitchen includes a Cartesian bot system that may be used to accurately position tools in the system very precisely in 3D space x₀, y₀, z₀. This Cartesian bot system may also be used to move food modules from a food storage tray to a specific position over the cooking pot or to a specific food processor for chopping, in much the same way that a CNC machine picks up a tool and positions it. If chopping, the recipe-driven process may at this time supply power to the specified food processor. The Casa Chef Automated Kitchen also includes an independent motorized arm that only operates in one axis, x₀. This independent motorized arm, in concert with the Cartesian bot's accurate positioning of a food module, may be used to actuate the food valves in order to deliver a calibrated quantity of food directly to the cook pot or to a recipe-specified food processor. When the foods have been dispensed as per the recipe, and chopping is completed, the Casa Chef Cartesian bot system may shut down power to the food processor and move the food modules back to the food storage tray in much the same way that a CNC machine returns a tool to its tool storage rack.

The selected recipe may also define what spices to add to the pot thorough out the cooking process. In Dispense Spices (9775). The Casa Chef Automated Kitchen includes a Cartesian bot system that may be used to accurately position tools in the system very precisely in 3D space x₀, y₀, z₀. This Cartesian bot system may also be used to move spice modules from a food storage tray to a specific position over the cooking pot in much the same way that a CNC machine picks up a tool and positions it. In addition, the Casa Chef Automated Kitchen includes an independent motorized arm that only operates in one axis, x₀. This independent motorized arm, in concert with the Cartesian bot's accurate positioning of a food module, may be used to actuate the spice valves in order to deliver a calibrated quantity of spice. When the spices have been dispensed as per the recipe, the Casa Chef Cartesian bot system may move the spice modules back from above the cook pot to the food storage tray in much the same way that a CNC machine returns a tool to its tool storage rack.

Stirring may be an important part of the cooking process and may be used to mix food, distribute flavors, provide texture to the food, distribute heat, and prevent burning. The Casa Chef Cartesian bot system may also be used to move a tool, such as a stirring implement, in a programmed path and speed as per the recipe in Stirring (9775).

Continue Cooking (9780); the defined recipe sets in motion the cooking process and the timing of the temperature changes, adding liquids, adding food, adding spices, and stirring.

At the specified Target Meal Time the Casa Chef may go to an idle resting state, with reduced warming temperatures only. Meal Ready (9785) may initiate a series of prompts to remove tools in order to access the cooking pot, to remove the cook pot and turn off the heater, and to eat. Clean Tools and Modules as Needed (9790) may suggest the tools and modules that need to be removed and cleaned. The variety of tools, components, and modules may vary between recipes and so may the cleaning procedures required. Cleaning (9795) may proceed if needed. End (9799) may prompt the shutdown of the main systems, which may include; the control tablet, air, water and the main electrical power switch.

With an automated cooking machine as described in this patent application, recipes may need to be entered into the machine. According to an embodiment of this invention, consumers could rent or buy recipes from an online or cloud recipe repository, which may be a recipe storage system. The recipes may be encrypted so that a user who may rent a recipe, for example for a day, may not reverse engineer and figure out aspects of the recipe such as temperature, cooking time, sensor readings for various tasks, etc.

While the figures in this patent application were sometimes described using an induction cooktop as the cooking medium, it will be clear to one skilled in the art that the ideas in this patent application are applicable to other types of cooktops which may be gas or electric or some other type.

For the ingredient dispenser embodiments described in this invention, one may use unique “non-stick” materials that reduce the amount of powder or other food items that stick to the sides of the ingredient dispenser. Parts of the ingredient dispenser may be made of different materials based on the type of food item it may store. Examples of non-stick materials may include Teflon.

Regions heated to high temperatures in an automated cooking machine may often need to be thermally insulated from other parts of the machine. This could be done using thermal insulation materials, which may be materials having thermal conductivity less than 2 W/mK. This may include materials such as PEEK, borosilicate glass and several others, for example.

While the figures in this patent application showed the cooking vessel staying stationary and other parts of the system such as the ingredient dispenser moving, one skilled in the art will realize that the cooking vessel may optionally be mounted on a robot arm and move as well.

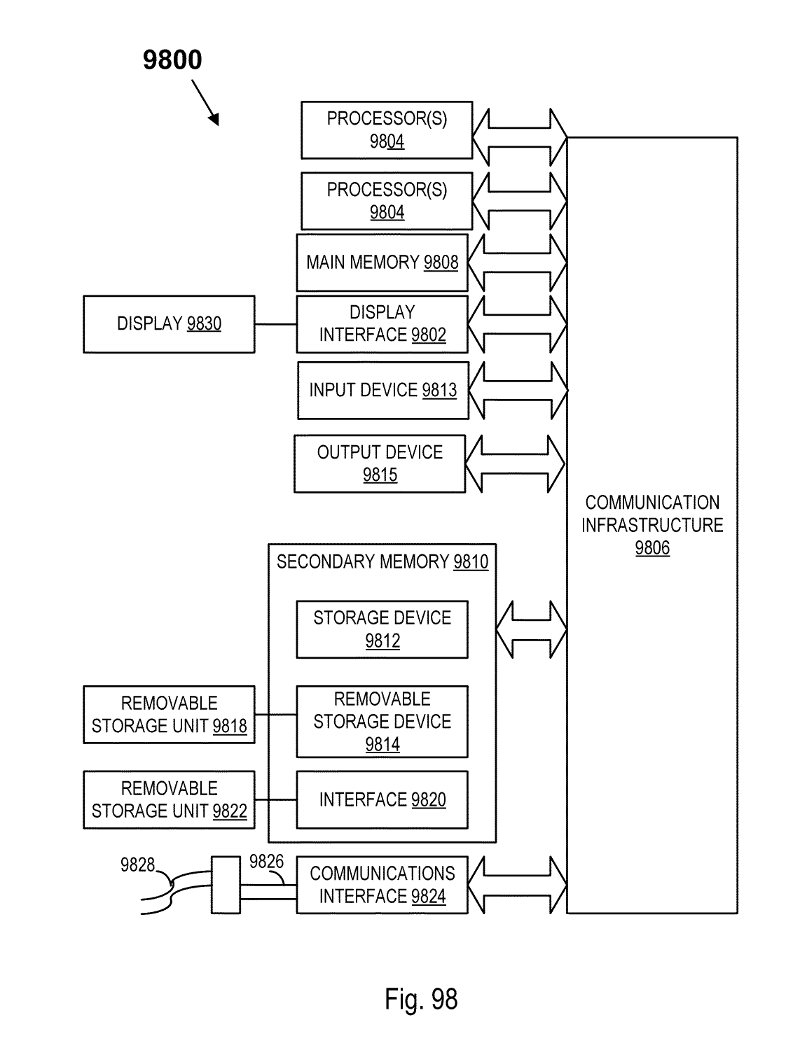

FIG. 98 depicts an example computer system that may be used in implementing an illustrative embodiment of the present invention. Specifically, FIG. 98 depicts an illustrative embodiment of a computer system 9800 that may be used in computing devices such as, e.g., but not limited to, standalone, client, server devices, or system controllers. FIG. 98 depicts an illustrative embodiment of a computer system that may be used as client device, a server device, a controller, etc. The present invention (or any part(s) or function(s) thereof) may be implemented using hardware, software, firmware, or a combination thereof and may be implemented in one or more computer systems or other processing systems. In one illustrative embodiment, the invention may be directed toward one or more computer systems capable of carrying out the functionality described herein. An example of a computer system 9800 is shown in FIG. 98, depicting an illustrative embodiment of a block diagram of an illustrative computer system useful for implementing the present invention. Specifically, FIG. 98 illustrates an example computer 9800, which in an illustrative embodiment may be, e.g., (but not limited to) a controller, tablet, and/or a personal computer (PC) system running an operating system such as, e.g., (but not limited to) MICROSOFT® WINDOWS® NT/98/2000/XP/Vista/Windows 7/Windows 8, etc. available from MICROSOFT® Corporation of Redmond, Wash., U.S.A., an Apple computer executing MAC® OS or iOS from Apple® of Cupertino, Calif., U.S.A., or a Linux derivative. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 9800 is shown in FIG. 98. Other components of the invention, such as, e.g., (but not limited to) a computing device, a communications device, a telephone, a personal digital assistant (PDA), an iPhone, a 3G/4G, LTE wireless device, a wireless device, a personal computer (PC), a handheld PC, a laptop computer, a smart phone, a mobile device, a netbook, a handheld device, a portable device, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 98. Computer system 9800 may be used to implement the network and/or components as described above. For example, the various components in FIGS. 1-97, such as the automated ingredient delivery system and the user interface, and in particular, portion of the electronics 110 and user interface 118, for example.

The computer system 9800 may include one or more processors, such as, e.g., but not limited to, processor(s) 9804. The processor(s) 9804 may be connected to a communication infrastructure 9806 (e.g., but not limited to, a communications bus, cross-over bar, interconnect, or network, etc.). Processor 9804 may include any type of processor, microprocessor, or processing logic that may interpret and execute instructions (e.g., for example, a field programmable gate array (FPGA)). Processor 9804 may comprise a single device (e.g., for example, a single core) and/or a group of devices (e.g., multi-core). The processor 9804 may include logic configured to execute computer-executable instructions configured to implement one or more embodiments. The instructions may reside in main memory 9808 or secondary memory 9810. Processors 9804 may also include multiple independent cores, such as a dual-core processor or a multi-core processor. Processors 9804 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention and/or parts of the invention using other computer systems and/or architectures.

Computer system 9800 may include a display interface 9802 that may forward, e.g., but not limited to, graphics, text, and other data, etc., from the communication infrastructure 9806 (or from a frame buffer, etc., not shown) for display on the display unit 9830. The display unit 9830 may be, for example, a television, a computer monitor, a touch sensitive display device, an LCD device, or a mobile phone screen. The output may also be provided as sound through a speaker.

The computer system 9800 may also include, e.g., but is not limited to, a main memory 9808, random access memory (RAM), and a secondary memory 9810, etc. Main memory 9808, random access memory (RAM), and a secondary memory 9810, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory 9810 may include, for example, (but is not limited to) a hard disk drive 9812 and/or a removable storage drive 9814, representing a floppy diskette drive, a magnetic tape drive, an optical disk drive, a compact disk drive CD-ROM, flash memory, etc. The removable storage drive 9814 may, e.g., but is not limited to, read from and/or write to a removable storage unit 9818 in a well-known manner. Removable storage unit 9818, also called a program storage device or a computer program product, may represent, e.g., but is not limited to, a floppy disk, magnetic tape, optical disk, compact disk, etc. which may be read from and written to removable storage drive 9814. As will be appreciated, the removable storage unit 9818 may include a computer usable storage medium having stored therein computer software and/or data.

In alternative illustrative embodiments, secondary memory 9810 may include other similar devices for allowing computer programs or other instructions to be loaded into computer system 9800. Such devices may include, for example, a removable storage unit 9822 and an interface 9820. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 9822 and interfaces 9820, which may allow software and data to be transferred from the removable storage unit 9822 to computer system 9800.

Computer 9800 may also include an input device 9813 which may include any mechanism or combination of mechanisms that may permit information to be input into computer system 9800 from, e.g., a user or operator. Input device 9813 may include logic configured to receive information for computer system 9800 from, e.g. a user or operator. Examples of input device 9813 may include, e.g., but not limited to, a mouse, pen-based pointing device, or other pointing device such as a digitizer, a touch sensitive display device, and/or a keyboard or other data entry device (none of which are labeled). Other input devices 9813 may include, e.g., but not limited to, a biometric input device, a video source, an audio source, a microphone, a web cam, a video camera, and/or other camera.

Computer 9800 may also include output devices 9815 which may include any mechanism or combination of mechanisms that may output information from computer system 9800. Output device 9815 may include logic configured to output information from computer system 9800. Embodiments of output device 9815 may include, e.g., but not limited to, display 9830, and display interface 9802, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 9800 may include input/output (I/O) devices such as, e.g., (but not limited to) input device 9813, communications interface 9824, connection 9828 and communications path 9826, etc. These devices may include, e.g., but are not limited to, a network interface card, onboard network interface components, and/or modems.

Communications interface 9824 may allow software and data to be transferred between computer system 9800 and external devices or other computer systems. Computer system 9800 may connect to other devices or computer systems via wired or wireless connections. Wireless connections may include, for example, WiFi, satellite, mobile connections using, for example, TCP/IP, 802.15.4, high rate WPAN, low rate WPAN, 6loWPAN, ISA100.11a, 802.11.1, WiFi, 3G, WiMAX, 4G and/or other communication protocols.

In this document, the terms “computer program medium” and “computer readable medium” may be used to generally refer to media such as, e.g., but not limited to, removable storage drive 9814, a hard disk installed in hard disk drive 9812, flash memories, removable discs, non-removable discs, etc. These computer program products may provide software to computer system 9800. It should be noted that a computer-readable medium that comprises computer-executable instructions for execution in a processor may be configured to store various embodiments of the present invention. Computer system 9800 may be specialized by storing programming logic that enables one or more processors to perform the techniques indicated herein and one or more of the steps of FIGS. 92-97, for example.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may. The various embodiments described herein may be combined and/or features of the embodiments may be combined to form new embodiments.

Unless specifically stated otherwise, as apparent from the following discussions, it is appreciated that throughout the specification discussions utilizing terms such as “processing,” “computing,” “calculating, ” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

It will also be appreciated by persons of ordinary skill in the art that the present invention is not limited to what has been particularly shown and described hereinabove. Rather, the scope of the present invention includes both combinations and sub-combinations of the various features described hereinabove as well as modifications and variations which would occur to such skilled persons upon reading the foregoing description. Thus the invention is to only be limited by the claims.

What is claimed is:

1. An automated cooking machine, comprising:
a Cartesian bot;
one or more dispensing sub-systems connectable to the Cartesian bot adapted to dispense solid, liquid, or powdered ingredients;
a stirrer adapted to stir said dispensed ingredients; and
a heater adapted to cook a food after said ingredients are dispensed.

2. The automated cooking machine of claim 1, further comprising: a chopping sub-system adapted to chop one or more ingredients.

3. The automated cooking machine of claim 1, further comprising: a spectrometer or a gas sensor.

4. The automated cooking machine of claim 1, wherein the one or more dispensing sub-systems dispense measured quantities of greater than one ingredient.

5. The automated cooking machine of claim 1, further comprising a temperature sensor.

6. The automated cooking machine of claim 1, wherein at least one container whose contents are dispensed is mounted atop the Cartesian bot.

7. The automated cooking machine of claim 1, wherein at least part of a motion of the stirrer is mechanically coupled to a motion of the Cartesian bot.

8. An ingredient dispenser, comprising:
a plurality of ingredients,
wherein at least one of said plurality of ingredients is dispensed by a motion of a shared robot arm; and
wherein said ingredient dispenser is mounted on a Cartesian bot system and disposed within an automated cooking machine.

9. The ingredient dispenser of claim 8, wherein the plurality of ingredients comprise at least one of:
a solid,
a liquid, or
powdered ingredients.

10. The ingredient dispenser of claim 8, wherein at least one of said plurality of ingredients is dispensed using at least one slide gate valve.

11. The ingredient dispenser of claim 8, wherein at least one of said plurality of ingredients is dispensed with a system which includes at least two slide gate valves.

12. The ingredient dispenser of claim 8, further comprising at least one solenoid valve.

13. The ingredient dispenser of claim 8, further comprising a weight measurement sensor.

14. The ingredient dispenser of claim 8, further comprising at least one ingredient container with a built-in motor.

15. The ingredient dispenser of claim 8, further comprising a screw-Auger mechanism.

16. An automated cooking machine comprising:
a Cartesian bot system; and
at least one continuous flow food processor adaptable to couple to the Cartesian bot system,
wherein said at least one continuous flow food processor chops up a food and delivers said food into a cooking vessel.

17. The automated cooking machine of claim 16,
wherein said Cartesian bot system dispenses an ingredient into one of said at least one continuous flow food processor.

18. The automated cooking machine of claim 16,
wherein said Cartesian bot system pushes at least a portion of said food to be chopped down an inlet of the continuous flow food processor.

19. The automated cooking machine of claim 16, comprising a plurality of continuous flow processors, each with a cutting blade.

20. The automated cooking machine of claim 16, comprising a plurality of continuous flow food processors, wherein a motor is shared by at least two continuous flow food processors.
